(19) United States
(12) Patent Application Publication
(10) Pub. No.: US 2024/0026082 A1
(43) Pub. Date: Jan. 25, 2024

(54) S-LINKED QUINONE POLYMERS, SULFURIZED CARBON MATRICES AND RELATED COMPOSITES, COMPOSITIONS, ELECTRODE MATERIAL, ELECTRODES, ELECTROCHEMICAL CELLS, BATTERIES, METHODS AND SYSTEMS

(71) Applicant: ALIONYX ENERGY SYSTEMS, Monrovia, CA (US)

(72) Inventors: Jasim UDDIN, Monrovia, CA (US); Thay A. UNG, Monrovia, CA (US); Simon C. JONES, Whittier, CA (US); Zeiad MUNTASSER, Glendale, CA (US); Andrew STEWART, Pasadena, CA (US); Demetrio BATAC, Valley Center, CA (US); Mohammed EL-KUMBARI, West Covina, CA (US)

(21) Appl. No.: 18/144,806

(22) Filed: May 8, 2023

Related U.S. Application Data
(60) Provisional application No. 63/339,684, filed on May 9, 2022.

(51) Int. Cl. C08G 75/0227; H01M 8/18

(52) U.S. Cl. CPC C08G 75/0227; H01M 8/18

(57) ABSTRACT

Redox active S-linked polymers, sulfurized matrices, and related composites, compositions electrode material, electrodes, as well as related electrode chemical cell battery, methods and systems are described. In particular, S-linked polymers and related compositions, composites, electrode material and electrodes having a redox potential of up to 3.5 V with reference to Li/Li+ electrode potential under standard conditions and a capacity up to 800 mAh/g or higher are described. More particularly, redox active S-linked polymers, sulfurized matrices, and related composites, and compositions are provided as electrode material of a cathode for an electrochemical cell further containing a Li anode and a non-aqueous electrolyte.

### CROSS REFERENCE TO RELATED APPLICATIONS

This application claims priority to U.S. provisional application No. 63/339,684, entitled “S-linked Quinone Polymers, Sulfurized Carbon Matrices and Related Composites, Compositions, Electrode Material, Electrodes, Electrochemical Cells, Batteries, Methods and Systems,” filed on May 9, 2022 with docket number P2678-USP the content of which is incorporated herein by reference. The present application may also be related to U.S. application Ser. No. 16/593,935, entitled “Crosslinked Polymers and Related Compositions, Electrochemical Cells, Batteries, Methods and Systems,” filed on Oct. 4, 2019, U.S. Provisional Application No. 62/741,519, entitled “Quinone-comprising network polymers as stable, high capacity organic electrode materials” filed on Oct. 4, 2018 with docket number ALNX_0001, U.S. Provisional Application No. 63/116,123, entitled “Organic Electrode Materials for Zinc Batteries and Their Applications” filed on Nov. 19, 2020 with docket number P2551-USP, and to U.S. Provisional Application No. 63/215,827, entitled “Organic Electrode Materials for Zinc Batteries and Their Applications” filed on Jun. 28, 2021 with docket number P2551-USP2, the content of each of which is incorporated herein by reference in its entirety.

### FIELD

The present disclosure relates to electrode active materials, and battery systems that feature electrodes incorporating organosulfur redox active polymers and matrices. In particular, the present disclosure relates to a S-linked quinone polymer, sulfurized carbon matrix, and related composites, compositions, electrode materials, electrodes, electrochemical cells, batteries, methods, and systems, that can be used to improve electrochemical cells and batteries performance.

### BACKGROUND

Performance, economics, and safety has been at the center of various efforts to improve electrode active materials and battery technologies.

Despite progresses made in the recent years, however, production for high reliability, high capacity, long-life, cheap and/or safe energy storage devices is still challenging, in particular with reference to batteries in large-scale applications, for example in, electric vehicles, utility grid storage supporting renewable power generation or in full-home backup battery installations.

### SUMMARY

Described herein are S-linked quinone polymers, sulfurized carbon matrix and related composites, compositions, electrode material, electrodes electrochemical cells, batteries, methods and systems, which, in several embodiments, allow production of high performance redox active materials which can be used as cathode active materials in high capacity, high energy density, safe, good cycling stability and long-lasting electrochemical cells and batteries with non-aqueous electrolytes.

According to a first aspect, a S-linked quinone polymer is described, wherein the S-linked quinone polymer is an S-linked quinone homopolymer represented by Formula (I)

-[M-Sₚ]-ₘ (I)

in which
M is a redox active monomeric quinone moiety having a redox potential of 0.5 V to 3.5 V with reference to Li/Li+ electrode potential under standard conditions, wherein the standard conditions where potentials are all measured are at 298 K, 1 atm, and with 1 M solutions.
p refers to the number of sulfur atom linking the redox active a monomeric quinone moiety M, p ranges from 1 to 5,
Sₚ is a sulfide when p is 1 or polysulfide when p is from 2 to 5,
m ranges from 5 to 10,000,
wherein the S-linked quinone polymer has a weight average molecular weight of at least 1,000 Dalton and a solubility in tetrahydrofuran (THF) of equal or less than 1.0 microgram per mL at 21° C. at 1 atm.

According to a second aspect, a S-linked quinone polymer is described, wherein the S-linked quinone copolymer represented Formula (II)

-[M1-Sₚ₁]ₘ₁-co-[M2-Sₚ₂]-ₘ₂ (II)

in which
M1 and M2 are each a redox active monomeric quinone moiety comprising a redox potential of 0.5 V to 3.5 V with reference to Li/Li+ electrode potential under standard conditions,
p1 and p2 each independently refer to a number of sulfur atom linking the redox active monomeric quinone moiety M1 and monomeric quinone moiety M2 respectively, p1 and p2 each independently range from 1 to 5,
Sₚ₁ is a sulfide when p1 is 1 or polysulfide when p1 is from 2 to 5,
Sₚ₂ is a sulfide when p2 is 1 or polysulfide when p2 is from 2 to 5,
m1 and m2 each independently range from 5 to 5,000, optionally a ratio of m1 to m2 ranges from 1:50 to 1:1, 1:20 to 1:2, 1:6 to 1:3, or 1:5 to 1:4,
wherein the S-linked quinone copolymer of Formula (II) has a weight average molecular weight ranging from 1,000 Dalton to 2,000,000 Dalton, and a solubility in tetrahydrofuran (THF) of equal or less than 1.0 microgram per mL at 21° C. at 1 atm.

According to a third aspect, a sulfurized carbon matrix is described, wherein the sulfurized carbon matrix represented by Formula (V), wherein Q is a bonded sp2 carbon atom (C) or a nitrogen (N), wherein [symbol] represents a single or double bond, Sₚ represents a polysulfide and p ranges from 2 to 8, wherein the sulfurized carbon matrix has a weight averaged MW ranging from 2000 to 2,000,000 Daltons,

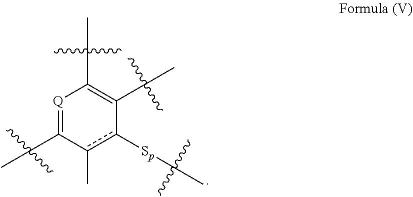

wherein the sulfurized carbon matrix has a sulfur content based on total weight of the sulfurized carbon matrix equal to or greater than 5 wt % and less than 20 wt %, equal to or greater than 20 wt % and less than 40 wt %, equal to or greater than 40 wt % less than 60 wt %, equal to or greater than 60 wt % less than 70 wt %, equal to or greater than 70 wt % less than 80 wt %.

According to a fourth aspect a redox active composition is described comprising one or more S-linked quinone polymer herein described, one or more sulfurized carbon matrix herein described or any combination thereof, together with an additive.

According to a fifth aspect, a redox active composite material is described, the composite material comprising at least one S-linked quinone polymer herein described, and at least one sulfurized carbon matrix herein described.

According to a sixth aspect, a cathode material is described wherein the cathode material comprises any redox active composition and/or any redox active composite herein described. In particular in some embodiments the cathode material herein described comprises an S-linked quinone polymer selected from an S-linked quinone homopolymer, an S-linked quinone copolymer and any combination thereof, and a sulfurized carbon matrix as described herein, wherein a weight ratio of the S-linked quinone polymer to the sulfurized carbon matrix ranges from 20:1 to 1:20, 10:1 to 1:10, 9:1 to 3:2, or 6:1 to 2:1 or is 1:1.

According to a seventh aspect a method and system to provide a cathode material are described. The method comprises combining at least one of an S-linked quinone polymer, at least one sulfurized carbon matrix herein described or any combination thereof, optionally together with an additive to provide a redox composition and/or a redox composite configured to enable sufficient contact with a non-aqueous electrolyte of an electrochemical cells and electrical conductivities. The system comprises at least one of an S-linked quinone polymer, a sulfurized carbon matrix herein described optionally together with an additive for combined use to provide a cathode material according to the seventh aspect herein described.

According to an eighth aspect method and system to provide a cathode material herein described. The method comprises
providing at least one S-linked quinone polymer selected from one or more S-linked quinone homopolymer one or more S-linked quinone copolymer and any combination thereof; and
providing at least one sulfurized carbon matrix.
   The method to provide a cathode material herein described further comprises
combining the least one S-linked quinone polymer and the at least one sulfurized carbon matrix to provide the cathode material herein described.
   The system comprises
at least one S-linked quinone polymer selected from one or more S-linked quinone homopolymer one or more S-linked quinone copolymer and any combination thereof; and
at least one sulfurized carbon matrix;
   for combined used in the method to provide a cathode material according to the eight aspect herein described. In some embodiments the at least one S-linked quinone polymer and the at least one sulfurized carbon matrix are mixed together. In addition, or in the alternative in some embodiments the at least one S-linked quinone polymer and the at least one sulfurized carbon matrix can be combined in any configuration allowing electrical connection between the at least one S-linked quinone polymer and the at least one sulfurized carbon matrix as well as enabling contact with a non-aqueous electrolyte when the cathode material is included in an electrochemical cell.
   In preferred embodiments, the combining is performed to provide a cathode material herein described in which a weight ratio of the S-linked quinone polymer to the sulfurized carbon matrix ranges from 20:1 to 1:20, 10:1 to 1:10, 9:1 to 3:2, or 6:1 to 2:1 or is 1:1.

According to a ninth aspect, an electrochemical cell is described. The electrochemical cell comprises an anode, a cathode, and a non-aqueous electrolyte, wherein the cathode electrode comprises a cathode material described herein. In preferred embodiments, the anode comprises lithium anode material, or potassium anode material, or sodium anode material or a combination thereof as will be understood by a skilled person.

In some embodiments, the cathode material as described comprises lithium and sodium in a molar ratio of Li to Na ranging from 1:10 to 10:1, 4:6 to 6:4, or being 1:1.

In some embodiments, the cathode material as described comprises lithium and potassium in a molar ratio of Li to K ranging from 1:10 to 10:1, 4:6 to 6:4, or being 1:1.

In some embodiments, the cathode material as described comprises sodium and potassium in a molar ratio of Na to K ranging from 1:10 to 10:1, 4:6 to 6:4, or being 1:1.

According to a tenth aspect, a electrochemical cell are herein described, the electrochemical cell comprising an anode, a cathode and an non-aqueous electrolyte, wherein the cathode electrode comprises one or more of the S-linked quinone polymer herein described, alone or in combination with a sulfurized carbon matrix and/or a redox active composite herein described.

According to an eleventh aspect, a method and system are described to provide an electrochemical cell herein described. The method comprises combining an anode electrode with a cathode electrode comprising any cathode material herein described and in particular, one or more of the S-linked quinone polymers herein described, alone or in combination with a sulfurized carbon matrix and/or a redox active composite herein described.

The system comprises anyone of the cathode materials herein described in combination with an anode material for combined use in the method to provide an electrochemical cell herein described.

In preferred embodiments of the methods and systems according to the eleventh aspect, the anode comprises Lithium material.

According to a twelfth aspect, a battery is described, the battery comprising at least one electrochemical cell herein described.

According to a thirteenth aspect, a method and system for making a S-linked quinone homopolymer is described. The method comprises
providing a redox active monomeric quinone monomer X₁-M-X₂, wherein X₁ and X₂ presents a leaving group,
providing a source of sulfide Sp,
contacting the redox active monomeric quinone monomer X₁-M-X₂ with the source of sulfide Sp under suitable conditions and for a sufficient period of time to provide the S-linked quinone polymer represented by Formula (I)

-[M-Sₚ]-ₘ (I)

in which
M is a redox active monomeric quinone moiety having a redox potential of 0.5 V to 3.5 V with reference to Li/Li+ electrode potential under standard conditions,
p refers to the number of sulfur atom linking the redox active a monomeric quinone moiety M, p ranges from 1 to 5,
Sₚ is a sulfide when p is 1 or polysulfide when p is from 2 to 5,
m ranges from 5 to 10,000,
   wherein the S-linked quinone polymer has a weight average molecular weight of at least 1,000 Dalton and a solubility in tetrahydrofuran (THF) of equal or less than 1.0 microgram per mL at 21° C. at 1 atm.
   The system comprises a redox active monomeric quinone monomer X₁-M-X₂, wherein X₁ and X₂ presents a leaving group, and a source of sulfide Sp, for combined used in a method for making a S-linked quinone polymer is described.

According to a fourteenth aspect, a method and system for making a S-linked quinone copolymer is described. The method for making a S-linked quinone copolymer comprises
providing a redox active monomeric quinone monomer X₁-M1-X₂, and a redox active monomeric quinone monomer X₁-M2-X₂ wherein X₁ and X₂ presents a leaving group,
providing a source of sulfide Sₚ₁ and Sₚ₂,
contacting the redox active monomeric quinone monomer X₁-M1-X₂ and redox active monomeric quinone monomer X₁-M2-X₂ with the source of sulfide Sₚ₁ and Sₚ₂ under suitable conditions and for a sufficient period of time to provide the S-linked quinone copolymer represented by Formula (II)

-[M1-Sₚ₁]ₘ₁-co-[M2-Sₚ₂]-ₘ₂ (II)

in which
M1 and M2 are each a redox active monomeric quinone moiety comprising a redox potential of 0.5 V to 3.5 V with reference to Li/Li+ electrode potential under standard conditions,
p1 and p2 each independently refer to a number of sulfur atom linking the redox active monomeric quinone moiety M1 and monomeric quinone moiety M2 respectively, p1 and p2 each independently range from 1 to 5,
Sₚ₁ is a sulfide when p1 is 1 or polysulfide when p1 is from 2 to 5,
Sₚ₂ is a sulfide when p2 is 1 or polysulfide when p2 is from 2 to 5,
m1 and m2 each independently range from 5 to 5,000, optionally a ratio of m1 to m2 ranges from 1:50 to 1:1, 1:20 to 1:2, 1:6 to 1:3, or 1:5 to 1:4,
wherein the S-linked quinone copolymer of Formula (II) has a weight average molecular weight ranging from 1,000 Dalton to 2,000,000 Dalton, and a solubility in tetrahydrofuran (THF) of equal or less than 1.0 microgram per mL at 21° C. at 1 atm.
   The system comprises
a redox active monomeric quinone monomer X₁-M1-X₂, and a redox active monomeric quinone monomer X₁-M2-X₂ wherein X₁ and X₂ presents a leaving group, and
a source of sulfide Sₚ₁ and Sₚ₂,
   for combined use in anyone of the methods for making a S-linked quinone copolymer is described.

The S-linked quinone polymers, sulfurized carbon matrix and related compositions, composites, electrode material, electrodes, electrochemical cells, methods and systems, allow in several embodiments to provide batteries with a high capacity (at least 50 mAh/g for active material or redox active S-linked organosulfur polymer that is utilized), long lifetime (e.g., at least 4 years) and/or low safety hazard including low flammability, and low cost.

The S-linked quinone polymers, sulfurized carbon matrix herein described and related compositions composites, electrode material, electrodes, electrochemical cells, methods and systems allow in several embodiments to provide batteries with low spatial footprint and low replacement.

The S-linked quinone polymers, sulfurized carbon matrix herein described and related compositions, composites, electrode material electrodes, electrochemical cells, methods, and systems as described herein allow in several embodiments to provide batteries having a higher capacity, longer lifetime with respect to existing polymer/metal and sulfur/metal batteries in nonaqueous electrolytes.

Additionally, the S-linked quinone polymers, sulfurized carbon matrix herein described and related compositions, composites, electrode material, electrodes, electrochemical cells, methods and systems, allow in several embodiments to provide Li batteries in nonaqueous electrolytes having a comparable or higher capacity, and longer lifetime with respect to existing batteries based on organic redox active materials.

The S-linked quinone polymers, sulfurized carbon matrix herein described and related composites, electrode materials, electrodes, electrochemical cells, methods and systems herein described can be used in connection with applications wherein electrochemical cell with high capacity, long life low safety hazards, low spatial footprint and/or low replacement are desired. Exemplary applications, but not limited to, comprise batteries for electric vehicles, grid storage, telecommunication, automotive start-stop.

The details of one or more embodiments of the disclosure are set forth in the accompanying drawings and the description below. Other features and objects will be apparent from the description and drawings, and from the claims.

### BRIEF DESCRIPTION OF DRAWINGS

The accompanying drawings, which are incorporated into and constitute a part of this specification, illustrate one or more embodiments of the present disclosure and, together with the description of example embodiments, explain the principles and implementations of the disclosure.

FIG. 1 shows a Table of exemplary S-linked organosulfur polymers including PAQS, 36PPAQS, 27PPAQS, and PAQT as cathode redox active material and the theoretical capacity (mAh/g), voltage vs. Li/Li+ and theoretical energy density (Wh/kg) in a lithium battery. The molecular weight these polymers range from 1,000 Da to 2,000,000 Da. As can be understood by a skilled person, theoretical values consider the amount of charge available to transfer per unit mass or volume by looking at the basic electrochemical processes in the redox reaction (number of electrons, voltage, mass).

FIG. 2 shows structures of S-linked quinone polymers PAQS, 36PPAQS, 27PPAQS, PAQT, and PBQS. The molecular weight of these polymers ranges from 1,000 Da to 2,000,000 Da.

FIG. 3 shows structures of the copolymers of PAQS or PAQT and PBQS. The molecular weight of these polymers ranges from 1,000 Da to 2,000,000 Da.

FIG. 4 shows structures of sulfurized carbon matrix capable of being used as one component in combination with S-linked organosulfur quinone polymers described in FIGS. 1 and 2. SPAN (11) Covalent triazine frameworks (S-CTF-1) (12), Covalent triazine frameworks (SF-CTF-1) (13)Poly(Sulfur random-1,3-diisopropylbenzene)(Poly(S-r-DIB) (14), S-BOP (15), Carbon/polymeric sulfur (C/PS) composites (16), Covalently grafted polysulfur graphene, nanocomposite (PolySGN, 17), Graphene-supported crosslinked sulfur copolymer nanoparticles, cp(STTCA)@ rGO-80 (18) are examples of sulfurized carbon matrices comprising a polymer wherein S is present, for example, as C—S, C—S—S, C—S—S—S, C—S—S—S—S, CSSSSS bonds, as will be understood by a skilled person upon reading of the present disclosure.

FIG. 5 shows a voltage profile (charge and discharge characteristics) of Li//36PPAQS cell in ANA-6 at C/10. C is capacity of battery, (dis)charged over n hours thus C/n=full capacity (dis)charged over n hours so C/10=full capacity discharged (or charged) in 10 hours.

FIG. 6 shows cycling characteristics of Li//36PPAQS cell at C/10 in ANA-6.

FIG. 7 shows Coulombic efficiency vs. cycle number profile of Li//36PPAQS cell in ANA-6.

FIG. 8 shows a voltage profile (charge and discharge characteristics) of Li//PAQT cell in ANA-7 at C/10.

FIG. 9 shows cycling characteristics of Li//PAQT cell at C/10 in ANA-7.

FIG. 10 shows Coulombic efficiency vs. cycle number profile of Li//PAQT cell in ANA-7.

FIG. 11 shows a voltage profile (charge and discharge characteristics) of Li//PAQS:SPAN cell in ANA-4 at C/10.

FIG. 12 shows discharge capacity vs. cycle number of Li//PAQS:SPAN cell in ANA-4 at C/10.

FIG. 13 shows Coulombic efficiency vs. cycle number of Li//PAQS:SPAN cell in ANA-4 at C/10.

FIG. 14 shows energy density (kWh/g) vs. cycle number of Li//PAQS:SPAN cell in ANA-4 at C/10.

FIG. 15 shows a voltage profile (charge and discharge characteristics) of Li//PAQS:SPAN (48:38) cell in ANA-6 at C/10.

FIG. 16 shows discharge capacity vs. cycle number of Li//PAQS:SPAN (48:38) cell in ANA-6 at C/10.

FIG. 17 shows Coulombic efficiency vs. cycle number of Li//PAQS:SPAN (48:38) cell in ANA-6 at C/10.

FIG. 18 shows a voltage profile (charge and discharge characteristics) of Li//PAQS:SPAN (70:20) cell in ANA-4 at C/10.

FIG. 19 shows discharge capacity vs. cycle number of Li//PAQS:SPAN (70:20) cell in ANA-4 at C/10.

FIG. 20 shows Coulombic efficiency vs. cycle number of Li//PAQS:SPAN (70:20) cell in ANA-4 at C/10.

FIG. 21 shows a voltage profile (charge and discharge characteristics) of Li//PAQS0.8-PBQS0.2 cell in ANA-4 at C/10.

FIG. 22 shows a discharge capacity vs cycle number of Li//PAQS0.8-PBQS0.2 cell in ANA-4 at C/10.

FIG. 23 shows Coulombic efficiency vs. cycle number of Li//PAQS0.8-PBQS0.2 cell in ANA-4 at C/10.

FIG. 24 shows a voltage profile (charge and discharge characteristics) of Li//PAQS:S-C cell in ANA-4 at C/10.

FIG. 25 shows discharge capacity vs cycle number of Li//PAQS:S-C cell in ANA-4 at C/10.

FIG. 26 shows Coulombic efficiency vs cycle number of Li//PAQS:S-C cell in ANA-4 at C/10.

FIG. 27 shows a voltage profile (charge and discharge characteristics) of Li//PAQS:S cell in ANA-4 at C/10.

FIG. 28 shows discharge capacity vs cycle number of Li//PAQS:S cell in ANA-4 at C/10.

FIG. 29 shows coulombic efficiency vs cycle number of Li//PAQS:S cell in ANA-4 at C/10.

FIG. 30 shows a comparison of the structures of elemental S (S8) and sulfurized polyacrylonitrile (SPAN).

FIG. 31 top panel shows a schematic representation of an exemplary electrochemical cell including a Li anode and a cathode comprising a organosulfur polymer herein described. FIG. 31 bottom panel shows a schematic representation of an exemplary Pouch Housing electrochemical cell including a Li anode and a cathode comprising a tricyclic compound herein described.

FIG. 32 shows exemplary arrangement of a plurality of electrochemical cells in a battery herein described.

FIG. 33 shows a schematic representation of an exemplary plurality of electrically connected electrochemical cells in accordance with the disclosure.

FIG. 34 shows a voltage profile (charge and discharge characteristics) of Li//Gen4 cell in ANA-42 at C/10.

FIG. 35 shows discharge capacity (mAh/g) vs cycle number of Li//Gen4 cell in ANA-42 at C/10.

FIG. 36 shows coulombic efficiency vs cycle number of Li//Gen4 cell in ANA-42 at C/10.

FIG. 37 shows energy density (Wh/kg) vs cycle number of Li//Gen4 cell in ANA-42 at C/10.

FIG. 38 shows a voltage profile (charge and discharge characteristics) of Li//Gen4 cell in ANA-42 at C/3.

FIG. 39 shows discharge capacity (mAh/g) vs cycle number of Li//Gen4 cell in ANA-42 at C/3.

FIG. 40 shows coulombic efficiency vs cycle number of Li//Gen4 cell in ANA-42 at C/3.

FIG. 41 shows a voltage profile (charge and discharge characteristics) of Li//Gen5 cell in ANA-42 at C/10.

FIG. 42 shows discharge capacity (mAh/g) vs cycle number of Li//Gen5 cell in ANA-42 at C/10.

FIG. 43 shows coulombic efficiency vs cycle number of Li//Gen5 cell in ANA-42 at C/10.

FIG. 44 shows a voltage profile (charge and discharge characteristics) of Li//PAQS_{0.8}-PBQS_{0.2} cell in ANA-5 at C/10.

FIG. 45 shows discharge capacity vs cycle number of Li//PAQS_{0.8}-PBQS_{0.2} cell in ANA-5 at C/10.

### DETAILED DESCRIPTION

Described herein are S-linked quinone polymers, sulfurized carbon matrix polymers and related compositions, electrode material, electrodes, electrochemical cells, batteries, methods, and systems.

The term a “S-linked quinone polymer” as used herein indicates sulfur containing quinone polymers, where monomeric units are linked via a sulfide (—S—) bond. Accordingly, the S-linked quinone polymer are sulfur containing polymer comprising one or more redox active quinone moieties as will be understood by a skilled person.

The term “polymer” as used herein indicates any of a class of natural or synthetic substances composed of very large organic molecules, called macromolecules, which comprises many repeating same and/or different chemical units called monomers. In particular, the word “polymer” comprises any products arising from the linkage of organic repeating units by covalent chemical bonds comprising for example aromatic moieties such as benzene, naphthalene, anthracene and moieties derivable therefrom such as quinones, and aliphatic monomeric unit such as ethylene, propylene, cyclooctadiene, diene, olefin, acrylonitrile, methyl methacrylate, vinyl acetate, dichlorodimethylsilane, tetrafluoroethylene and additional monomers identifiable by a skilled person. Monomers as described herein can include substituent selected from F, Cl, Br, I, CF3, a linear or branched, substituted or unsubstituted C1-C4 aliphatic group, an aromatic, heteroaromatic, non-aromatic cycle, or non-aromatic heterocycle containing substituent containing 4-12 carbon atoms and 0-4 heteroatoms or any suitable substituent identifiable by a skilled person.

Accordingly, S-linked quinone polymers as described herein comprise a polymer in the sense of the disclosure which in turn comprises a redox active quinone monomeric moiety.

The term “redox active” as used herein indicates a chemical moiety (e. g. polymer or monomer or portion thereof) capable of being reversibly oxidized or reduced in a nonaqueous electrolytes to produce a detectable redox potential. Redox active functional groups comprise ketones, aldehydes, and carboxylic acids, imines, organosulfides and additional functional groups identifiable by a skilled person.

In S-linked quinone polymers herein described, the redox active moiety has a redox potential of 0.50 V to 3.5 V with reference to Li/Li+ electrode potential under standard conditions. It is to be understood that a person of skill in the art would know that Li/Li⁺ has a potential of −3.04 V vs. SHE, a potential of a redox moiety relative to the potential of Li/Li⁺ can be converted to a potential of a redox moiety relative to SHE by subtraction of the potential vs. Li/Li⁺ by 3.04 V to give the potential vs. SHE.

Accordingly, the S-linked quinone polymers herein described have a charging capacity as will be understood by a skilled person. As used herein, the wording “charging capacity” is a measurement of the product of current times time of the charge that the anode material accepts until a cutoff voltage is reached. Discharging capacity is the product of current times time of the charge that the cathode material accepts until a cutoff voltage is reached.

$$Q = \frac{n F}{3600 * M W}$$

where Q is the theoretical capacity,
n is the number of electrons exchanged,
F is Faraday's constant, and
MW is the molecular weight of the electroactive material.

Since in S-linked quinone polymer herein described has a redox potential of 0.5 V to 3.5 V with reference to Li/Li+ electrode potential, to increase or decrease the redox potential of a starting redox active monomeric moiety, a substituent group can be selected, based on the Hammett Sigma constant such as the constants shown in the following Table 1.

Since in S-linked quinone polymer herein described has a redox potential of 0.50 V to 3.5V with reference to Li/Li+ electrode potential, to increase or decrease the redox potential of a starting redox active monomeric moiety, a substituent group can be selected, based on the Hammett Sigma constant such as the constants shown in the following Table 1.

TABLE 1
Hammett Sigma Constants*

| Group | Σmeta | σpara | σI | σv | II | Eₛ | MR |
|---|---|---|---|---|---|---|---|
| H | 0.00 | 0.00 | 0.00 | 0.00 | 0.00 | 0.00 | 1.03 |
| CH₃ | −0.07 | −0.17 | −0.04 | 0.52 | 0.56 | −1.24 | 5.65 |
| C₂H₅ | −0.07 | −0.15 | −0.05 | 0.56 | 1.02 | −1.31 | 10.30 |
| n-C₃H₇ | −0.07 | −0.13 | −0.03 | 0.68 | 1.55 | −1.60 | 14.96 |
| i-C₃H₇ | −0.07 | −0.15 | −0.03 | 0.76 | 1.53 | −1.71 | 14.96 |
| n-C₄H₉ | −0.08 | −0.16 | −0.04 | 0.68 | 2.13 | −1.63 | 19.61 |
| t-C₄H₉ | −0.10 | −0.20 | −0.07 | 1.24 | 1.98 | −2.78 | 19.62 |
| H₂C═CH** | 0.05 | −0.02 | 0.09 | 2.11 | 0.82 | | 10.99 |
| C₆H₅** | 0.06 | −0.01 | 0.10 | 2.15 | 1.96 | −3.82 | 25.36 |
| CH₂Cl | 0.11 | 0.12 | 0.15 | 0.60 | 0.17 | −1.48 | 10.49 |
| CF₃ | 0.43 | 0.54 | 0.42 | 0.91 | 0.88 | −2.40 | 5.02 |
| CN | 0.56 | 0.66 | 0.53 | 0.40 | −0.57 | −0.51 | 6.33 |
| CHO | 0.35 | 0.42 | 0.25 | | −0.65 | | 6.88 |
| COCH₃ | 0.38 | 0.50 | 0.29 | 0.50 | −0.55 | | 11.18 |
| CO₂H** | 0.37 | 0.45 | 0.39 | 1.45 | −0.32 | | 6.93 |
| Si(CH₃)₃ | −0.04 | −0.07 | −0.13 | 1.40 | 2.59 | | 24.96 |
| F | 0.34 | 0.06 | 0.52 | 0.27 | 0.14 | −0.46 | 0.92 |
| Cl | 0.37 | 0.23 | 0.47 | 0.55 | 0.71 | −0.97 | 6.03 |
| Br | 0.39 | 0.23 | 0.50 | 0.65 | 0.86 | −1.16 | 8.88 |
| I | 0.35 | 0.18 | 0.39 | 0.78 | 1.12 | −1.40 | 13.94 |
| OH | 0.12 | −0.37 | 0.29 | 0.32 | −0.67 | −0.55 | 2.85 |
| OCH₃ | 0.12 | −0.27 | 0.27 | 0.36 | −0.02 | −0.55 | 7.87 |
| OCH₂CH₃ | 0.10 | −0.24 | 0.27 | 0.48 | 0.38 | | 12.47 |
| SH | 0.25 | 0.15 | 0.26 | 0.60 | 0.39 | −1.07 | 9.22 |
| SCH₃ | 0.15 | 0.00 | 0.23 | 0.64 | 0.61 | −1.07 | 13.82 |
| NO₂** | 0.71 | 0.78 | 0.76 | 1.39 | −0.28 | −2.52 | 7.36 |
| NO | 0.62 | 0.91 | 0.37 | | −0.12 | | 5.20 |
| NH₂ | −0.16 | −0.66 | 0.12 | | −1.23 | −0.61 | 5.42 |
| NHCHO | 0.19 | 0.00 | 0.27 | | −0.98 | | 10.31 |
| NHCOCH₃ | 0.07 | −0.15 | 0.26 | | −0.37 | | 16.53 |
| N(CH₃)₂ | −0.15 | −0.83 | 0.06 | 0.43 | 0.18 | | 15.55 |
| N(CH₃)₃⁺ | 0.88 | 0.82 | 0.93 | 1.22 | −5.96 | | 21.20 |

*σmeta, σpara = Hammett constants; σI = inductive sigma constant; σv = Charton's v (size) values; p = hydrophobicity parameter; Es = Taft size parameter; MR = molar refractivity (polarizability) parameter.
**indicates that the group is in the most sterically hindered conformation.

For example, to increase redox potential of a starting redox active monomeric moiety having an aromatic ring, a CN or a CF3 group can be comprised as can be comprised in view of the related Hammett Sigma Constant. Additional modifications to increase or decrease the redox potential of a starting moiety will be understood by a skilled person upon reading of the present disclosure.

In some embodiments, where the S-linked quinone polymers herein described the redox active moiety is provided by the quinone moiety of the polymer.

The term “quinones” and related moieties as used herein indicates a class of organic compounds that are formally “derived from aromatic compounds [such as benzene or naphthalene] by conversion of an even number of —CH═groups into —C(═O)— groups with any necessary rearrangement of double bonds, resulting in “a fully conjugated cyclic dione structure [1] [2] [3] [4] [5]. Exemplary quinones comprises moieties such as 1,4-benzoquinone or cyclohexadienedione, often called simply “quinone” (thus the name of the class). Other examples are 1,2-benzoquinone (ortho-quinone), 1,4-naphthoquinone and 9,10-anthraquinone [5]. Other quinones include 2,5-dichloroanthraquinone, 3,6-dibromo-phenanthrequinone, 2,7-dibromo-phenanthrequinone, and 1,2,5,6-anthracenetetraone as described herein, as well as additional quinones as will be understood by a skilled person.

In some embodiments herein described, S-link quinone polymers comprise homopolymers of 2,5-S -linked-anthraquinone (PAQS), 3,6-S -linked-phenanthrequinone (36PPAQS), 2,7-S -linked-phenanthrequinone (27PPAQS), and 9,10-S -linked-1,2,5,6-anthracenetetraone (PAQT) as described herein, as well co-polymers in a configuration such as alternating copolymer, random copolymer, block copolymer and graft copolymer, as will be understood by a skilled person. An exemplary random copolymer as described herein is poly-anthraquinone-benzoquinone sulfide (PAQS-BQ) of Example 34. Additional quinone copolymers in the sense of the disclosure are identifiable by a skilled person.

In some examples, S-linked polymer is obtained via the reaction between chlorinated or brominated quinone monomer and Na₂S at 120-150° C.

In some embodiments, a S-linked quinone polymer of the present disclosure can be S-linked homopolymers represented by Formula (I)

-[M-Sₚ]-ₘ (I)

in which
M is a redox active a monomeric quinone moiety comprising a redox potential of 0.5 V to 3.5 V with reference to Li/Li+ electrode potential under standard conditions,
p refers to the number of sulfur atom linking the redox active monomeric quinone moiety M, p ranges from 1 to 5,
Sₚ is a sulfide when p is 1 or polysulfide when p is from 2 to 5,
m ranges from 5 to 10,000,
wherein the S-linked quinone polymer has a weight average molecular weight of at least 1,000 Dalton and a solubility in tetrahydrofuran (THF) of equal or less than 1.0 microgram per mL at room temperature (i.e. 21° C.) at 1 atm, preferably a solubility in tetrahydrofuran (THF) of equal or less than 0.1 microgram per mL at room temperature at 1 atm, more preferably a solubility in tetrahydrofuran (THF) of equal or less than 0.01 microgram per mL at room temperature at 1 atm.

In some embodiments, at least one redox active monomeric moiety M of Formula (I) can be represented by Formula (III):

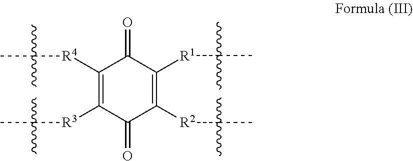

wherein R¹, R², R³, and R⁴ are each independently null, H, Sₚ wherein p ranges from 1 to 5, F, Cl, Br, I, CF3, a linear or branched, substituted or unsubstituted C1-C4 aliphatic group, an aromatic, heteroaromatic, non-aromatic cycle, or non-aromatic heterocycle containing substituent containing 4-12 carbon atoms and 0-4 heteroatoms,
wherein heteroatoms are selected from O, N, and S, R¹ and R² together and/or R³, and R⁴ together are part of an aromatic or aliphatic cyclic structure, and
wherein dash line - - - - - - represents null or a single bond to quinone ring carbon when associated R¹, R², R³, or R⁴ is null.

In some embodiments, the at least one redox active monomeric moiety M of Formula (I) represented by Formula (III) can be any one of S-linked monomeric moiety -S-M of Formula (IIIA) and Formula (IIIB)

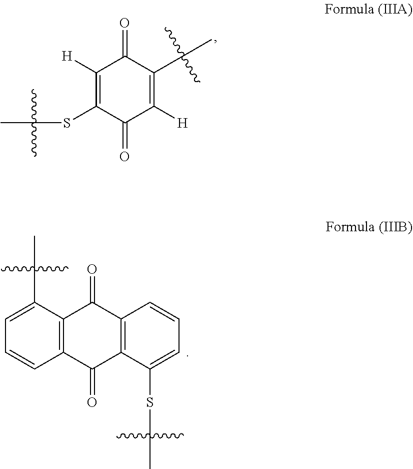 [SMILES: *SC1=CC(=O)C(*)=CC1=O ; *Sc1cccc2c1C(=O)c1cccc(*)c1C2=O]

In some embodiments, the at least one redox active monomeric moiety M of Formula (I) can be represented by Formula (IV):

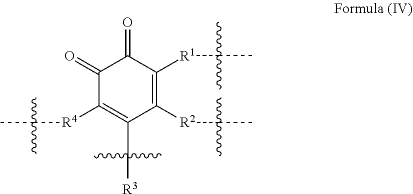

wherein R¹, R², R³, and R⁴ are each independently null, H, Sₚ wherein p ranges from 1 to 5, F, Cl, Br, I, CF3, a linear or branched, substituted or unsubstituted C1-C4 aliphatic group, an aromatic, heteroaromatic, non-aromatic cycle, or non-aromatic heterocycle containing substituent containing 4-12 carbon atoms and 0-4 heteroatoms,
wherein heteroatoms are selected from O, N, and S, R¹ and R² together and/or R³, and R⁴ together are part of an aromatic or aliphatic cyclic structure, and
wherein dash line - - - - - - represents null or a single bond to quinone ring carbon when associated R¹, R², R³, or R⁴ is null.

In some embodiments, the at least one redox active monomeric moiety M of Formula (I) represented by Formula (IV) can be any one of S-linked monomeric moiety as shown in Formula (IVA), Formula (IVB), Formula (IVC)

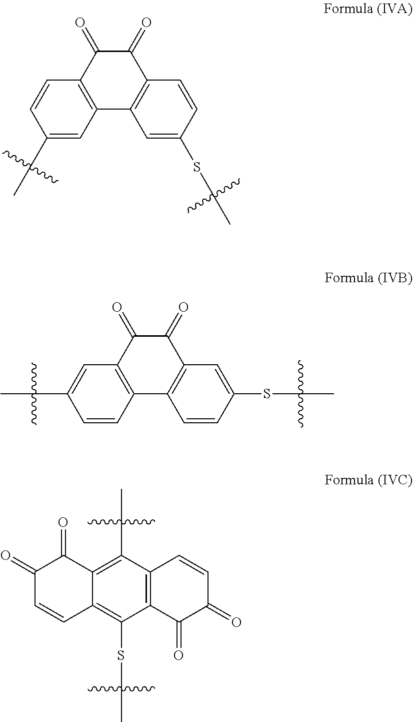 [SMILES: *Sc1ccc2c(c1)-c1cc(*)ccc1C(=O)C2=O ; *Sc1ccc2c(c1)C(=O)C(=O)c1cc(*)ccc1-2 ; *Sc1c2ccc(=O)c(=O)c2c(*)c2ccc(=O)c(=O)c12]

In some embodiments, the source of sulfide Sp includes but is not limited to elemental sulfur S8, Na₂S, Li₂S, K₂S any other sulfur containing compound known to a skilled person.

In some embodiments, a S-linked quinone polymer of the present disclosure can be a S-linked copolymer represented Formula (II)

-[M1-Sₚ₁]ₘ₁-co-[M2-Sₚ₂]-ₘ₂ (II)

in which
M1 and M2 are each a redox active monomeric quinone moiety comprising a redox potential of 0.5 V to 3.5 V with reference to Li/Li+ electrode potential under standard conditions,
p1 and p2 each independently refer to the number of sulfur atom linking the redox active a monomeric quinone moiety M1 and M2 respectively, p1 and p2 each independently range from 1 to 5,
Sₚ₁ is a sulfide when p1 is 1 or polysulfide when p1 is from 2 to 5,
Sₚ₂ is a sulfide when p2 is 1 or polysulfide when p2 is from 2 to 5,
m1 and m2 each independently range from 5 to 5,000, optionally a ratio of m1 to m2 ranges from 1:50 to 1:1, 1:20 to 1:2, 1:6 to 1:3, or 1:5 to 1:4,
wherein the S-linked quinone copolymer of Formula (II) has a weight average molecular weight of at least 1,000 Dalton and a solubility in tetrahydrofuran (THF) of equal or less than 1.0 microgram per mL at room temperature at 1 atm, preferably a solubility in tetrahydrofuran (THF) of equal or less than 0.1 microgram per mL at room temperature at 1 atm, more preferably a solubility in tetrahydrofuran (THF) of equal or less than 0.01 microgram per mL at room temperature at 1 atm.

Formula (II) represents any arrangements of M1 and M2 moieties in the S-linked copolymer including random copolymer, block copolymer and alternate copolymer.

In particular, some embodiments, redox active monomer M1, redox active monomer M2, in a S-linked co-polymer can be a statistical random copolymer in which redox active monomer M1, redox active monomer M2, are statistically randomly present in the network polymer. Exemplary statistically random copolymer of M1 and M2 can be represented as

-M1-S-M2-S-M1-S-M2-S-M1-S-M1-S-M2-S-M1-S-M2-S-M2-S-

In some embodiments, a method for making a S-linked quinone copolymer is described. The method comprising
providing a redox active monomeric quinone monomer X₁-M1-X₂, and a redox active monomeric quinone monomer X₁-M2-X₂ wherein X₁ and X₂ presents a leaving group,
providing a source of sulfide Sₚ₁ and Sₚ₂,
contacting the redox active monomeric quinone monomer X₁-M1-X₂ and redox active monomeric quinone monomer X₁-M2-X₂ with the source of sulfide Sₚ₁ and Sₚ₂ under suitable conditions and for sufficient period of time to provide the S-linked quinone copolymer represented by Formula (II)

-[M1-Sₚ₁]ₘ₁-co-[M2-Sₚ₂]-ₘ₂ (II)

in which
M1 and M2 are each a redox active monomeric quinone moiety comprising a redox potential of 0.5 V to 3.5 V with reference to Li/Li+ electrode potential under standard conditions,
p1 and p2 each independently refer to a number of sulfur atom linking the redox active monomeric quinone moiety M1 and monomeric quinone moiety M2 respectively, p1 and p2 each independently range from 1 to 5,
Sₚ₁ is a sulfide when p1 is 1 or polysulfide when p1 is from 2 to 5,
Sₚ₂ is a sulfide when p2 is 1 or polysulfide when p2 is from 2 to 5,
m1 and m2 each independently range from 5 to 5,000, optionally a ratio of m1 to m2 ranges from 1:50 to 1:1, 1:20 to 1:2, 1:6 to 1:3, or 1:5 to 1:4,
wherein the S-linked quinone copolymer of Formula (II) has a weight average molecular weight ranging from 1,000 Dalton to 2,000,000 Dalton, and a solubility in tetrahydrofuran (THF) of equal or less than 1.0 microgram per mL at 21° C. at 1 atm.

In some embodiments, the leaving group X1 and X 2 can be independently selected from Cl⁻, Br⁻, I⁻, ⁻OTs, ⁻OMs, ⁻OTf or any other leaving groups known to a skilled person.

In some embodiments, the source of sulfide Sₚ₁ and Sₚ₂ includes but is not limited to elemental sulfur S8, Na₂S, Li₂S, K₂S any other sulfur containing compound known to a skilled person.

In some embodiments, redox active monomer M1, redox active monomer M2, in a S-linked co-polymer can be an alternating copolymer in which redox active monomer M1, redox active monomer M2, present alternately in a S-linked co-polymer. Exemplary alternating S-linked copolymer of M1 and M2 can be represented as
-M1-S-M2-S-M1-S-M2-S-M1-S-M2-S-M1-S-M2-S-M1-S-M2-S-.

In some embodiments, redox active monomer M1, redox active monomer M2 in a S-linked co-polymer can be an M1M2 di-block copolymer in which redox active monomer M1, redox active monomer M2, present only in a sequence of at least 5 moieties in the S-linked co-polymer. Exemplary M1M2 di-block S-linked copolymer of M1 and M2 can be represented as
-M1-S-M1-S-M1-S-M1-S-M1-S-M1-S-M2-S-M2-S-M2-S-M2-S-M2-S-M2-S-.

In some embodiments, redox active monomer M1, redox active monomer M2 in a S-linked co-polymer represent an M1M2M1 tri-block copolymer in which one of redox active monomer M1 and redox active monomer M2 present in at least two sequences of at least 5 moieties separated by a sequence of different moiety in the network polymer. Exemplary M1M2 tri-block copolymer of M1 and M2 can be represented as
M1-S -M1-S -M1-S -M1-S -M1-S -M2-S -M2-S -M2-S -M2-S -M2-S -M1-S -M1-S -M1-S -M1-S-M1-S-M1-S-.

In some embodiments, the redox active monomeric quinone moiety M1 and redox active monomeric quinone moiety M2 of Formula (II) can be independently represented by any one of Formula (III) and Formula (IIV):

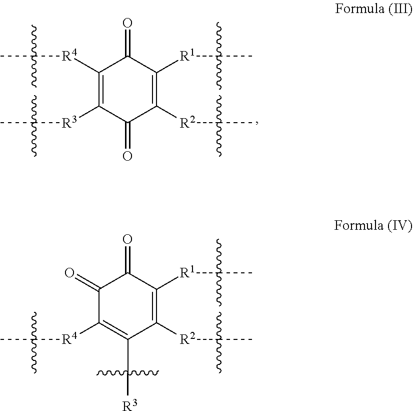

wherein R¹, R², R³, and R⁴ are each independently null, H, Sp wherein p ranges from 1 to 5, F, Cl, Br, I, CF3, a linear or branched, substituted or unsubstituted C1-C4 aliphatic group, an aromatic, heteroaromatic, non-aromatic cycle, or non-aromatic heterocycle containing substituent containing 4-12 carbon atoms and 0-4 heteroatoms,
wherein heteroatoms are selected from O, N, and S, R¹ and R² together and/or R³, and R⁴ together are part of an aromatic or aliphatic cyclic structure, and
wherein dash line [symbol] represents null or a single bond to quinone ring carbon when associated R¹, R², R³, or R⁴ is null.

In some embodiments, S-linked redox active monomeric quinone moiety -S-M1 and S-linked redox active monomeric quinone moiety -S-M2 of Formula (II) can be independently any one of S-linked monomeric moiety -S-M of Formula (IIIA), Formula (IIIB), Formula (IVA), Formula (IVB), and Formula (IVC)

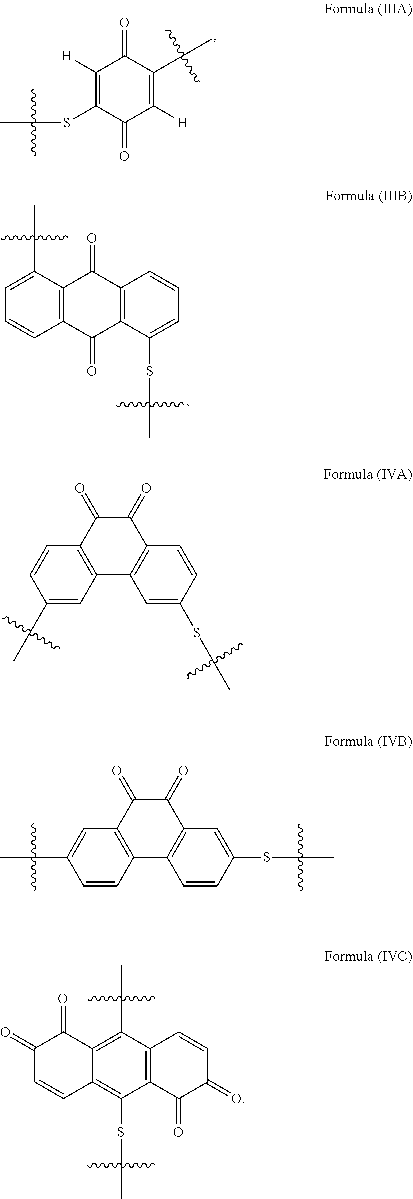 [SMILES: *SC1=CC(=O)C(*)=CC1=O ; *Sc1cccc2c1C(=O)c1cccc(*)c1C2=O ; *Sc1ccc2c(c1)-c1cc(*)ccc1C(=O)C2=O ; *Sc1ccc2c(c1)C(=O)C(=O)c1cc(*)ccc1-2 ; *Sc1c2ccc(=O)c(=O)c2c(*)c2ccc(=O)c(=O)c12]

In some embodiments, a S-linked copolymer comprises S-linked redox active monomeric quinone moiety -S-M1 S-linked monomeric moiety -S-M of Formula (IIIA),

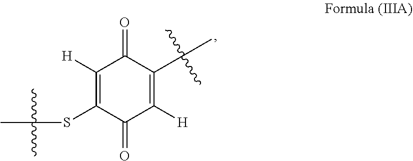 [SMILES: *SC1=CC(=O)C(*)=CC1=O]

and S-linked redox active monomeric quinone moiety -S-M2 of Formula (II) any one of S-linked monomeric moiety -S-M of Formula (IIIB), Formula (IVA), Formula (IVB), and Formula (IVC),

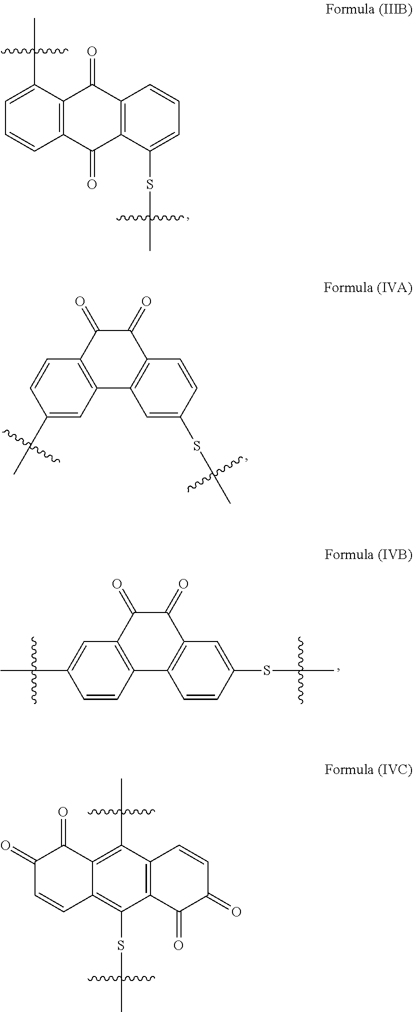 [SMILES: *Sc1cccc2c1C(=O)c1cccc(*)c1C2=O ; *Sc1ccc2c(c1)-c1cc(*)ccc1C(=O)C2=O ; *Sc1ccc2c(c1)C(=O)C(=O)c1cc(*)ccc1-2 ; *Sc1c2ccc(=O)c(=O)c2c(*)c2ccc(=O)c(=O)c12]

wherein a molar ratio of S-linked monomeric moiety -S-M1 of Formula (IIIA) to S-linked monomeric moiety -S-M2 of Formula (IIIB), Formula (IVA), Formula (IVB), or Formula (IVC) ranges from 1:50 to 1:1, 1:20 to 1:2, 1:6 to 1:3, or 1:5 to 1:4, or
wherein a molar ratio of S-linked monomeric moiety -S-M1 of Formula (IIIA) to S-linked monomeric moiety -S-M2 of Formula (IIIB), Formula (IVA), Formula (IVB), or Formula (IVC) can be 1:4.

In some embodiments, a S-linked copolymer as described comprises the redox active monomeric quinone moiety M1 and redox active monomeric quinone moiety M2 of Formula (II) can be independently represented by Formula (III):

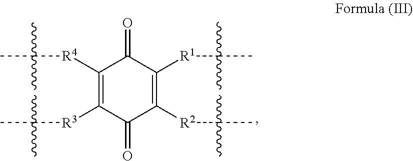

wherein R¹, R², R³, and R⁴ are each independently null, H, Sₚ wherein p ranges from 1 to 5, F, Cl, Br, I, CF3, a linear or branched, substituted or unsubstituted C1-C4 aliphatic group, an aromatic, heteroaromatic, non-aromatic cycle, or non-aromatic heterocycle containing substituent containing 4-12 carbon atoms and 0-4 heteroatoms,
wherein heteroatoms are selected from O, N, and S, R¹ and R² together and/or R³, and R⁴ together are part of an aromatic or aliphatic cyclic structure, and
wherein dash line [symbol] represents null or a single bond to quinone ring carbon when associated R¹, R², R³, or R⁴ is null.

In some embodiments, S-linked redox active monomeric quinone moiety -S-M1 and S-linked redox active monomeric quinone moiety -S-M2 of Formula (II) can be S-linked monomeric moiety -S-M of Formula (IIIA) and Formula (IIIB)

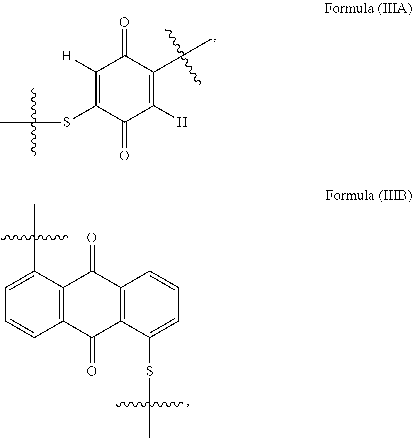 [SMILES: *SC1=CC(=O)C(*)=CC1=O ; *Sc1cccc2c1C(=O)c1cccc(*)c1C2=O]

wherein a molar ratio of S-linked monomeric moiety -S-M1 of Formula (IIIA) to S-linked monomeric moiety -S-M2 of Formula (IIIB) ranges from 1:50 to 1:1, 1:20 to 1:2, 1:6 to 1:3, or 1:5 to 1:4.

In some embodiments, a redox active S-linked copolymer PAQS_{0.8}BQ_{0.2} is described wherein S-linked redox active monomeric quinone moiety -S-M1 and S-linked redox active monomeric quinone moiety -S-M2 of Formula (II) can be independently any one of S-linked monomeric moiety -S-M of Formula (IIIA) and Formula (IIIB)

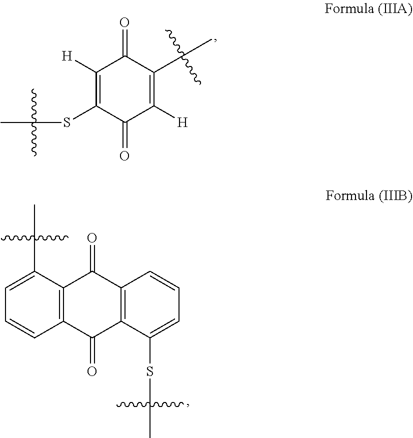 [SMILES: *SC1=CC(=O)C(*)=CC1=O ; *Sc1cccc2c1C(=O)c1cccc(*)c1C2=O]

wherein a molar ratio of S-linked monomeric moiety -S-M of Formula (IIIA) to Formula (IIIB) can be 1:4.

In some embodiments, the redox active monomeric quinone moiety M1 and redox active monomeric quinone moiety M2 of Formula (II) can be represented by Formula (IV):

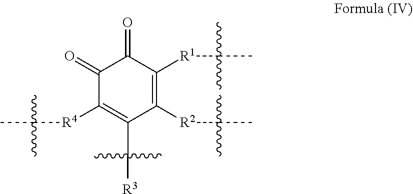

wherein R¹, R², R³, and R⁴ are each independently null, H, Sₚ wherein p ranges from 1 to 5, F, Cl, Br, I, CF3, a linear or branched, substituted or unsubstituted C1-C4 aliphatic group, an aromatic, heteroaromatic, non-aromatic cycle, or non-aromatic heterocycle containing substituent containing 4-12 carbon atoms and 0-4 heteroatoms,
wherein heteroatoms are selected from O, N, and S, R¹ and R² together and/or R³, and R⁴ together are part of an aromatic or aliphatic cyclic structure, and
wherein dash line [symbol] represents null or a single bond to quinone ring carbon when associated R¹, R², R³, or R⁴ is null.

In some embodiments, S-linked redox active monomeric quinone moiety -S-M1 and S-linked redox active monomeric quinone moiety -S-M2 of Formula (II) represented by Formula (IV) can be any one of S-linked monomeric moiety as shown in Formula (IVA), Formula (IVB), Formula (IVC)

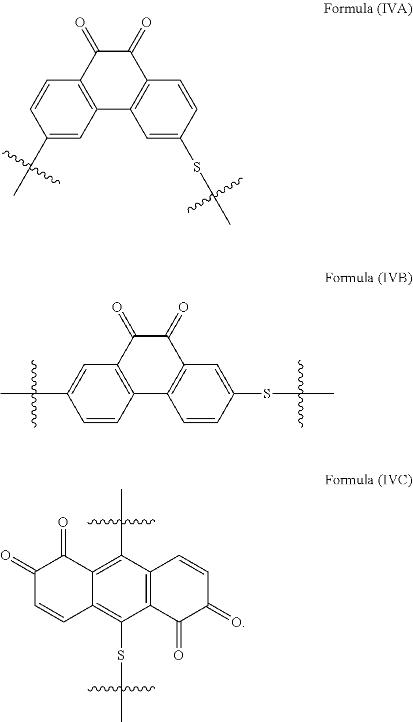 [SMILES: *Sc1ccc2c(c1)-c1cc(*)ccc1C(=O)C2=O ; *Sc1ccc2c(c1)C(=O)C(=O)c1cc(*)ccc1-2 ; *Sc1c2ccc(=O)c(=O)c2c(*)c2ccc(=O)c(=O)c12]

In some embodiments, herein described one or more S-linked polymers herein described alone or in various combinations identifiable by a skilled person are comprised within a composite material together with one or more sulfurized carbon matrices.

The term a “sulfurized carbon matrix” or “sulfur-incorporated carbon matrices” as used herein indicates carbon based matrix wherein elemental sulfur is embedded into a carbon based matrix wherein the elemental sulfur is linked to a C atom of the matrix material, in structures such as C—S, C—S—S, C—S—S—S, C—S—S—S—S, CSSS SS bonds or other higher polysulfide. The term “carbon matrix” as used herein indicates a solid carbon-based material wherein inorganic graphite or organic monomeric moieties of the polymeric matrix are configured to link to a C atom within a surrounding organic mass, a Group 16 element, and in particular S, as described herein in the form of C—S, C—S—S, C—S—S—S, C—S—S—S—S, CSSSSS bonds. For example, any configuration of aromatic monomer herein described linked to one another in any configuration resulting in the presentation of the C S, C—S—S, C—S—S—S, C—S—S—S—S, CSS SS S bonds on the resulting organic moieties for electrochemical reactions with other molecules or compounds such as an electrolyte and/or S-linked polymer herein described. Exemplary carbon based matrix includes graphite, polyacrylonitrile, as well as additional carbon based matrices as would be understood by a skilled person.

The sulfurized carbon matrices herein described can be provided by sulfurizing elemental sulfur at high temperature in presence of a polymer comprising aromatic moieties to form a carbon-based matrix wherein the sulfur atom bonded into the matrix and carbonized at a suitable temperature, suitable temperature can be for example, >300° C. and preferably >500° C., or ranges from 300° C. to 1000° C., or from 500° C. to 800° C.

Sulfur-incorporated carbon matrices can deliver a relatively high theoretical capacity based on reversible breakage and formation of disulfide (S-S) bonds. Three types of organosulfur cathodes are being used: (i) small organosulfur molecules, (ii) high sulfur content polymers, and (iii) sulfurized polymers. Small organosulfur molecules are soluble in organic electrolytes, therefore their use as cathode active materials is limited. High sulfur content polymers and sulfurized polymers are not soluble in organic solvents, but they still form small amount of soluble polysulfides during deep discharge, consequently overcharging such soluble sulfides during the charge process due to shuttle mechanism. Even though a significant progress is made over the years for realizing organosulfur polymers as cathode active materials for practical batteries, but significant hurdles need to overcome due to shuttle effects, high electrolyte loading, high conducting carbon loading, and low tap density.

In some embodiments the sulfur-incorporated carbon matrices can be SPAN (sulfurized poly[acrylonitrile]), a sulfurized carbon matrix polymer of elemental sulfur and polyacrylonitrile which exhibit high capacity (>200 mAh/g from 3.0 to 0.500 V) with better cycling stability compared to standard sulfur cathodes in electrochemical cells with a lithium anode; however, the majority of the capacity is accessed at lower potentials than conventional Li/S cells (lower than 2.0V, for example) so is less preferred in comparison to Li/S compositions. The overall S content in SPAN is ˜30 to 50% and its capacity can vary from 300-800 mAh/g of SPAN. Those features can be found in other sulfurized carbon matrix polymer which can have an overall S content of ˜30 to 50 w/w % with respect to the total weight of the sulfurized carbon matrix polymer and a capacity varying from 300-800 mAh/g of active polymer as will be understood by a skilled person.

In some embodiments, a redox active composite as described herein comprises a sulfurized carbon matrix represented by Formula (V), wherein Q is a bonded sp2 carbon atom (C) or a nitrogen (N), wherein [symbol] represents a single or double bond, Sₚ represents a polysulfide and p ranges from 2 to 8, wherein the sulfurized carbon matrix has a weight averaged MW ranging from 2000 to 2,000,000 Daltons, from 10,000 to 1,500,000 Daltons, from 100,000 to 1,000,000 Daltons,

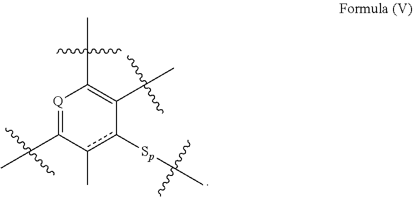

In some embodiments, the sulfurized carbon matrix has a sulfur content based on the total weight of the sulfurized carbon matrix equal to or greater than 5 wt % and less than 20 wt %, equal to or greater than 20 wt % and less than 40 wt %, equal to or greater than 40 wt % less than 60 wt %, equal to or greater than 60 wt % less than 70 wt %, equal to or greater than 70 wt % less than 80 wt %.

In some embodiments, the redox active composite as disclosed herein comprises a sulfurized carbon matrix represented by Formula (V), wherein Q is N.

In some embodiments, the redox active composite as disclosed herein comprises a sulfurized carbon matrix represented by Formula (V), wherein Q is C.

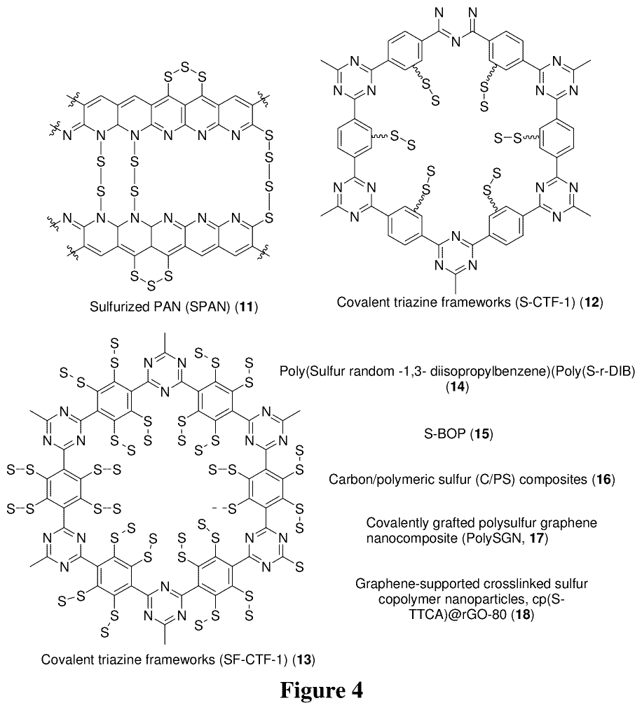

In some embodiments, sulfurized carbon matrix of the Formula (V) can be selected from any one shown in Examples in FIG. 4 including sulfurized carbon matrix polymers SPAN (11), covalent trizaine frameworks (S-CTF-1) (12), covalent trizaine frameworks (S-CTF-1) (13), poly(sulfur random-1,3-diisopropylbenzene) (poly(S-r-DIB) (14), S-BOP (15), carbon/polymeric sulfur (C/PS) composite (16), covalently grafted polysulfur graphene nanocomposite (PolySGN, 17), and Graphene-supported crosslinked sulfur copolymer nanoparticles, cp(S-TTCA)@rGO-80 (18) or any combination thereof.

In some embodiments, the redox active composite as disclosed herein comprises a S-linked quinone polymer represented Formula (I)

-[M-Sₚ]-ₘ (I)

in which
M is a redox active a monomeric quinone moiety comprising a redox potential of 0.5 V to 3.3 V with reference to Li/Li+ electrode potential under standard conditions,
p refers to the number of sulfur atom linking the redox active a monomeric quinone moiety M, p ranges from 1 to 5,
Sₚ is a sulfide when p is 1 or polysulfide when p is from 2 to 5,
m ranges from 5 to 10,000,
wherein the S-linked quinone polymer has a weight average molecular weight of at least 1500 Dalton or a weight averaged MW ranging from 2000 to 2,000,000 Daltons, from 10,000 to 1,500,000 Daltons, from 100,000 to 1,000,000 Daltons, and a solubility in tetrahydrofuran (THF) of equal or less than 1.0 microgram per mL at room temperature at 1 atm, preferably a solubility in tetrahydrofuran (THF) of equal or less than 0.1 microgram per mL at room temperature at 1 atm, more preferably a solubility in tetrahydrofuran (THF) of equal or less than 0.01 microgram per mL at room temperature at 1 atm, and
   a sulfurized polymer represented by Formula (V), wherein Q is a bonded sp2 carbon atom(C) or a nitrogen (N), wherein [symbol] represents a single or double bond, Sₚ represents a polysulfide and p ranges from 2 to 8, wherein the sulfurized polymer has a weight averaged MW of at least 2000, 10,000, 100,000, or 1,000,000, or a weight averaged MW ranging from 2000 to 2,000,000 Daltons, from 10,000 to 1,500,000 Daltons, from 100,000 to 1,000,000 Daltons,

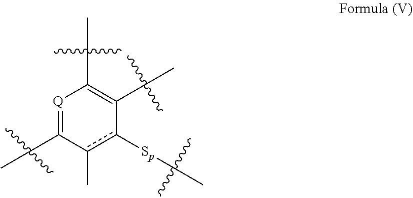

wherein a weight ratio of the S-linked quinone polymer represented Formula (I) and sulfurized polymer represented by Formula (V) ranges from 20:1 to 1:20, 10:1 to 1:10, 9:1 to 3:2, or 6:1 to 2:1.

In some embodiment, the redox active material as described herein further comprises a binder, and a conductive additive, wherein the binder is selected from one of poly(vinylidene-fluoride), poly(tetrafluoroethylene), sodium carboxymethylcellulose, lithium carboxymethylcellulose, potassium carboxymethylcellulose styrene-butadiene rubber, polyacrylic acid (PAA), polyvinyl alcohol (PVA), polyethylene glycol (PEG), polyethylene oxide (PEO), polyamide imide (PAI), or any combination thereof, wherein the conductive additive is selected from one of graphite, carbon black, acetylene black, Super-P carbon, graphite, carbon nanotubes, vapor grown carbon fiber, graphene, nickel powder, KB and SP65 or any combination thereof.

As used herein, a conductive additive is a solid material which when present in the electrode composition enhances the electrical conductivity of the resulting electrode composition.

In some embodiment, in the redox active composite as described herein the binder is present in 1 to 20% by weight of the total electrode composition, and the conductive additive is present in 5 to 70% by weight of the total electrode composition.

In some embodiments, the redox active composite as disclosed herein comprises a S-linked quinone copolymer represented by Formula (II)

-[M1-Sₚ₁]ₘ₁-co-[M2-Sₚ₂]-ₘ₂ (II)

in which
M1 and M2 are each a redox active a monomeric quinone moiety comprising a redox potential of 0.5 V to 3.5 V with reference to Li/Li+ electrode potential under standard conditions,
p1 and p2 each independently refer to the number of sulfur atom linking the redox active a monomeric quinone moiety M1 and M2 respectively, p1 and p2 each independently range from 1 to 5,
Sₚ₁ is a sulfide when p1 is 1 or polysulfide when p1 is from 2 to 5,
Sₚ₂ is a sulfide when p2 is 1 or polysulfide when p2 is from 2 to 5,
m1 and m2 each independently range from 5 to 5,000, optionally a ratio of m1 to m2 ranges from 1:50 to 1:1, 1:20 to 1:2, 1:6 to 1:3, or 1:5 to 1:4,
   wherein the S-linked quinone copolymer of Formula (II) has a weight average molecular weight of at least 1000 Dalton or a weight averaged MW ranging from 2000 to 2,000,000 Daltons, from 10,000 to 1,500,000 Daltons, from 100,000 to 1,000,000 Daltons, and a solubility in tetrahydrofuran (THF) of equal or less than 1.0 microgram per mL at room temperature at 1 atm, preferably a solubility in tetrahydrofuran (THF) of equal or less than 0.1 microgram per mL at room temperature at 1 atm, more preferably a solubility in tetrahydrofuran (THF) of equal or less than 0.01 microgram per mL at room temperature at 1 atm, and
   a sulfurized polymer represented by Formula (V), wherein Q is a bonded sp2 carbon atom (C) or a nitrogen (N), wherein [symbol] represents a single or double bond, Sₚ represents a polysulfide and p ranges from 2 to 8, wherein the sulfurized polymer has a weight averaged MW of at least 2000, 10,000, 100,000, or 1,000,000, or a weight averaged MW ranging from 2000 to 2,000,000 Daltons, from 10,000 to 1,500,000 Daltons, from 100,000 to 1,000,000 Daltons,

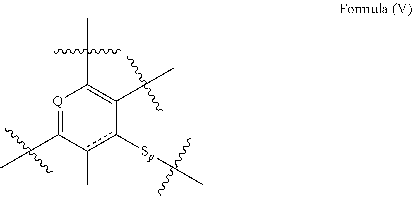

wherein a weight ratio of the S-linked quinone copolymer represented Formula (II) and sulfurized polymer represented by Formula (V) ranges from 20:1 to 1:20, 10:1 to 1:10, 9:1 to 3:2, or 6:1 to 2:1, or is 1:1.

In some embodiments the S-linked polymers, the sulfurized carbon matrix, and/or composite material herein described can be comprised in redox active composition further comprising one or more additives herein.

As used herein, an “additive” indicates any component other than the redox active polymers or sulfurized carbon matrix which enhances the mechanical, physical, electrical or electrochemical properties of the electrode material. Exemplary additive includes binder and conductive additives.

In some embodiments the S-linked polymers, the sulfurized carbon matrix, composite material and/or redox compositions herein described can be comprised in a cathode material, and in particular, in a cathode material configured to enable contact with a non-aqueous electrolyte of an electrochemical cells.

In embodiments herein described the S-linked polymer and/or composite material of the disclosure can be comprised within an electrochemical cell.

As used herein, an “electrochemical cell” refers to a device capable of generating electrical energy by chemical reaction, or a device capable of using electrical energy to drive a chemical reaction, or both.

The electrochemical cells which generate an electric current are called voltaic cells or galvanic cells and those that generate chemical reactions, via electrolysis for example, are called electrolytic cells.

In particular voltaic cell (galvanic cell) is an electrochemical cell that generates electrical energy through redox (reduction-oxidation) reactions in the cell. An electrochemical cell can also use externally applied electrical energy to drive a redox reaction within the cell, referred to as an electrolytic cell. A fuel cell is an electrochemical cell that generates electrical energy from a fuel through electrochemical reaction of hydrogen with an oxidizing agent.

A voltaic cell or a redox generating electrochemical cell can include a permeable barrier between the two electrodes that allow anions and/or cations to pass from the electrolyte in contact with one electrode to the electrolyte in contact with the other electrode.

As used herein, “electrode” refers an electrically conductive material that makes contact with a non-conductive element. In the case of an electrochemical cell, the non conductive element is an electrolyte where the chemical reactions occur. The two types of electrodes in cell are the anode and cathode. The anode is the electrode where electrons leave the electrochemical cell and where oxidation occurs. The cathode is the electrode where electrons enter the cell and where reduction occurs. By convention, anodes are considered “negative” and cathodes are considered “positive” when producing electrical energy. When the cell is using electrical energy to drive a reaction (e.g., when a rechargeable battery is charging), then the cathode is negative with respect to the anode's polarity and the convention is usually (but not always) reversed. A cell can change between energy producing (voltaic) and redox producing (electrolytic) by changing the externally applied voltage between the electrodes (changing the direction of the current through the cell).

An “electric current” or “electrical current” by the sense of the description can be described as a flow of positive charges or as an equal flow of negative charges in the opposite direction. Electrical current, by convention, goes from cathode to anode (the opposite of the flow of electrons) outside the cell, regardless of method of operation (voltaic vs. electrolytic).

The electrochemical cell as described herein can contain a cathode on a metal substrate with current collector and an anode on a metal substrate with current collector which are separated by a semipermeable insulative membrane. The cell contains a non-aqueous salt solution that conducts ions. These components are placed within a container. Any of the cathode or anode can comprise the redox active composition as described herein.

In particular in some embodiments, an electrochemical cell is described comprising an anode, a cathode and a non-aqueous electrolyte, wherein the anode electrode comprises the network polymer of Formula (I) and/or the network dendrimer of Formula (II) herein described.

As used herein, “electrolyte” refers to a liquid or mixture of liquid and solid that contains at least a cation and a counterion for conducting ions during an electrochemical reaction in an electrochemical cell. In some embodiments as described herein, the cation of the electrolyte can be lithium ion.

The electrolyte as described herein can have a mixture of a cyclic carbonate of ethylene carbonate (EC) or mono-fluoroethylene carbonate (FEC) co-solvent, ethyl methyl carbonate (EMC), a flame retardant additive, a lithium salt, and an electrolyte additive that improves compatibility and performance of the lithium-ion battery.

The lithium salt of the electrolyte as described herein can be selected from the group consisting of lithium hexafluorophosphate (LiPF₆), lithium tetrafluoroborate (LiBF₄), lithium bis(oxalato)borate (LiBOB), lithium hexafluoroarsenate (LiAsF₆), lithium perchlorate (LiClO₄), lithium trifluoromethanesulfonate (LiCF₃SO₃), lithium bistrifluoromethanesulfonate sulfonyl imide (LiN(SO₂CF₃)₂), LiFSI and mixtures thereof.

The electrolyte additive as described herein can include lithiumbis(oxalato)borate (LiBOB), lithium difluoro(oxalato)borate (LiODFB), lithium tetrafluorooxalatophosphate (LiPF₄(C₂O₄)), and mixtures thereof.

The flame retardant additive of the electrolyte as described herein can selected from the group consisting of triphenyl phosphate (TPhPh/TPP/TPPa), tributyl phosphate (TBP/TBuPh), triethyl phosphate (TEP/TEtPh), bis(2,2,2-trifluoroethyl)methyl phosphonate (B TFEMP/TFMPo), tris(2,2,2-trifluoroethyl) phosphate, diethyl ethylphosphonate, diethyl phenylphosphonate, and mixtures thereof.

In some embodiments of an electrochemical cell of the disclosure, redox active monomeric moiety contains thiophene or anthraquinone and the electrolyte was 1.0 M LiPF₆ in EC:DEC (50:50 v/v). EC and DEC refer to ethylene carbonate and diethyl carbonate respectively.

In an alternative embodiment, these electrochemical cells can feature non-aqueous electrolytes including organic solvents such as propylene carbonate, ethylene carbonate, dialkyl carbonate, DME, Dioxolanes, ethers, fluorinated ethers, glymes, acetonitrile, alongside one or more salts of lithium, sodium and/or potassium such as lithium hexafluorophosphate (LiPF₆), lithium hexafluoroarsenate (LiAsF₆), lithium perchlorate (LiClO₄), lithium tetrafluoroborate (LiBF₄), lithium trifluoromethanesulfonate (LiCF₃SO₃), lithium trifluoroacetate (LiCF₃CO₂), lithium tetrachloroaluminate (LiAlCl₄), lithium bis(trifluoromethanesulfonyl)imide (Li[CF₃SO₂]₂N, LiTFSI), lithium bis(fluorosulfonyl)imide (Li[FSO₂]₂N, LiFSI), lithium bis(oxalato)borate (Li[C₂O₄]₂B, LiBOB), lithium iodide (LiI), lithium bromide (LiBr), lithium chloride (LiCI) and lithium fluoride (LiF) at concentrations from 0.01-1 M, for example. In particular, the electrodes as described in this disclosure may function as the cathode in such non-aqueous cells, and low-potential metallic or alloy species such as, but not limited to, lithium metal, lithiated graphite, lithium-silicon alloy, magnesium or sodium or potassium as the anode.

In such non-aqueous cell embodiments as described above where Li metal features as the anode, the open circuit voltage of the cell (and, hence, the relative potential of the cathode vs. Li⁺/Li) can be 2.0-3.5 V.

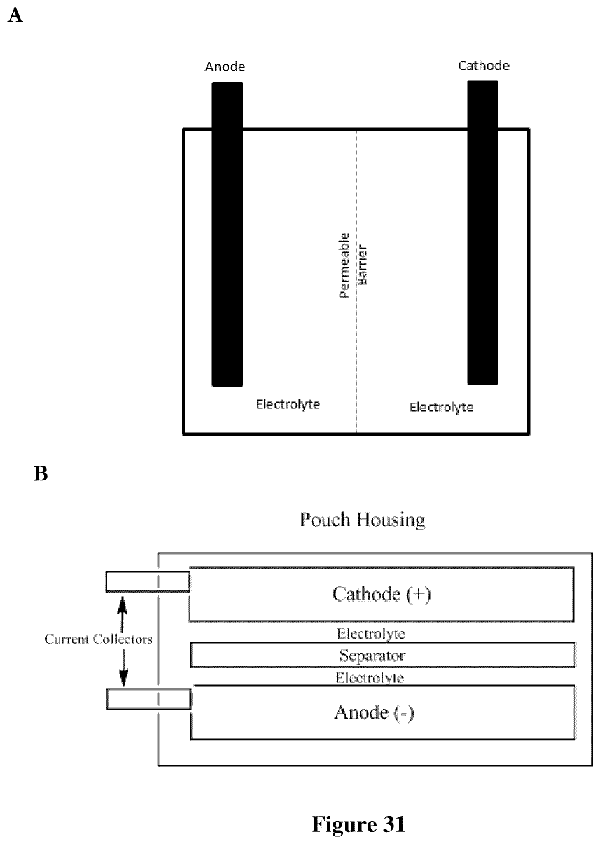

Schematic illustration of possible configuration of electrochemical cells are illustrated in FIG. 31.

In particular FIG. 31 top panel shows an exemplary electrochemical cell including an anode, a cathode and an electrolyte disposed between the anode and cathode with an optional permeable barrier dividing the electrolyte into two ionically communicative portions. FIG. 31 bottom panel shows an exemplary electrochemical cell in a pouch housing including an anode, a cathode and their respective current collectors and an electrolyte disposed between the anode and cathode with an optional separator dividing the electrolyte into two ionically communicative portions. In some embodiments, of the present disclosure one or more electrochemical cells can be comprised within a battery.

As used herein, a “battery” is a device consisting of one or more electrical energy generating electrochemical cells arranged in parallel (for increased capacity) or serial (for increased voltage). Battery types include redox active polymer-metal, zinc-carbon, alkaline, nickel-oxyhydroxide, lithium, mercury oxide, zinc-air, Zamboni pile, silver-oxide, magnesium, nickel-cadmium, lead-acid, nickel-metal hydride, nickel-zinc, silver-zinc, lithium-iron-phosphate, lithium ion, and others as could be understood by a skilled person.

In particular, a battery according to this disclosure can include one or more electrochemical cells as described herein and may additionally include a first electrode coupled to an anode of the one or more electrochemical cells, a second electrode coupled to a cathode of the one or more electrochemical cells, and a casing or housing encasing the one or more electrochemical cells.

In some embodiments a battery in the sense of disclosure consists of one or more electrochemical cells, connected either in parallel, series or series-and-parallel pattern. In some embodiments, the battery can include a plurality of electrochemical cells can be linked in series or parallel based on performance demands including voltage requirement, capacity requirement.

In some embodiments, electrochemical cell as described can be electrically connected in series to increase voltage of the battery thereof.

In some embodiments, electrochemical cell as described can be electrically connected in parallel to increase charge capacity of the battery thereof.

In some embodiments, the battery as described herein can take a shape of a pouch, prismatic, cylindrical, coin.

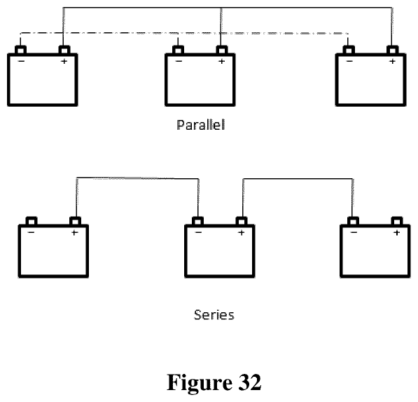

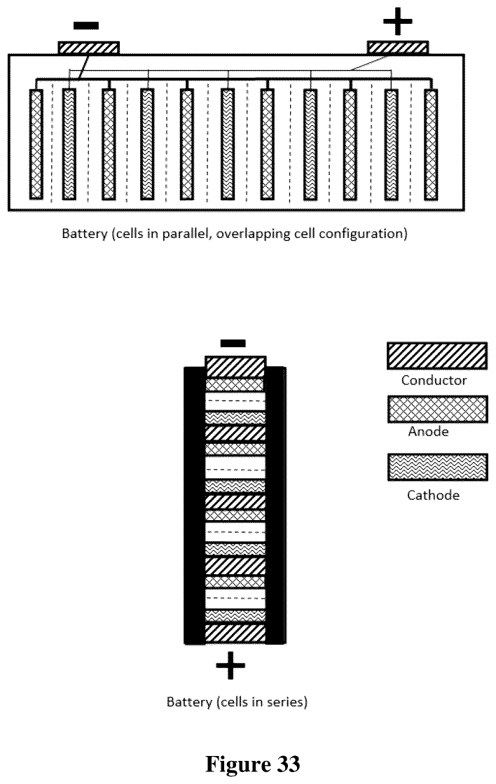

A schematic illustration of the arrangement of the electrochemical cells in a batter of the disclosure is illustrated in FIGS. 32 and 33.

FIG. 32 shows exemplary arrangement of a plurality of electrochemical cells in a battery. The top panel of FIG. 32 shows a plurality of electrically connected electrochemical cells that electrically connected in parallel, whereas the bottom panel of FIG. 32 shows a plurality of electrically connected electrochemical cells that electrically connected in series. A battery of three cells connected in parallel has a capacity of three times that of the individual cell. A battery of three cells connected in series has a voltage of three times that of the individual cell.

The top panel of FIG. 33 shows a plurality of electrically connected electrochemical cells that electrically connected in parallel in an overlapping configuration, whereas the bottom panel of FIG. 33 shows a plurality of electrically connected electrochemical cells that electrically connected in series.

The battery can be configured as a primary battery, wherein the electrochemical reaction between the anode and cathode is substantially irreversible or as a secondary battery, wherein the electrochemical reactions between the anode and cathode are substantially reversible.

Battery comprising S-linked quinone polymers, electrode materials, electrode and electrochemical cells of the disclosure are long life battery. A used herein, a long life for a battery indicates a battery that can charge/discharge for over 1,000 cycles, while retaining 70% of charge capacity. In some embodiments, a battery as described herein can have a lifetime of at least four years. In some embodiments, a battery as described herein can have charge/discharge for over 1,200 cycles, while retaining 70% of charge capacity.

S-linked polymers herein described sulfurized matrices herein described and related composites electrode materials and/or electrodes to be included in electrochemical cells and batteries in accordance with the present disclosure can be provided according to methods identifiable by a skilled person upon reading of the present disclosure.

S-linked polymers herein described to be included in electrochemical cells and batteries in accordance with the present disclosure can be provided according to methods identifiable by a skilled person upon reading of the present disclosure

In some embodiments, a method for making a S-linked quinone polymer is described. The method comprising
providing a redox active monomeric quinone monomer X₁-M-X₂, wherein X₁ and X₂ presents a leaving group,
providing a source of sulfide Sp,
contacting the redox active monomeric quinone monomer X₁-M-X₂ with the source of sulfide Sp under suitable conditions and for sufficient period of time to provide the S-linked quinone polymer represented by Formula (I)

-[M-Sₚ]-ₘ (I)

in which
M is a redox active monomeric quinone moiety having a redox potential of 0.5 V to 3.5 V with reference to Li/Li+ electrode potential under standard conditions,
p refers to the number of sulfur atom linking the redox active a monomeric quinone moiety M, p ranges from 1 to 5,
Sₚ is a sulfide when p is 1 or polysulfide when p is from 2 to 5,
m ranges from 5 to 10,000,
wherein the S-linked quinone polymer has a weight average molecular weight of at least 1500 Dalton or a weight averaged MW ranging from 2000 to 2,000,000 Daltons, from 10,000 to 1,500,000 Daltons, from 100,000 to 1,000,000 Daltons, and a solubility in tetrahydrofuran (THF) of equal or less than 1.0 microgram per mL at 21° C. at 1 atm.

In some embodiments, the leaving group X1 and X2 can be independently selected from Cl⁻, Br⁻, I⁻, ⁻OTs, ⁻OMs, ⁻OTf or any other leaving groups known to a skilled person.

In some embodiments, the source of sulfide Sp includes but is not limited to elemental sulfur S8, Na₂S, K₂S, Li₂S any other sulfur containing compound known to a skilled person.

In some embodiments, a method for making a S-linked quinone copolymer is described. The method comprising
providing a redox active monomeric quinone monomer X₁-M1-X₂, and a redox active monomeric quinone monomer X₁-M2-X₂ wherein X₁ and X₂ presents a leaving group,
providing a source of sulfide Sₚ₁ and Sₚ₂,
contacting the redox active monomeric quinone monomer X₁-M1-X₂ and redox active monomeric quinone monomer X₁-M2-X₂ with the source of sulfide Sₚ₁ and Sₚ₂ under suitable conditions and for sufficient period of time to provide the S-linked quinone copolymer represented by Formula (II)

-[M1-Sₚ₁]ₘ₁-co-[M2-Sₚ₂]-ₘ₂ (II)

in which
M1 and M2 are each a redox active monomeric quinone moiety comprising a redox potential of 0.5 V to 3.5 V with reference to Li/Li+ electrode potential under standard conditions,
p1 and p2 each independently refer to a number of sulfur atom linking the redox active monomeric quinone moiety M1 and monomeric quinone moiety M2 respectively, p1 and p2 each independently range from 1 to 5,
Sₚ₁ is a sulfide when p1 is 1 or polysulfide when p1 is from 2 to 5,
Sₚ₂ is a sulfide when p2 is 1 or polysulfide when p2 is from 2 to 5,
m1 and m2 each independently range from 5 to 5,000, optionally a ratio of m1 to m2 ranges from 1:50 to 1:1, 1:20 to 1:2, 1:6 to 1:3, or 1:5 to 1:4,
wherein the S-linked quinone copolymer of Formula (II) has a weight average molecular weight ranging from 1,000 Dalton to 2,000,000 Dalton, or a weight averaged MW ranging from 2000 to 2,000,000 Daltons, from 10,000 to 1,500,000 Daltons, from 100,000 to 1,000,000 Daltons, and a solubility in tetrahydrofuran (THF) of equal or less than 1.0 microgram per mL at 21° C. at 1 atm.

In some embodiments, the leaving group X1 and X 2 can be independently selected from Cl⁻, Br⁻, I⁻, ⁻OTs, ⁻OMs, ⁻OTf or any other leaving groups known to a skilled person.

In some embodiments, the source of sulfide Sₚ₁ and Sₚ₂ includes but is not limited to elemental sulfur S8, Na₂S, Li₂S, K₂S any other sulfur containing compound known to a skilled person.

The specific chemical moiety, groups and substituents can be selected to provide the desired redox activity as will be understood by a skilled person.

The term “chemical moiety” as used herein indicates an atom or group of atoms that when included in a molecule is responsible for a characteristic chemical reaction of that molecule or an atom or group of atoms that that is retained to become part of the reaction product after the reaction. A chemical moiety comprising at least one carbon atom is also indicated as organic moiety as will be understood by a skilled person.

In particular, as used here, the wording “organic moiety” refers to a carbon containing portion of an organic molecule. For example, within an organic polymer organic moieties can be formed by a distinct portion of the polymer, such as a distinct portions of a monomer that is retained in the polymer following polymerization as part of the monomeric unit of the polymer. An exemplary organic moiety is provided by a 1,5-dichloroanthraquinone or by an anthraquinone moiety retained in a S-linked polymer as disclosed herein.

Exemplary chemical moieties in the sense of the disclosure are provided by functional groups such as hydrocarbon groups containing double or triple bonds, groups containing halogen, groups containing oxygen, groups containing nitrogen and groups containing phosphorus and sulfur all identifiable by a skilled person.

A skilled person will be able to identify the moiety that can be used in methods of the disclosure to provide the redox active polycyclic compound of the disclosure.

The S-linked polymers, sulfurized carbon matrices, redox compositions, redox composites, and related electrode material, electrodes and electrochemical cells can be comprised in systems in which the polymers, matrices compositions composites electrode material, electrodes and/or electrochemical cells are comprised in various combinations wherein they are interconnected in configurations in which they work together as parts of mechanism and/or interconnecting network according to methods herein described.

In summary, electrode materials including S-linked polymer and sulfurized caron matrices, are described here, alongside functional electrodes incorporating such species and electrochemical cells and batteries including such electrodes. In certain embodiments, the electrode material described herein exhibits high mechanical strength and excellent processability into a functional electrode due to its unique composition. Advantageously, in certain embodiments the electrode supports battery charging and recharging for hundreds of cycles without material loss, due to the insoluble nature and, stability of these organosulfur polymer in the non-aqueous electrolytes used.

In particular, S-linked quinone polymers, sulfurized carbon matrices, and related compositions, composites, electrode materials, electrodes, electrochemical cells as well as related methods and systems can be used in connection with applications wherein the demand for high energy, high performance, safe and long-lasting batteries is growing rapidly due for example to environmental concerns among other things.

S-linked quinone polymers, sulfurized carbon matrices, and related compositions, composites, electrode materials, electrodes, electrochemical cells as well as related methods and systems can be used in connection with lithium-ion battery technology with various cathodes such as NMC, LFP, LMO, NCA which are currently widely applied in the electric vehicular applications.

In this connection in some embodiments sulfurized carbon matrices, and related compositions, composites, electrode materials, electrodes, electrochemical cells as well as related methods and systems can be used in connection with Li anode in place of inorganic cathodes which can be preferred for example in view of the price of Li-ion battery technologies which has dropped consistently over the past 30 years due to the adoption of improved processing and manufacturing practices, In particular, in those embodiments S-linked quinone polymers herein described such as PAQT and 36PPAQS, 27PPAQS are expected improve the overall capacity and performance of the battery, and composite cathodes of hybrid mixtures of various proportions of PAQS, PAQT, 36PPAQS, 27PPAQS, PBQS and various sulfurized carbon matrix polymers including but not limited to SPAN

Further details concerning the organosulfur polymer, and related composition electrochemical cells, batteries methods and systems including generally manufacturing and packaging of the organosulfur polymer compositions, electrochemical cells and/or the battery, can be identified by the person skilled in the art upon reading of the present disclosure.

### EXAMPLES

The S-linked polymer, sulfurized carbon matrices, and related composition, composites, electrode materials, electrodes, electrochemical cells, batteries, as well as related methods and systems herein described are further illustrated in the following examples, which are provided by way of illustration and are not intended to be limiting.

A skilled person will be able to identify additional S-linked polymer, sulfurized carbon matrices, and related composition, compositions, electrode materials, electrodes, electrochemical cells, batteries methods and systems in view of the content of the present disclosure. The following specific examples are given to illustrate the practice of the invention, but are not to be considered as limiting the invention in any way.

In particular, exemplary redox active S-linked polymers, sulfurized carbon matrices, composites, metals and related electrode material, electrodes, devices, compositions, methods and systems, are described in connection with specificc experimental tests and procedures. A skilled person will be able to understand and identify the modifications required to adapt the results illustrated in the exemplary embodiments of this sections to additional embodiments of organosulfur polymer, and related electrodes, devices, compositions, methods and systems in accordance with the present disclosure.

As will be appreciated from the Examples herein described, the features and performance of these organosulfur polymer, herein described support their use as organic electrode materials suitable for a wide range of primary or rechargeable applications, such as batteries for electric vehicles, stationary batteries for emergency power, local energy storage, starter or ignition, remote relay stations, communication base stations, uninterruptible power supplies (UPS), spinning reserve, peak shaving, or load leveling, or other electric grid electric storage or optimization applications. Small format or miniature battery applications including watch batteries, implanted medical device batteries, or sensing and monitoring system batteries (including gas or electric metering) are contemplated, as are other portable applications such as flashlights, toys, power tools, portable radio and television, mobile phones, camcorders, lap-top, tablet or hand-held computers, portable instruments, cordless devices, wireless peripherals, or emergency beacons. Military or extreme environment applications, including use in satellites, munitions, robots, unmanned aerial vehicles, or for military emergency power or communications are also possible.

### Materials and Methods

The following materials and methods can be used for all compounds and their precursors exemplified herein.

All S-linked polymers, sulfurized carbon matrices and lithium system electrochemical measurements were taken using a Biologic SP-150 Potentiostat, a Neware tester or an Arbin Tester.

A beaker-type cell (or beaker cell as used herein interchangeably) was used here for measurement of all cyclic voltammetry of the organosulfur polymer. The beaker cell includes glass container holding an electrolyte, a cathode organosulfur polymer material mixing with conductive carbon and additive is used as the working electrode (WE), a Li/Li⁺ is used as reference electrode, and Pt wire is used as counter electrode (CE).

All polymers of the present disclosure were filtered and washed with deionized water and acetone until solvents passing through the filter were clear.

To help with cell formation as well as electrode conductivity, different additives are also used, including, but not limited to, bismuth oxide, carbon black powders, graphite, carbon fibers, graphene, carbon nanofibers, and carbon fibers.

To enhance adhesion, cohesion, and structural features of the cathode or anode, carbon fiber, zirconium fiber, alumina fiber or silicon fiber have all been incorporated into the anode formulation.

To hold the cathode or anode to the substrate a form of binder is used. Preferred binder can be PTFE, SBR, PVDF, HEC, CMC, Arabic Gum, xanthan gum, HPMC, and chitosan.

The cathode or anode can be applied using wet process by mixing all the active materials and additives and binders with water then coat or used as a dry powder and pressed onto aforementioned substrates.

### Example 1: PAQS- SPAN Composite Material Representative Sulfurized Carbon Matrix Polymer

Sulfur-linked quinone polymers such as PAQS (poly[anthraquinonyl-sulfide]) has a theoretical capacity of 225 mAh/g but only delivers ˜160 mAh/g in usable practical cell with lithium anode at material loadings>60% active cathode (necessary for a cell with an energy density for significant commercial application), although with good cycling stability (>1000 cycles possible). Discharge potentials are typically ˜2.5-2.0V vs. Li⁺/Li.

In sulfurized carbon matrices such as SPAN (sulfurized poly[acrylonitrile] exhibit high capacity (>200 mAh/g from 3.0 to 0.50 V) with better cycling stability compared to standard sulfur cathodes in electrochemical cells with a lithium anode; however, the majority of the capacity is accessed at lower potentials than conventional Li/S cells so is less preferred in comparison to Li/S compositions. The overall S content in SPAN is ˜25 to 50% and its capacity can vary from 400-800 mAh/g of total mass of SPAN. Sulfurized carbon matrix polymer typically have same features with an S content of ˜25 to 50 w/w % with respect to total weight of sulfurized carbon matrix polymer and its capacity can vary from 400-800 mAh/g of total mass of polymer as will be understood by a skilled person.

The combination of organosulfur polymer and sulfurized polymeric materials such as PAQS and SPAN in a hybrid cathode material combination in accordance with the feature of the present disclosure is expected to afford an active material that exhibits both the good cycling stability of constituent PAQS and SPAN and the combined discharge capacity of both materials. In particular mixture can offer a capacity of >250 mAh/g from 3.2-1.0V vs Li⁺/Li with cycling stability>100 cycles, for example.

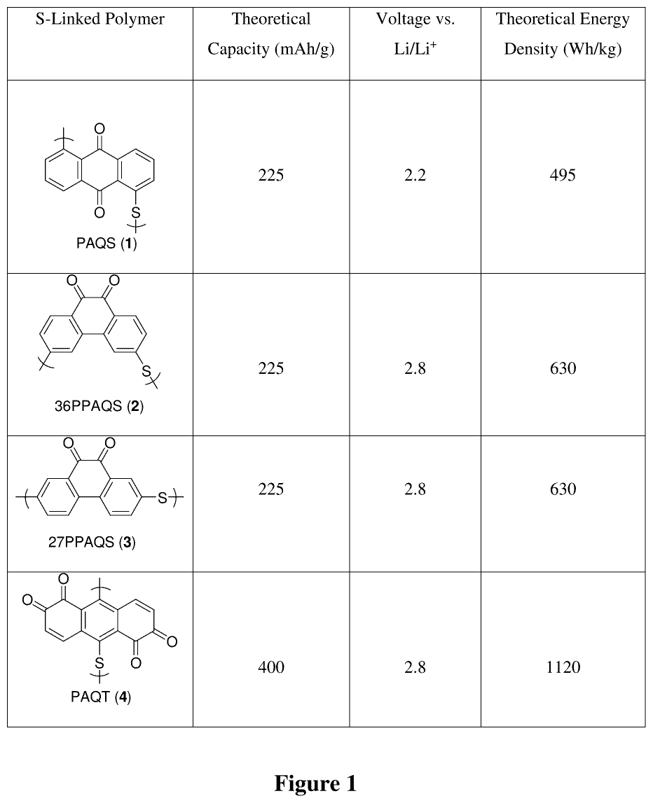

In particular, exemplary organosulfur polymers known or expected to be included in the composite of the disclosure comprise are redox active polymers capable of undergoing reversible redox processes at high potential vs Li⁺/Li, increasing the overall energy density of the battery. Exemplary polymers having the above referenced properties comprise S-linked quinone polymers including 36PPAQS, 27PPAQS and PAQT. Both 36PPAQS and 27PPAQS have the capacities of 225 mAh/g, respectively, however they give a 2.8V battery when coupled with metallic lithium as anode in nonaqueous electrolytes, compared to PAQS at 2.2.V. PAQT is a new polymer with theoretical capacity of 400 mAh/g, and redox potential of 2.8V vs. Li/Li⁺. Overall, the energy density of these new polymers is higher than PAQS alone, as shown in the Table of FIG. 1.

Additional exemplary organosulfur polymers usable in the composite of the disclosure comprise S-linked copolymers of two quinone moieties as cathode active materials for the use in nonaqueous rechargeable batteries. PAQS is chosen as the major component, and poly-1,4-benzoquinone sulfide (PBQS) is chosen as the minor component of the copolymers. Further exemplary organosulfur polymers comprise -S-linked copolymers such as PAQS_{0.8}BQ_{0.2} configured to increases the capacity of PAQS by 20%.

Further encompassed in the present disclosure are hybrid mixtures of S-linked quinone polymers, comprising PAQS, and sulfurized carbon matrices, such as, but not limited to, sulfurized polyacrylonitrile (SPAN). Even though nonaqueous batteries with PAQS as cathode active material show excellent cyclability, the energy density is limited due to two carbonyl redox active centers which yield only 225 mAh/g of theoretical capacity. In this disclosure, we envisaged to add high-capacity sulfur containing polymers into PAQS to make a hybrid mixture of cathode materials which provide higher overall capacity, and thus higher energy density batteries. In some embodiments, the energy density can be increased from 20-60% by combining 10-60 wt % sulfurized carbon matrices such as SPAN polymers with organosulfur polymer such as PAQS material. In some embodiments the energy density can be increased from 20-250% by combining 10-90 wt % of SPAN or other sulfurized carbon matrix polymers with organosulfur —S— polymer such as PAQS material.

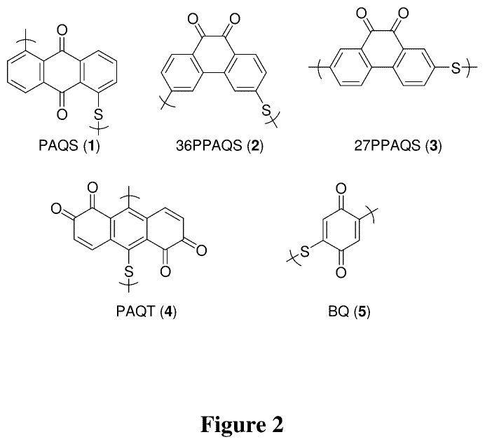

In particular, S-linked quinone polymers described in this disclosure comprise S-linked condensation polymers based on anthraquinone (AQ), phenanthrenequinone (PAQ), anthracenetetraone (AQT) and 1,4-benzoquinone (BQ), and possess a redox potential range from 1.0 V to 3.5 V with reference to Li/Li⁺ electrode potential under standard conditions. FIG. 2 shows exemplary structures of S-linked quinone polymers.

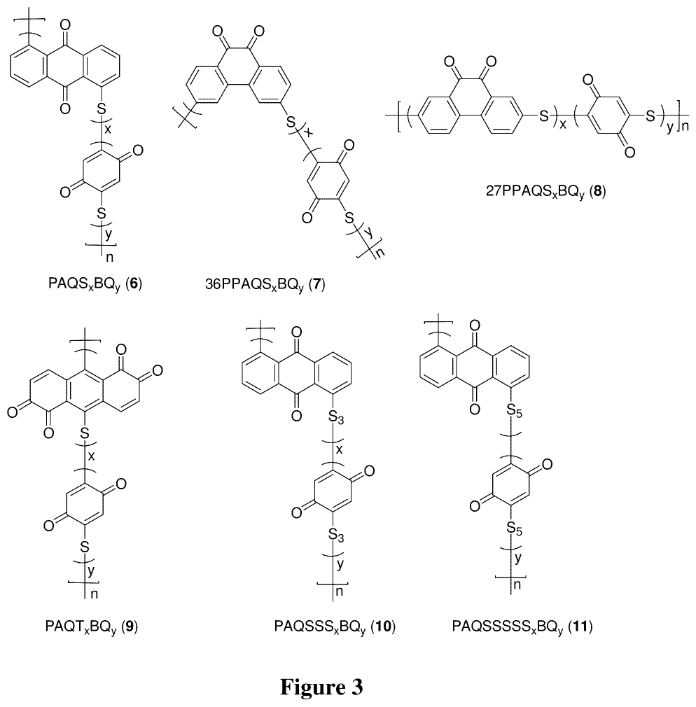

Furthermore, copolymers of sulfur-linked quinone polymers are useful and can be formed by condensation of suitable monomers with sulfur materials under typical conditions described below. For example, co-polymers of PAQS or PAQT and PBQS can be formed. PAQS is a robust polymer, which offers 1000 cycles with >80% active material but delivers only 160 mAh/g capacity at low rates. This can be improved in a series of PAQS-PBQS or copolymers (e.g. random co-polymers) by varying the ratio of monomers. We have achieved 20% improvement of capacity from PAQS by incorporating up to 20 mol % PBQS into the co-polymers (FIG. 3). Similar results can be achieved using PAQT monomer with PBQS.

FIG. 3 shows structures of the copolymers of PAQS or PAQT and PBQS covered in this disclosure.

In particular, embodiments of the disclosure typically use either high sulfur content polymer or sulfurized carbon matrices (as shown in FIG. 4) as one of the components to S-linked quinone polymer. The redox potential properties of these sulfurized carbon matrices are slightly below but are in close proximity to the quinone based sulfide (—S—) polymers. The high sulfur content of the sulfurized carbon matrices described in this disclosure are n-type and possessed the redox potential range from 1.0 V to 2.5V or 1 1.0 V to 3.5 V with reference to Li/Li⁺ electrode potential under standard conditions.

FIG. 4 shows structures of sulfurized carbon matrices used as one of the components in —S-linked organic quinone polymers. The following description of the properties of the sulfurized carbon matrices of the instant disclosure will be made with reference to the representative Sulfurized polyacrylonitrile (SPAN). The related features apply to other sulfurized carbon matrices as will be understood by a skilled person upon reading of the present disclosure.

Sulfurized polyacrylonitrile (SPAN) is one such material first reported by Wang et. al. in 2002. [6] [7] [8] [9] [10] SPAN is chemically and electrochemically different than elemental sulfur and any elemental sulfur based composite cathodes. Elemental sulfur is an insulating material with an eight membered cyclic structure, whereas SPAN is a conductive material in which active sulfur is chemically embedded into the conductive matrix of the carbonized PAN polymer, as shown in FIG. 30.

FIG. 30 shows a comparison of the structures of elemental S and sulfurized polyacrylonitrile (SPAN).

During discharge elemental sulfur or sulfur composite with elemental sulfur form long-chain linear lithium polysulfides via ring opening the cyclic S₈ which are soluble in the electrolyte, whereas the SPAN, in which active sulfur moieties are covalently attached to the carbon framework, therefore no such long-chain linear lithium polysulfides are formed. Since there is no long-chain linear polysulfides formation with SPAN, therefore, there is no lithium polysulfides dissolution, and therefore no shuttle mechanism.

Additionally, sulfur content in elemental sulfur is 100%, whereas sulfur content in SPAN varies from 30-60% depending on the synthesis. Higher the temperature for synthesis, lower the sulfur content in the polymer matrix. The synthetic procedure for the SPAN used in this disclosure is described in Example 37. The sulfur content is found to be 40% based on TGA and elemental analysis.

Many examples of modified SPAN and SPAN-like material are known in the literature, summarized in FIG. 4.

Both S and S-C cathodes form soluble long-chain polysulfides during discharge. These lithium salt of polysulfides are nucleophilic in nature and capable of reacting with any electron deficient species. In presence of quinone polymer as a co-active material in the hybrid cathode, the soluble polysulfides can react with carbonyl groups of the polymer and destroy their ability to intercalate and de-intercalate Li⁺ during cycling. However, with SPAN, As used herein, S—C means Carbon and S can be written as S-C. C—S refers to a pre mix of conducting carbon and Sulfur optionally comprising additives since there is no soluble polysulfide formation, therefore there is no such detrimental reaction occurring during cycling.

Elemental sulfur is an insulating material. Conductive carbon and additives can be added to the elemental sulfur for electron conduction during battery cycling. Moreover, elemental sulfur forms polysulfides during discharge which are soluble in organic electrolytes. The solubility of polysulfide discharge products in electrolyte cause shuttling effect, which is detrimental to the battery performance. To address both issues, Sulfurized Polyacrylonitrile (SPAN) was synthesized via thermal treatment of elemental sulfur (S₈) and polyacrylonitrile (PAN) at various temperature. [6] Elemental sulfur is embedded in the framework of pyrolytic PAN polymer as C-S bonds in SPAN confirmed by FTIR, Raman spectra, and XPS. [11] The conjugated nature of SPAN improves the conductivity of the material, and C—S bonds throughout the structure prevents the formation of soluble polysulfides. The amount of sulfur in the SPAN is about 25-60 wt %.

Exemplary polymers including PAQT, 36PPAQS, and random copolymer of PAQS-PBQS are described. PAQT has higher the voltage and capacity than PAQS. PAQT has a redox voltage and a capacity of 2.80V and 400 mAh/g, respectively compared to 2.20V and 225 mAh/g in PAQS. Similarly, 36PPAQS has an improved redox voltage of 2.70V and capacity 225 mAh/g, respectively.

In the experimental data presented here, we found that SPAN works as co-active material with PAQS. Both SPAN and PAQS have their signature voltage profiles in the discharge-charge curves. Whereas S or S-C doesn't work as co-active material in the same electrolyte, and the signature voltage profile of PAQS is no evident during the discharge-charge profile when the battery was assembled and cycled under same conditions.

### Example 2: Anode

Anode active materials of the present of disclosure include, but are not limited to, metallic lithium in the form of lithium foil, powdered lithium, lithium deposited onto a conducting or non-conducting substrate, such copper foil, lithium alloys such as, lithium-aluminum alloys, lithium-tin alloys. In some embodiments, anode active materials can be metallic sodium, metallic potassium, graphite, hard carbon, silicon-based materials. In some embodiments, anodes can be coated with carbon, graphite, non-redox active polymers to prevent dendrite formation during cycling.

### Example 3: Cathode

A cathode electrode composition comprises of PAQS:SPAN active material, one or more conductive carbons and one of more binder materials. The PAQS and SPAN or other sulfurized polymers composition can be varied from 90 wt % PAQS to 20 wt % or lower to 5 wt % PAQS, the remaining amount of the respective cathode can be the SPAN materials or any other sulfurized polymeric materials from 5 wt % to 10 wt % to 80 wt %. In some embodiments, 36PPAQS, PAQT, modified PAQS can be used as cathode active material, respectively or their combinations of various ratios from 20 mol % to 80 mol %. In some embodiments, 36PPAQS:SPAN, PAQT:SPAN, BQ:SPAN, PAQS_{0.8}-BQ_{0.2}:SPAN hybrid mixture of various combinations from 90 wt % to 20 wt % or down to 5 wt % can be used a cathode active materials. In some embodiments of an electrode composition comprising a n-type redox polymer, sulfurized carbon matrix polymer, a binder, and a conductive additive can be used.

### Example 4: Binder

The binder can be 0.5-15% by weight of one or more selected from the group of polytetrafluoroethylene (PTFE), styrene-butadiene or styrenebutadiene rubber (SBR), poly(vinylidene-fluoride) (PVDF), poly(tetrafluoroethylene), sodium or lithium carboxymethylcellulose (CMC), styrene-butadiene rubber, polyacrylic acid (PAA), polyvinyl alcohol (PVA), polyethylene glycol or oxide (PEG or PEO), polyamide imide (PAI), Polyacrylonitrile (PAN) Xanthan Gum, Gum Arabic, and Agar any combination thereof. In some embodiments of an electrode composition comprising a redox polymer and a sulfurized carbon matrix polymer can be present in 20 to 80% or 20 to 95% percent by weight of the total electrode composition. With increased conductivity of the active material or network polymer, the amount of conductive additives in the electrode can be reduced appropriate while maintaining the same degree of the conductivity for the electrode composition. With increased stability of active material or network polymer, the amount of binders in the electrode can be reduced accordingly physical stability of the electrode composition. In some embodiments of an electrode composition comprising a n-type redox polymer, sulfurized carbon matrix polymer, a binder can be used.

### Example 5: Conductive Additive

the conductive additive can be 5-25% by weight of one selected from the group of Carbon Black (Acetylene Black, Super P Li, C-energy, Ketjen Black-300, Ketjen Black-600), Imerys (Super P, Super P C65, C-Nergy), carbon nanotubes (Cnano, Tuball), graphene (xGnP Grade R, xGnP Grade H, xGnP Grade C, xGnP Grade M) and Graphite (KS-4, KS-8, KC-4, KC-8), and nickel powder or any combination thereof. As used herein, a binder as used herein refers to a polymeric material which is non redox active under the battery working condition but enhance the adhesion of the electrode.

### Example 6: Mixing Process

In embodiments herein described, the n-type polymers and sulfurized carbon matrix polymers of the present disclosure can be incorporated into functional electrodes by mixing with suitable binder and conductive additive. Mixing methods include planetary mixing and high shear mixing. Electrode coating methods include drop casting, doctor blade casting, spin coating, comma-roll coating and extrusion. In some embodiments, the composition of electrodes may vary from 30-100 wt % active materials, 5-70 wt % conductive additive and 1-20 wt % binder with the total wt % of all species summing to 100%. After mixing and coating and drying of such electrodes, the electrodes are subjected to pressure through calendaring, followed by heating at temperatures above 50° C. Calendaring may be achieved using a heated or unheated roller.

### Example 7: Separators

The electrochemical cells described in the present invention comprise of an anode, a cathode, an electrolyte, and a separator. A separator is placed in between cathode and anode and can be any porous non-conductive polymeric material which is non-reactive, capable of insulting anode active materials and cathode active materials, but capable of conducting the ions between them. Typical examples of separators include, but are not limited to, polyolefins such as polyethylenes and polypropylenes, glass fiber papers, and ceramic materials. In some embodiments, Celgard 2400 is used as separator. In some embodiments the Celgard 3501 is used as separator. In some embodiments the Celgard 2325 is used as separator. In other embodiments, Polypropylene SH2214 is used as separator. Separators of different thickness ranging from 5 micron to 50 micron are used in the invention.

### Example 8: Electrolytes

Nonaqueous electrolytes used in this invention include, but are not limited to, acyclic ethers, cyclic ethers, glymes, polyethers, sulfolane, sulfones, acetals, ketals, carbonates, dioxolanes and their mixtures thereof. Examples of acyclic ethers include, but are not limited to, 1,2-dimethoxyethane (DME), trimethoxyethane (TME), diethyl ether (DEE), partially fluorinated ethers such as bis(trifluoroethyl) ether (BTFE), perfluorinated ethers, dimethoxypropane, diethoxyethane. Examples of cyclic ethers include, but are not limited to, 1,4-dioxane, 1,3-dioxolane, tetrahydrofuran, 2-methyltetrahydrofuran. Examples of polyethers include, but are not limited to, diethylene glycol dimethyl ether (diglyme), triethylene glycol dimethyl ether (triglyme), tetraethylene glycol dimethyl ether (tetraglyme), higher molecular weight glymes, diethylene glycol divinylether, ethylene glycol divinylether, triethylene glycol divinylether, tetraethylene glycol divinylether. Examples of sulfones and sulfolane include, but are not limited to, 3-methyl sulfolane, 3-sulfolene, dimethyl sulfone, diethyl sulfone, sulfolane, 3-flurosulfolane. Examples of carbonate solvents include, but are not limited to, dimethyl carbonate (DMC), diethyl carbonate (DEC), propylene carbonate (PC), ethylene carbonate (EC), vinylene carbonate (VC).

Examples of lithium salts used in this disclosure include, but are not limited to, LiTFSI, LiOTf, LiClO₄, LiBF₄, LiPF₆, LiSCN, LiI, LiAsF₆, LiFSI, LiNO₃, LiF, LiOAc, lithium formate, LiSO₃CH₃. The range of concentrations of lithium salts used are from 0.5M to 6M.

### Example 9: S-Linked Polymer (PAQS) Cathode

A cathode consisted of various ratios of PAQS active material, conducting carbon, and PVDF binder. A typical cathode consisted of 70 wt % PAQS20 wt % SP carbon and 10 wt % PVDF. First, PAQS and SP powder was mixed in a coffee mixer. Then added calculated amount of 3 wt % PVDF solution in NMP into the PAQS: SP mix in a screw cap cup. The overall mix was then placed in a Thinky centrifuged mixer and mixed at 2000 rpm for 30 sec for 3 times. A honey like material was coated using an auto-coater on to carbon coated aluminum foil. The coated material was then dried at 100° C. for overnight under vacuum. The typical thickness of the electrode is about 40-100 micron, and typical loading of the active material ranging from 3-10 mg/cm².

### Example 10: 36PPAQS Cathode

A 36PPAQS cathode was prepared by mixing 36PPAQS, SP, KB (Ketjen black) in a mortar using pestle. The 3 wt % solution of PVDF in NMP was added into the mixed powder in a plastic cup which can be sealed using a screw cap. The overall mixture was then placed in a Thinky centrifuged mixer, and spined them at 2000 rpm for 30 sec for 3 times. The thick solution was coated using an auto-coater on to carbon coated aluminum foil. The coated foil was then dried at 120° C. for overnight under vacuum. The final composition of the electrode was 36PPAQS:SP:KB:PVDF (70:18:2:10).

### Example 11: 27PPAQS Cathode

A 27PPAQS cathode was prepared by mixing 27PPAQS, SP in a mortar using pestle. The 3 wt % solution of PVDF in NMP was added into the mixed powder in a plastic cup which can be sealed using a screw cap. The overall mixture was then placed in a Thinky centrifuged mixer, and spined them at 2000 rpm for 30 sec for 3 times. The thick solution was coated using an auto-coater on to carbon coated aluminum foil. The coated foil was then dried at 120° C. for overnight under vacuum. The final composition of the electrode was 27PPAQS:SP:PVDF (70:20:10).

### Example 12: PAQT Cathode

A typical PAQT cathode was prepared by mixing PAQT, SP, PTFE was mixed in H₂O:EtOH (50:50) first. The solvent was dried at 80° C. for overnight. The PAQT:SP:PTFE mixture was then densified and granulated. A 3 wt % solution of PVDF in NMP was added into the densified and granulated mixture in a plastic cup which can be sealed using a screw cap. The overall mixture was then placed in a Thinky centrifuged mixer, and spined them at 2000 rpm for 30 sec for 3 times. The thick solution was coated using an auto-coater on to carbon coated aluminum foil. The coated foil was then dried at 120° C. for overnight under vacuum. The final composition of the electrode was PAQT:SP:PTFE:PVDF (70:20:2:8).

### Example 13: PAQS:SPAN Cathode

A variety of S-linked quinone polymer and sulfurized carbon matrix polymer ratios of composite hybrid cathodes were prepared. The S-linked quinone polymer PAQS amount varies from 5 wt % to wt 80% or 60 wt % to 80 wt % with respect to the total weight of S-linked quinone polymer and sulfurized carbon matrix polymer and the rest of the active material is being the SPAN. A typical procedure for making a PAQS:SPAN hybrid cathode is as follows. First, a specific ratio of SPAN:SP mixture was ball-milled for 10 min. The SPAN: SP mixture was then added to PAQS and mixed them well using a coffee mixer. A calculated amount 3 wt % solution of PVDF in NMP was added to the powder mixture of PAQS:SPAN:SP in a cup which was sealed using a screw cap. The whole mixture was then placed into a Thinky centrifuged mixture and mixed then at 2000 rpm for 30 sec for at least 3 times. A thick honey like material was coated onto a carbon coated aluminum foil. The NMP was dried at 80° C.

The following PAQS:SPAN cathodes were prepared by following the above procedure:
(1) PAQS:SPAN:SP:PVDF (45:22:23:10 wt %)
(2) PAQS:SPAN:SP:PVDF (50:30:10:10 wt %)
(3) PAQS:SPAN:SP:PVDF (75:15:5:5 wt %)
(4) PAQS:SPAN:SP:PVDF (75:17:5:3 wt %)
(5) PAQS:SPAN:SP:PVDF (70:20:5:5 wt %)
(6) PAQS:SPAN:SP:PVDF (65:25:5:5 wt %)
(7) PAQS:SPAN:SP:PVDF (60:30:5:5 wt %).

### Example 14: PAQS_{0.8}BQ_{0.2} Electrode Preparation

PAQS_{0.8}BQ_{0.2} copolymer was mixed with Super P (SP) carbon using a mortar and pestle. A 3 wt % solution was added in the mixture. The 3 wt % solution of PVDF in NMP was added into the mixed powder in a plastic cup which can be sealed using a screw cap. The overall mixture was then placed in a Thinky centrifuged mixer, and spined them at 2000 rpm for 30 sec for 3 times. The thick solution was coated using an auto-coater on to carbon coated aluminum foil. The coated foil was then dried at 100° C. for overnight under vacuum. The final composition of the electrode was PAQS_{0.8}BQ_{0.2}:SP:PVDF (70:20:10 wt %).

### Example 15: Electrolyte Preparation

All electrolytes were prepared inside the glove box with the H₂O and O₂ levels<10 ppm by mixing appropriate lithium salt and solvent as described in the following Table. H₂O contents of the electrolytes were measured by a Karl Fisher Titrator. H₂O levels were found to be <25 ppm in all the electrolytes.

| Electrolyte Composition | Electrolyte ID |
|---|---|
| 1M LiTFSI in DME | ANA-1 |
| 1M LiTFSI in DME + 100 mM LiNO₃ | ANA-2 |
| 2M LiTFSI in DME | ANA-3 |
| 1M LiTFSI in DME: 13DOL (1:1 vol) | ANA-4 |
| 1M LiTFSI in DME: 13DOL (1:1 vol) + 100 mM | ANA-5 |
| LiNO₃ | |
| 2M LiTFSI in DME:13DOL (1:1 vol) | ANA-6 |
| 2M LiTFSI in DME:13DOL (1:1 vol) + 100 mM | ANA-7 |
| LiNO₃ | |
| 1M LiFSI in DME | ANA-8 |
| 1M LiFSI in DME:13DOL (1:1 vol) | ANA-9 |
| 2M LiFSI in DME:13DOL (1:1 vol) | ANA-10 |
| 1M LIFSI + 1M LiFSI in DME:13DOL (1:1 vol) | ANA-11 |
| 2M LiTFSI in DME:13DOL:DEE (0.4:0.4:0.2 vol) | ANA-12 |
| 1M LiTFSI in DME:13DOL:DEE (0.4:0.4:0.2 vol) | ANA-13 |
| 1M LiCLO₄ in DME: 13DOL (1:1 vol) | ANA-14 |
| 1M LiTFSI + 1M LiCLO₄ in DME:13DOL (1:1 vol) | ANA-15 |
| 3M LiTFSI in DME:13DOL (1:1 vol) | ANA-18 |
| 2M LiTFSI in Sulfolane | ANA-19 |
| 2M LiOTf in DME:13DOL (1:1 vol) | ANA-20 |
| ANA-18:BTFE (7:3 vol) | ANA-30 |
| ANA-18:PC (9:1 vol) | ANA-32 |
| ANA-18:EC (9:1 vol) | ANA-33 |
| ANA-18:DEC (9:1 vol) | ANA-34 |
| 4M LiTFSI in DME:13DOL (1:1 vol) | ANA-36 |
| 5M LiTFSI in DME: 13DOL (1:1 vol) | ANA-37 |
| ANA-37:BTFE (8:2 vol) | ANA-38 |
| 1M LiTFSI in MPPyTFSI | ANA-39 |
| 1M LiFSI in MPPyTFSI | ANA-41 |
| 1.2M LiFSI in BTFE:TEP (3:1 mol) | ANA-42 |
| ANA-42:ANA-39 (8:2 vol) | ANA-43 |
| ANA-42:ANA-41 (8:2 vol) | ANA-44 |
| ANA-37:TEP (8:2 vol) | ANA-45 |
| 2M LiTFSI in BTFE:TEP (1:1 vol) | ANA-47 |
| 1.2M LiFSI in TEP:TEETFE (1:3 mol) | ANA-48 |
| 1.2M LiFSI in TEP:DEE (1:3 mol) | ANA-56 |
| 1.2M LiFSI in TEP | ANA-57 |
| 1.2M LiFSI in DMMP | ANA-58 |
| 1.0M LiFSI in TEP:ENFB (3:3 mol) | ANA-59 |
| 1.0M LiFSI in TEP:MPFB (2:3 mol) | ANA-60 |
| 1.0M LiFSI in TEP:TFETFP-E (2:3 mol) | ANA-61 |

### Example 16: Coin Cell Preparation

All 2032 coin-type cells were assembled inside glove box with H₂O and O₂ levels<10 ppm. A lithium foil (0.02 mm thick, MTI corporation) was used as anode. A Celgard 2400 and 2325 polypropylene membranes were used as the separator. A typical thickness of the electrode ranges from 50-100 mm. Typical mass loadings ranges from 3-10 mg/cm². Typical loading of electrolytes ranges from 50-100 mL.

### Example 17: Li//36PPAQS Coin Cell

In this example, 36PPAQS polymer (herein also indicated as Gen 2) was used as cathode active material. The cathode was prepared by mixing 1.35 g 36PPAQS polymer:SP:KB (70:18:2 wt ratios) in a mortar using pestle. A 3 wt % solution of PVDF in NMP (5.0 g) was added into the mixed powder in a plastic cup. Additional 2.0 g of NMP was added to improve the texture and viscosity of the slurry. The overall mixture was then placed in a Thinky centrifugal mixer and centrifuged at 2000 rpm for 30 sec for 3 times. The homogenous viscous solution was coated using an auto-coater on to carbon coated aluminum foil. The coated foil was then dried at 120° C. for overnight under vacuum and stored in an argon glovebox. The final composition of the electrode came out as 36PPAQS:SP:KB:PVDF (70:18:2:10 wt ratios).

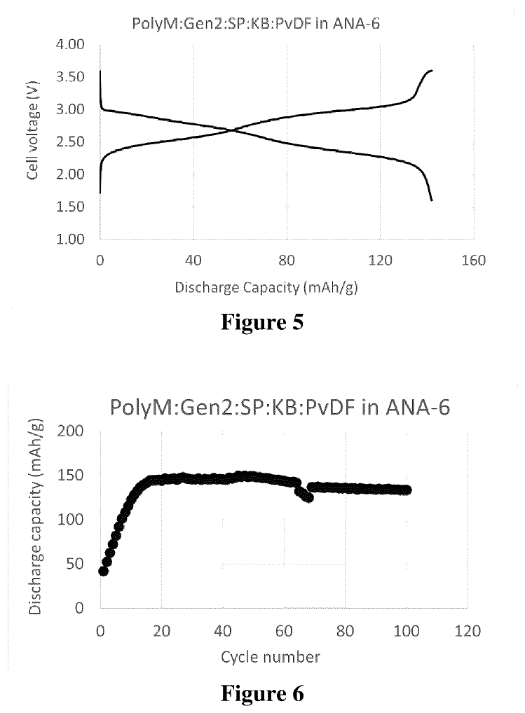

The electrochemical tests were performed using two-electrode CR2032 coin-type cells using lithium chip (0.02 mm, 1.54 cm²) as anode, and above described 36PPAQS:SP:SP:KB:PVDF (2.9 mg, 1.13 cm²) as cathode. An 18 mm diameter (2.54 cm²) Celgard 2400 was used as separator. Various electrolyte formulations were tested, but in this example 50 μL of 2M LiTFSI in DME:13DOL (1:1 vol) electrolyte formulation (ANA-6) was used. The cell was cycled at C/10 rate with voltage cutoffs of 1.6V to 3.6V. The charge and discharge characteristics at C/10 of the cell is presented in FIG. 5. This polymer gave a 2.70V battery when coupled with metallic lithium anode with a weight averaged MW ranging from 1,000 Da to 2,000,000 Da.

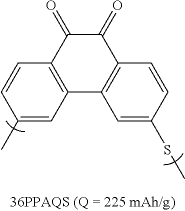

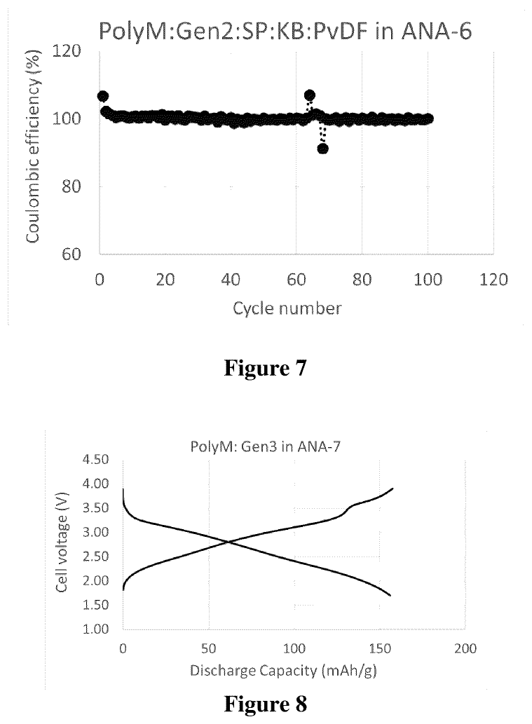

The cyclic performance of the cell assembled in ANA-6 is presented in FIG. 6. A low specific capacity of the (˜50 mAh/g) was obtained in initial cycles which improved with cycling, reaching a maximum capacity of 152 mAh/g, which about 68% of the theoretical capacity of the polymer. No appreciable capacity fading was observed up to 60 cycles, and then slight capacity fading was observed up to 100 cycles. The coulombic efficiency was found to be >99.5% for the cell up to 100 cycles (FIG. 7).

### Example 18: Li//PAQT Coin Cell

In this example, S-linked PAQT polymer termed as Gen3 was used as cathode active material having a weight average MW ranging from 1,000 Da to 2,000,000 Da. The synthesis of this S-linked quinone polymer is presented in Scheme 4. The cathode was prepared by mixing PAQT (0.52 g) polymer, SP carbon (0.15 g) and of 60% PTFE (0.015 g) aqueous suspension in 1.5 mL of EtOH:H₂O (1:1). The mixture was mixed by a Thinky centrifugal mixer at 2000 rpm for 30 sec. The EtOH:H₂O solvent mixture was dried at 80° C. for overnight, and the residual powder was then densified and granulated to fine powder. A 3 wt % solution of PVDF in NMP (2.0 g) was added into the granulated powder (0.72 g) in a plastic cup. The overall mixture was then placed in a Thinky centrifugal mixer and centrifuged at 2000 rpm for 30 sec for 3 times. To get appropriate slurry viscosity and texture, additional amount of pure NMP was added to the mixture, and then subsequently 36PPAQS (Q=225 mAh/g) centrifuged at 2000 rpm for 30 sec. A total of 3.0 g of NMP was added to the mixture. The homogenous viscous slurry was coated on to carbon coated aluminum foil using an auto-coater. The coated foil was then dried at 120° C. for overnight under vacuum and stored in an argon glovebox with H₂O and O₂ levels<10 ppm. The final composition of the electrode came out as PAQT:SP:PTFE:PVDF (70:20:2:8 wt ratios).

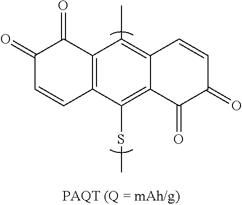

The electrochemical tests were performed using two-electrode CR2032 coin-type cells using lithium chip (thickness 0.02 mm, 1.54 cm²) as anode, and above described PAQT:SP:PTFE:PVDF (4.57 mg, 1.13 cm²) as cathode. An 18 mm diameter (2.54 cm²) Celgard 2400 was used as separator. Various electrolyte formulations were tested, but in this example, 60 μL of 2M LiTFSI in DME:13DOL (1:1 vol)+100 mM LiNO₃ electrolyte formulation (ANA-7) was found to be given the best cycling data. The charge and discharge characteristics at C/10 of the cell is presented in FIG. 8. This PAQT polymer gave a 2.80V battery when coupled with metallic lithium anode.

Voltage profile (charge and discharge characteristics) of Li//PAQT cell in ANA-7 at C/10 was shown in FIG. 8.

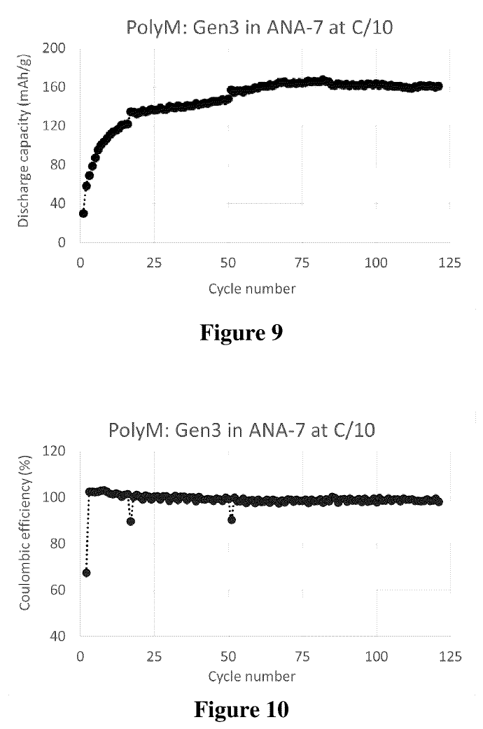

The galvanostatic cycling profile of the Li//PAQT cell in ANA-7 electrolyte at C/10 is presented in FIG. 9. PAQT is a sulfide polymer with four carbonyl groups in it structure capable of exchanging 4e- during cycling, which is equivalent to 400 mAh/g of theoretical specific capacity. In our experiments with Li//PAQT 2032 coin cells show 162 mAh/g of capacity at C/10 as shown in FIG. 8. Low specific capacity of the (˜50 mAh/g) was obtained in initial cycles suggesting the reorganization and wetting the electrode, which is presumably associated with high viscosity of the applied electrolyte. The specific capacity was improved with cycling, reaching the maximum capacity of 162 mAh/g after 50 cycles, which about 40% of the theoretical capacity of the polymer. No capacity fading was observed up to 124 cycles. The coulombic efficiency was found to be >99.8% for the cell up to 124 cycles (FIG. 10).

### Examples of Li//PAQS:SPAN Coin Cells

### Example 19: Li//PAQS:SPAN:SP:PVDF (45:22:23:10) Coin Cell

In this example, a hybrid mixture of PAQS and Sulfurized organo-sulfur polymer (SPAN) was used as cathode active materials. The cathode was prepared by first ball-milling the 1:1 mixture of SPAN and SP for 30 min a high energy ball-miller. Then 0.22 g of the SPAN:SP (1:1) mixture was taken a mortar and then added PAQS (0.24 g) to it and mixed them well using a pestle. The overall mixer was taken in a plastic cup and added a 3 wt % solution of PVDF in NMP (1.70 g). The sealed cup with the mixture was then placed in a Thinky centrifugal mixer and centrifuged at 2000 rpm for 30 sec for 3 times. A homogenous looking viscous slurry was obtained, which was coated on to carbon coated aluminum foil using an auto-coater. The coated foil was then dried at 80° C. for overnight under vacuum and stored in an argon glovebox with H₂O and O₂ levels<10 ppm. The final composition of the electrode came out as PAQS:SPAN:SP:PVDF (45:22:23:10 wt ratios).

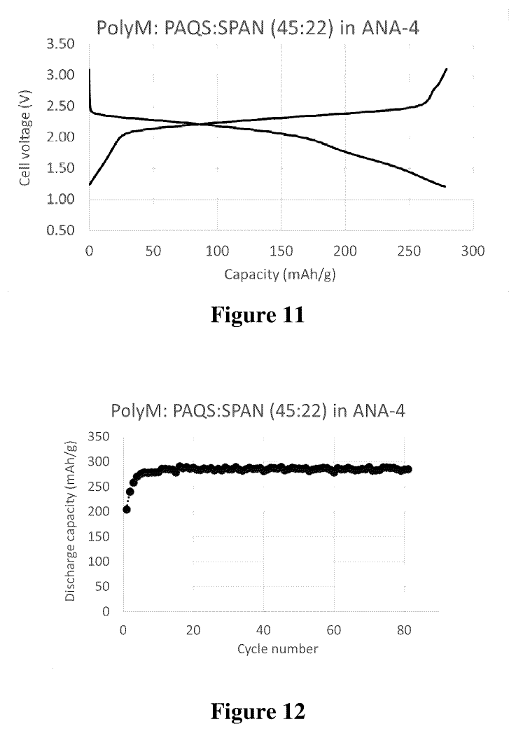

FIG. 11 shows a voltage profile (charge and discharge characteristics) of Li//PAQS:SPAN cell in ANA-4 at C/10.

The electrochemical tests were performed using two-electrode CR2032 coin-type cells using lithium chip (thickness 0.02 mm, 1.54 cm²) as anode, and above described PAQS:SPAN:SP:PVDF (2.90 mg, 1.13 cm²) as cathode. An 18 mm diameter (2.54 cm²) Celgard 2400 was used as separator. Various electrolyte formulations were tested, but in this example, 80 μL of 1M LiTFSI in DME:13DOL (1:1 vol) electrolyte formulation (ANA-4) was found to be given the best cycling data (FIG. 11). The cell was cycled at C/10 with the voltage cutoffs of 3.1V to 1.1V. This PAQS:SPAN hybrid mix of polymer gave an average 2.0V battery when coupled with metallic lithium anode (FIG. 11). The overall discharge capacity of the cell was found to be 285 mAh/g, which is >75% higher than the cathode with PAQS polymer alone.

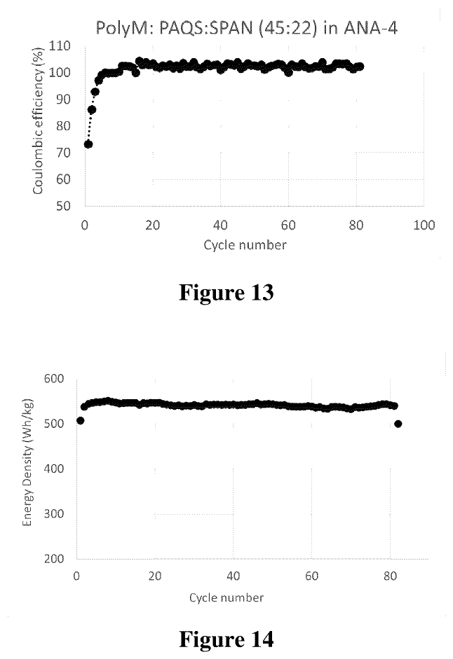

FIG. 12 shows discharge capacity vs. cycle number of Li//PAQS:SPAN cell in ANA-4 at C/10. The discharge capacity vs. cycle number is presented in FIG. 12. The data shows the remarkable stability of the discharge capacity up to 82 cycles. The coulombic efficiency vs. cycle number is presented in FIG. 13, which shows excellent coulombic efficiency up to 81 cycles. FIG. 13 shows Coulombic efficiency vs. cycle number of Li//PAQS:SPAN cell in ANA-4 at C/10.

The overall energy density (kWh/kg) of the system vs. cycle number is presented in FIG. 14. The overall energy density was found to be >550 Wh/kg and was remarkably stable up to at least 82 cycles.

FIG. 14 shows Energy density (kWh/g) vs. cycle number of Li//PAQS:SPAN cell in ANA-4 at C/10.

### Example 20: PAQS:SPAN:SP:PTFE:PVDF (48:38:10:1:4)

In this example, a PAQS:SPAN hybrid mixture of polymers was used as cathode active material. The cathode was prepared by first mixing 0.34 g PAQS polymer, 0.27 g of SPAN and SP carbon+PTFE (0.07 g) in 1.0 mL of EtOH:H₂O (1:1). The mixture was mixed by a Thinky centrifugal mixer at 2000 rpm for 30 sec. The EtOH:H₂O solvent mixture was dried at 80° C. for overnight, and the residual powder was then densified and granulated to fine powder. A 3 wt % solution of PVDF in NMP (0.9 g) was added into the granulated powder (0.72 g) in a plastic cup. The overall mixture was then placed in a Thinky centrifugal mixer and centrifuged at 2000 rpm for 30 sec for 3 times. To get appropriate slurry viscosity and texture, additional amount of pure NMP was added to the mixture, and then subsequently centrifuged at 2000 rpm for 30 sec. A total of 0.2 g of NMP was added to the mixture. The homogenous viscous slurry was coated on to carbon coated aluminum foil using an auto-coater. The coated foil was then dried at 100° C. for overnight under vacuum and stored in an argon glovebox with H₂O and O₂ levels<10 ppm. The final composition of the electrode came out as PAQS:SPAN:SP:PTFE:PVDF (48:38:9:1:4 wt ratios).

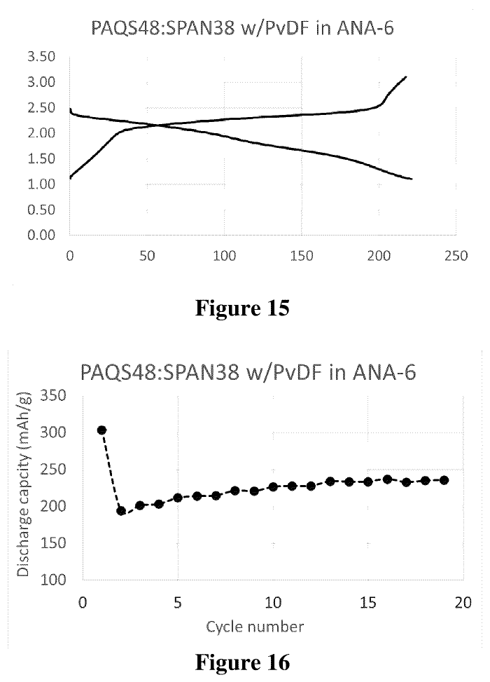

FIG. 15 show a voltage profile (charge and discharge characteristics) of Li//PAQS:SPAN (48:38) cell in ANA-6 at C/10.

The electrochemical tests were performed using two-electrode CR2032 coin-type cells using=lithium chip (thickness 0.02 mm, 1.54 cm²) as anode, and above described PAQS:SPAN:SP:PTFE:PVDF (3.23 mg, 1.13 cm²) as cathode. An 18 mm diameter (2.54 cm²) Celgard 2400 was used as separator. Various electrolyte formulations were tested, but in this example, 80 μL of 2M LiTFSI in DME:13DOL (1:1 vol) electrolyte formulation (ANA-6) was found to be given the best cycling data (FIG. 16). The cell was cycled at C/10 with the voltage cutoffs of 3.1V to 1.1V. The charge and discharge characteristics at C/10 of the cell is presented in FIG. 15. The overall discharge capacity of the cell was found to be 235 mAh/g, which is >47% higher than the cathode with PAQS polymer alone. The discharge capacity is slightly lower than the cell described in the previous example, which could be due to the addition of 1% PTFE in the cathode.

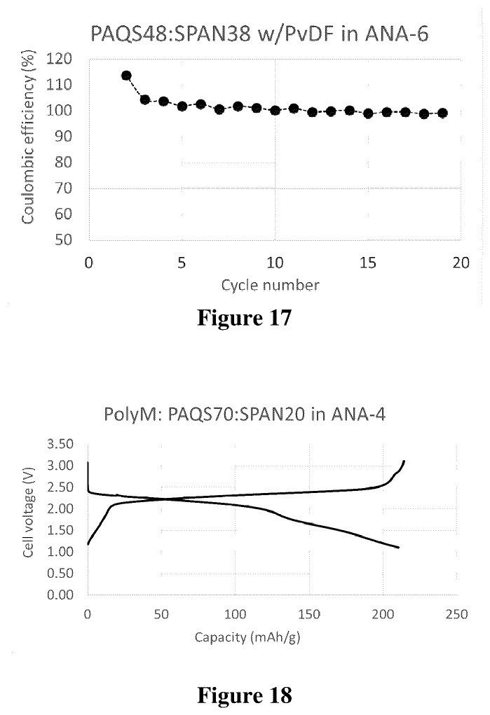

FIG. 16 shows discharge capacity vs. cycle number of Li//PAQS:SPAN (48:38) cell in ANA-6 at C/10. The discharge capacity vs. cycle number is presented in FIG. 16. The data shows the remarkable stability of the discharge capacity up to 18 cycles. The coulombic efficiency vs. cycle number was presented in FIG. 17, which shows 100% coulombic efficiency up to 18 cycles. FIG. 17 shows Coulombic efficiency vs. cycle number of Li//PAQS:SPAN (48:38) cell in ANA-6 at C/10.

### Example 21: PAQS:SPAN:SP:PVDF (70:20:5:5)

In this example, a hybrid mixture of PAQS and Sulfurized polyacrylonitrile polymer (SPAN) was used as cathode active materials. The cathode was prepared, first by mixing PAQS (0.70 g), SPAN (0.20 g) and SP (0.05 g) together in a mortar and pestle. The overall mixer was taken in a plastic cup and added a 3 wt % solution of PVDF in NMP (1.70 g). The cup with the mixture was then placed in a Thinky centrifugal mixer and centrifuged at 2000 rpm for 30 sec for 3 times. To get appropriate slurry viscosity and texture, additional amount of pure NMP was sequentially added to the mixture, and then subsequently centrifuged at 2000 rpm for 30 sec. A total of 0.5 g of pure NMP added to the mixture. A homogenous looking viscous slurry was obtained, which was then coated on to carbon coated aluminum foil using an auto-coater. The coated foil was then dried at 80° C. for overnight under vacuum and stored in an argon glovebox with H₂O and O₂ levels<10 ppm. The final composition of the electrode came out as PAQS:SPAN:SP:PVDF (70:20:5:5 wt ratios).

FIG. 18 shows voltage profile (charge and discharge characteristics) of Li//PAQS:SPAN (70:20) cell in ANA-4 at C/10.

The electrochemical tests were performed using two-electrode CR2032 coin-type cells using lithium chip (thickness 0.02 mm, 1.54 cm²) as anode, and above described PAQS:SPAN:SP:PTFE:PVDF (6.70 mg, 1.13 cm²) as cathode. An 18 mm diameter (2.54 cm²) Celgard 2400 was used as separator. Various electrolyte formulations were tested, but in this example, 80 μL of 1M LiTFSI in DME:13DOL (1:1 vol) electrolyte formulation (ANA-4) was found to be given the best cycling data (FIG. 18). The cell was cycled at C/10 with the voltage cutoffs of 3.1V to 1.1V. The charge and discharge characteristics at C/10 of the cell is presented in FIG. 18. The overall discharge capacity of the cell was found to be 225 mAh/g, which is >40% higher than the cathode with PAQS polymer alone.

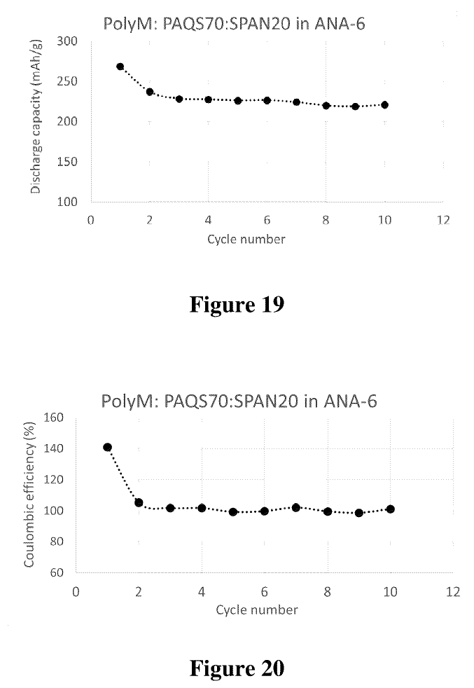

FIG. 19 shows discharge capacity vs. cycle number of Li//PAQS:SPAN (70:20) cell in ANA-4 at C/10. The discharge capacity vs. cycle number is presented in FIG. 19. The data shows the remarkable stability of the discharge capacity up to 10 cycles. The coulombic efficiency vs. cycle number was presented in FIG. 20, which shows 100% coulombic efficiency up to 10 cycles. FIG. 20 shows Coulombic efficiency vs. cycle number of Li//PAQS:SPAN (70:20) cell in ANA-4 at C/10.

### Example 22: PAQS-PBQS Random Copolymer as Cathode Active Material

The overall capacity of the PAQS can be improved by incorporating lower molecular weight monomer such as benzoquinone (BQ) into the polymer backbone. The synthesis of copolymer of PAQS-PBQS is described in Scheme 5 reported in Example 34.

In this example, a copolymer with 80 mol % PAQS and 20 mol % PBQS and used as cathode active materials. The cathode was prepared by first mixing 0.35 g PAQS_{0.8}-PBQS_{0.2} copolymer and 0.10 g of SP carbon by using a mortar and pestle. A 3 wt % solution of PVDF in NMP (1.70 g) was added into the mixed powder (0.45 g) in a plastic cup. The overall mixture was then placed in a Thinky centrifugal mixer and centrifuged at 2000 rpm for 30 sec for 3 times. To get appropriate slurry viscosity and texture, additional amount of pure NMP was added to the mixture, and then subsequently centrifuged at 2000 rpm for 30 sec. A total of 0.2 g of NMP was added to the mixture. The homogenous viscous slurry was coated on to carbon coated aluminum foil using an auto-coater. The coated foil was then dried at 100° C. for overnight under vacuum and stored in an argon glovebox with H₂O and O₂ levels<10 ppm. The final composition of the electrode came out as PAQS_{0.8}-PBQS_{0.2}:SP:PVDF (70:20:10 wt ratios).

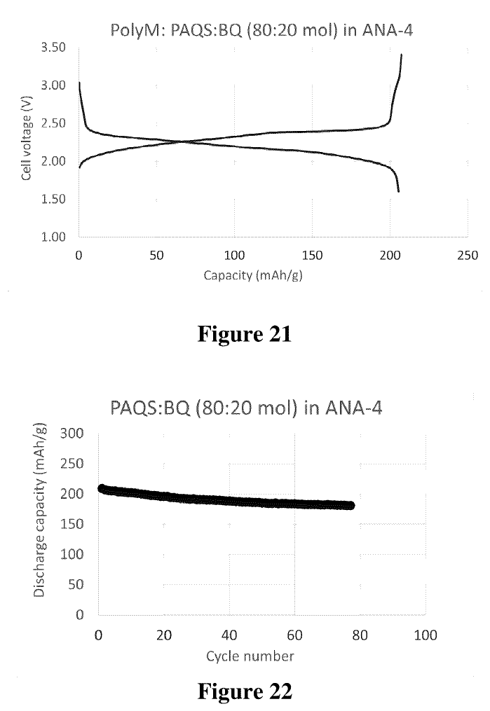

FIG. 21 shows a voltage profile (charge and discharge characteristics) of Li//PAQS_{0.8}-PBQS_{0.2} cell in ANA-4 at C/10.

The electrochemical tests were performed using two-electrode CR2032 coin-type cells using lithium chip (thickness 0.02 mm, 1.54 cm²) as anode, and above described PAQS_{0.8}-PBQS_{0.2}:SP:PVDF (2.9 mg, 1.13 cm²) as cathode. An 18 mm diameter (2.54 cm²) Celgard 2400 was used as separator. Various electrolyte formulations were tested, but in this example, 80 μL of 1M LiTFSI in DME:13DOL (1:1 vol) electrolyte formulation (ANA-4) was found to be given the best cycling data (FIG. 21). The cell was cycled at C/10 with the voltage cutoffs of 3.2V to 1.6V. The charge and discharge characteristics at C/10 of the cell is presented in FIG. 22. The overall discharge capacity of the cell was found to be 205 mAh/g, which is >25% higher than the cathode with PAQS polymer alone.

FIG. 22 shows discharge capacity vs cycle number of Li//PAQS_{0.8}-PBQS_{0.2} cell in ANA-4 at C/10.

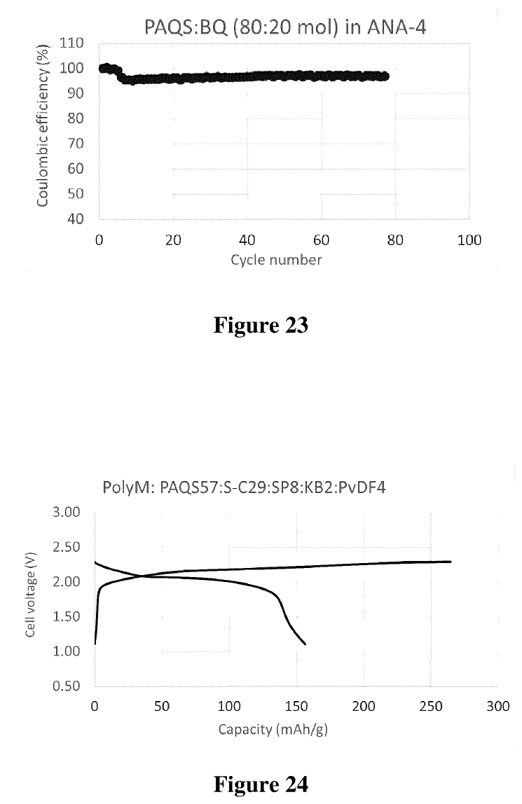

The discharge capacity vs. cycle number is presented in FIG. 22. The data shows slight decay of the discharge capacity up to 78 cycles The coulombic efficiency vs. cycle number was presented in FIG. 23, which shows 98% coulombic efficiency up to 78 cycles.

FIG. 23 shows Coulombic efficiency vs. cycle number of Li//PAQS_{0.8}-PBQS_{0.2} cell in ANA-4 at C/10.

### Example 23: PAQS:Sulfur Composite (S-C) as Cathode Active Material

Sulfur cathode in nonaqueous lithium sulfur battery is known to form lithium polysulfides during discharge. The dissolution of polysulfides into the electrolyte and their migration from cathode to anode causing the shuttling phenomenon during charge is one of the major obstacles for lithium sulfur battery to be a practical rechargeable battery technology. To demonstrate the advantage of choosing a PAQS:SPAN hybrid cathode, we prepared PAQS:S-C hybrid cathode and cycled the Li//PAQS:S-C cells by following the same protocol as Li//PAQS:SPAN cells in the same electrolyte.

The sulfur-carbon (S-C) composite material was purchased from MSE supplies (Product No. PO5018). The sulfur content of the composite was reported to be 75 wt %. The cathode was prepared, first by mixing S-C composite (0.29 g), PAQS (0.57 g), SP (0.08 g) and KB (0.02 g) together in a mortar and pestle. The overall mixer was taken in a plastic cup and added a 3 wt % solution of PVDF in NMP (1.30 g). The cup with the mixture was then placed in a Thinky centrifugal mixer and centrifuged at 2000 rpm for 30 sec for 3 times. A homogenous looking viscous slurry was obtained, which was then coated on to carbon coated aluminum foil using an auto-coater. The coated foil was then dried at 80° C. for overnight under vacuum and stored in an argon glovebox with H₂O and O₂ levels<10 ppm. The final composition of the electrode came out as PAQS:S-C:SP:KB:PVDF (57:29:8:2:4 wt ratios).

FIG. 24 shows a voltage profile (charge and discharge characteristics) of Li//PAQS:S-C cell in ANA-4 at C/10.

The electrochemical tests were performed using two-electrode CR2032 coin-type cells using lithium chip (thickness 0.02 mm, 1.54 cm²) as anode, and above described PAQS:S-C:SP:KB:PVDF (6.15 mg, 1.13 cm²) as cathode. An 18 mm diameter (2.54 cm²) Celgard 2400 was used as separator. A 80 μL of 1M LiTFSI in DME:13DOL (1:1 vol) electrolyte formulation (ANA-4) was used. The cell was cycled at C/10 with the voltage cutoffs of 3.2V to 1.1V. The charge and discharge characteristics at C/10 of the cell is presented in FIG. 24. The cycling data shows a considerable over-charge during charge, which indicates the shuttling mechanism.

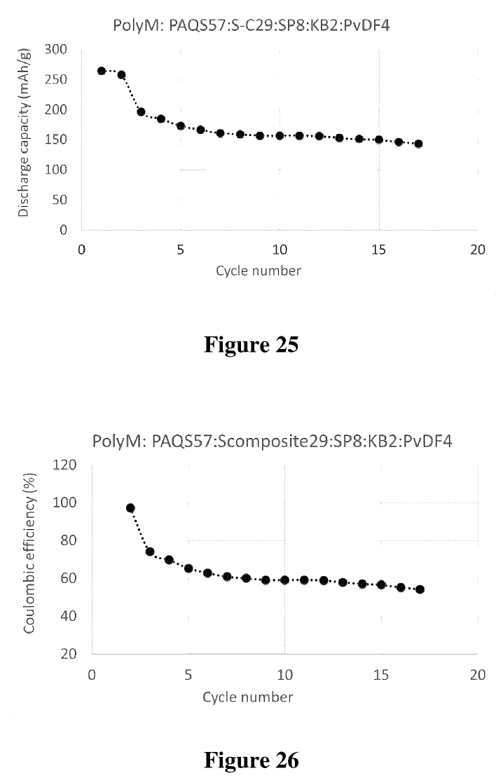

FIG. 25 shows discharge capacity vs cycle number of Li//PAQS:S-C cell in ANA-4 at C/10.

The discharge capacity vs. cycle number of the cell is presented in FIG. 25. The data shows a considerable decay of the discharge capacity up to 17 cycles. The coulombic efficiency vs. cycle number was presented in FIG. 26. The data shows a significant decay of coulombic efficiency with cycling, which is mainly due to the shuttling mechanism of polysulfides.

FIG. 26 shows Coulombic efficiency vs cycle number of Li//PAQS:S-C cell in ANA-4 at C/10.

### Example 24: PAQS: Elemental Sulfur as Cathode Active Material

In this example, the cathode was prepared, first by mixing PAQS (0.57 g), elemental S (0.29 g), SP (0.08 g) and KB (0.02 g) together in a mortar and pestle. The overall mixer was taken in a plastic cup and added a 3 wt % solution of PVDF in NMP (1.30 g). The cup with the mixture was then placed in a Thinky centrifugal mixer and centrifuged at 2000 rpm for 30 sec for 3 times. To get appropriate slurry viscosity and texture, additional amount of pure NMP was added to the mixture, and then subsequently centrifuged at 2000 rpm for 30 sec. A total of 0.25 g of NMP was added to the mixture. A homogenous looking viscous slurry was obtained, which was then coated on to carbon coated aluminum foil using an auto-coater. The coated foil was then dried at 80° C. for overnight under vacuum and stored in an argon glovebox with H₂O and O₂ levels<10 ppm. The final composition of the electrode came out as PAQS:S:SP:KB:PVDF (57:29:8:2:4 wt ratios).

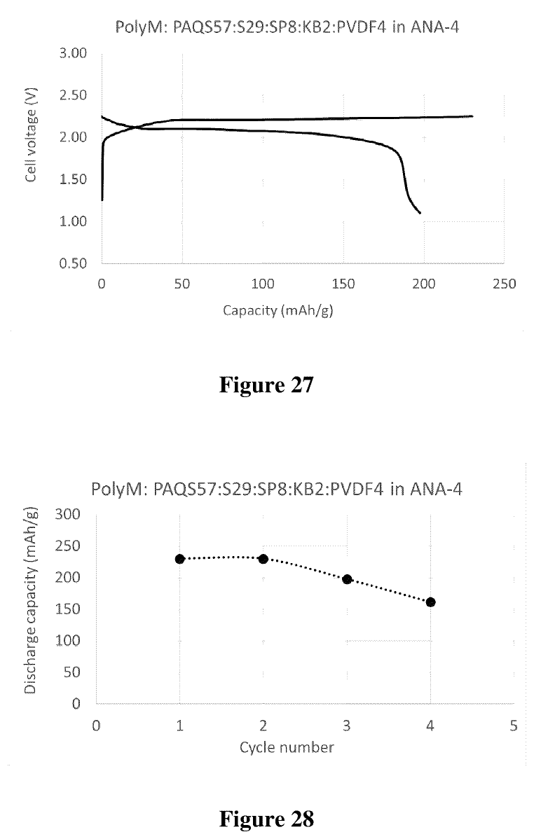

FIG. 27 shows a voltage profile (charge and discharge characteristics) of Li//PAQS:S cell in ANA-4 at C/10.

The electrochemical tests were performed using two-electrode CR2032 coin-type cells using lithium chip (thickness 0.02 mm, 1.54 cm²) as anode, and above described PAQS:S:SP:KB:PVDF (6.0 mg, 1.13 cm²) as cathode. An 18 mm diameter (2.54 cm²) Celgard 2400 was used as separator. A 80 μL of 1M LiTFSI in DME:13DOL (1:1 vol) electrolyte formulation (ANA-4) was used. The cell was cycled at C/10 with the voltage cutoffs of 3.2V to 1.1V. The charge and discharge characteristics at C/10 of the cell is presented in FIG. 27. The cycling data shows a considerable over-charge during charge, which indicates the polysulfide shuttling mechanism.

FIG. 28 shows discharge capacity vs cycle number of Li//PAQS:S cell in ANA-4 at C/10.

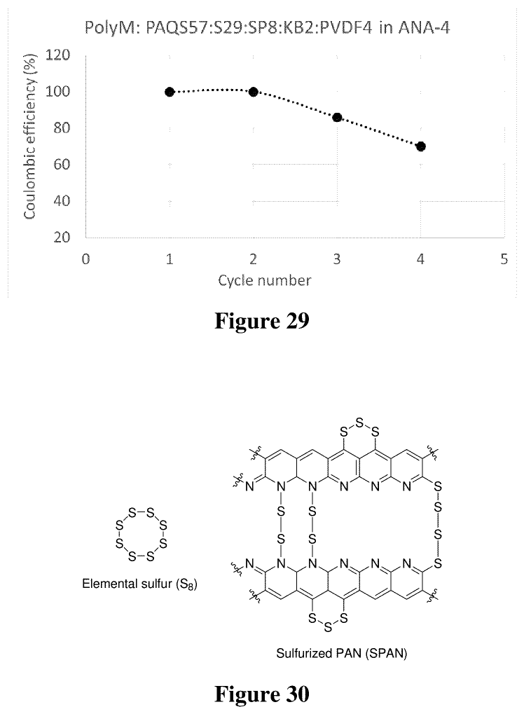

The discharge capacity vs. cycle number of the cell is presented in FIG. 28. The data shows a considerable decay of discharge capacity in just 4 cycles. The coulombic efficiency data shows a significant decay of coulombic efficiency just in 4 cycles (FIG. 29), which is mainly due to the shuttling mechanism of polysulfides.

FIG. 29 shows Coulombic efficiency vs cycle number of Li//PAQS:S cell in ANA-4 at C/10.

### Example 25: Comparison Between PAQS:SPAN System Vs. PAQS:S-C or PAQS:S System

A comparison between SPAN/PAQS and S-C composite/PAQS shows the advantage of SPAN. The electrochemical performance data for the batteries with PAQS:SPAN, PAQS:S-C and PAQS:S hybrid cathodes with metallic lithium anode in the same nonaqueous electrolyte (ANA-4) are shown in FIGS. 11-14, FIGS. 24-29, respectively. It is evident from the voltage profiles (FIG. 11, FIG. 24, FIG. 27) and cyclic data (FIG. 12, FIG. 25, FIG. 28) that the cell with PAQS:SPAN hybrid cathode performed considerably better than the cell with PAQS:S-C and PAQS:S cathode. The current invention PAQS:SPAN hybrid cathode shows the highest discharge capacity (286 mAh/g), as shown in FIG. 11, compared to PAQS:S-C composite (FIG. 24) and PAQS:S (FIG. 27) hybrid cathodes. The SPAN material used in this disclosure is a high sulfur content(up to 40 wt % or higher). Conductive material with -S- embedded into the conductive matrix of pyrolyzed polyacrylonitrile. Due to the embedded nature of the active sulfur in the matrix of the polymer, the battery with PAQS:SPAN cathode showed excellent cycling stability (FIG. 12) and excellent coulombic efficiency (FIG. 13) compared to the S-C and elemental sulfur cathodes. Both PAQS:S-C and PAQS:S cathodes showed considerable overcharges, as shown in FIG. 24 and FIG. 27, respectively and dismal coulombic efficiency, as shown in FIG. 26 and FIG. 29, respectively. The high overcharges and low coulombic efficiencies are believed to be for the formation of soluble polysulfides during discharge.

The present PAQS:SPAN hybrid cathode provides a stable high energy density system (>500 Wh/kg), as shown in FIG. 14. Additional data reported in Example 4—and FIG. 37 show in some cases a PAQS:SPAN hybrid cathode can provide a stable high energy density system>650 Wh/kg.

### Example 26: Synthesis of PAQS

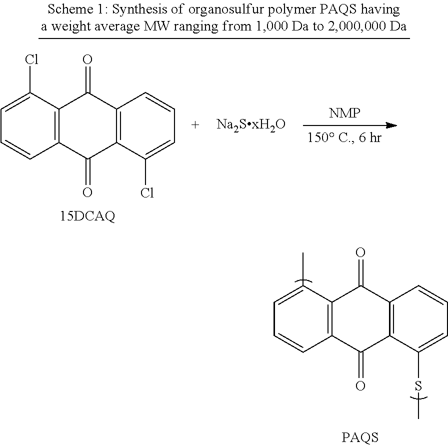

To a solution of 2,5-dichloroanthraquinone (25.00 g, 90.22 mmol) in NMP (200 mL) under argon atmosphere in a 1 L round-bottomed flask, was slowly added Na₂S.xH₂O (60%, 11.73 g, 90.22 mmol). The mixture was stirred at room temperature under argon atmosphere for 15 min, and then heated to 150° C. for 6 hours. Heating was stopped and them mixture allowed to cool to room temperature. The precipitate was then filtered off, washed with NMP, then water and then acetone. The brown solid product of PAQS (22.0 g) was dried at 120° C. for overnight. The formation of PAQS polymer and its purity were verified by elemental analysis and TGA analysis. The data shows that the measured values of C, H, and S in PAQS is found to be 67.08%, 2.55%, and 12.95%, respectively, which corresponds to an empirical formula of C₁₄H₆S. The approximate calculated value of C, H, S is 70.57%, 2.54% and 13.43%, respectively. The measured value and calculated value are within close agreement. The TGA data shows no mass loss up to 420° C.

### Example 27: Synthesis of 36PPAQS

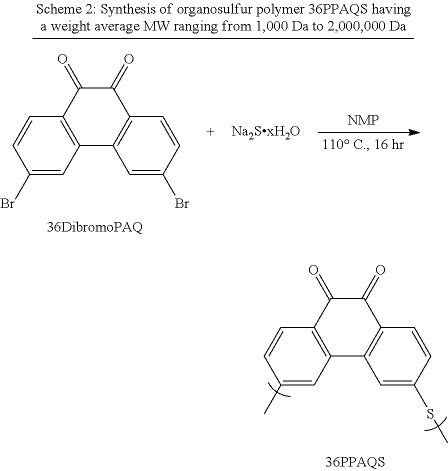

In an argon filled glovebox, to a solution of 3,6-dibromo-phenanthrequinone (2.0 g, 5.46 mmol) in NMP (15 mL) in a 40 mL vial, slowly added Na₂S.xH₂O (60%, 0.71 g, 5.46 mmol). The mixture was stirred at room temperature under argon atmosphere for 15 min, and then the reaction vial was taken out of the glove box and started heating to 110° C. The reaction mixture was heated at 110° C. for 16 hours. It was then stopped heating and allowed to cool to room temperature, a brown color solution was observed with some precipitate. 5 mL of EtOH was added to the solution, and stirred for 3 hr. A brown precipitate appeared. The precipitate was then filtered off, washed with NMP, then water and then acetone. The brown solid product of 36PPAQS (1.10 g) was dried at 120° C. for overnight. The product was characterized by elemental analysis and by TGA. The data shows that the measured values of C, H, and S in 36PAQS is found to be 66.55%, 2.68%, and 13.21%, respectively, which corresponds to an empirical formula of C₁₄H₆S. The approximate calculated value of C, H, S is 69.98%, 3.36% and 13.35%, respectively. The measured value and calculated value are within close agreement. The TGA data shows no mass loss up to 400° C.

36PPAQS is also synthesized using different reaction solvents such Sulfolane, DMA, DMF, DMSO, and Sulfolane/NMP mixtures by following the same procedure and conditions described above.

### Example 28: Synthesis of 27PPAQS

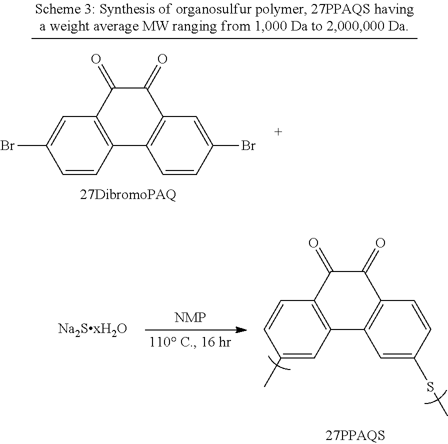

In an argon filled glovebox, to a solution of 2,7-dibromo-phenanthrequinone (2.0 g, 5.46 mmol) in NMP (15 mL) in a 40 mL vial, slowly added Na₂S.xH₂O (60%, 0.71 g, 5.46 mmol). The mixture was stirred at room temperature under argon atmosphere for 20 min, and then the reaction vial was taken out of the glove box and started heating to 120° C. The reaction mixture was heated at 120° C. for 15 hours. It was then stopped heating and allowed to cool to room temperature, a brown color solution was observed with some precipitate. 6 mL of EtOH was added to the solution, and stirred for 3 hr. A brown precipitate appeared. The precipitate was then filtered off, washed with NMP, then water and then acetone. The brown solid product of 27PPAQS (1.0 g) was dried at 110° C. for overnight. The product was characterized by elemental analysis and by TGA. The data shows that the measured values of C, H, and S in 27PAQS is found to be 66.75%, 2.98%, and 13.10%, respectively, which corresponds to an empirical formula of C₁₄H₆S. The approximate calculated value of C, H, S is 69.98%, 3.36% and 13.35%, respectively. The measured value and calculated value are within close agreement. The TGA data shows no mass loss up to 400° C.

### Example 29: Synthesis of PAQT

Poly(1,2,5,6-anthracenetetrone sulfide) (PAQT) was synthesized in four steps:

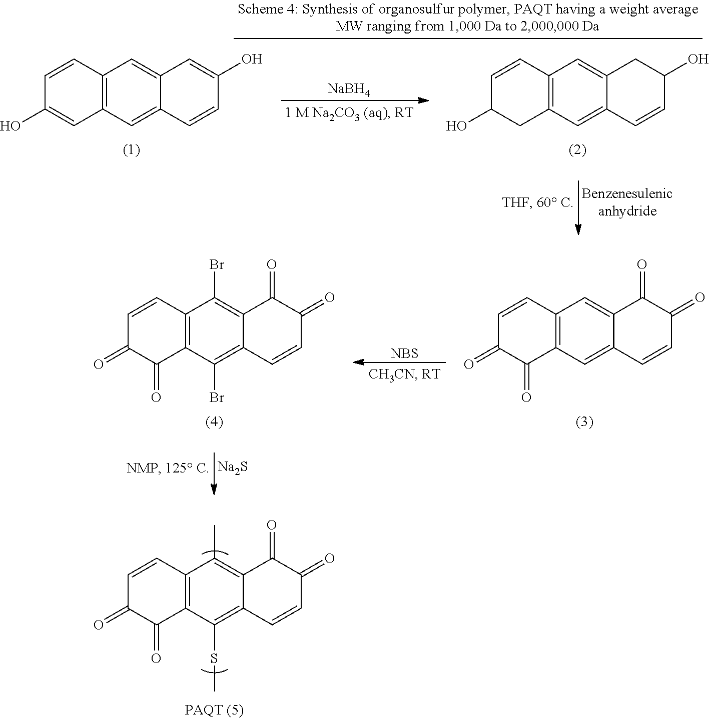

### Example 30: Synthesis of 2,6-dihyroxyanthracene (1)

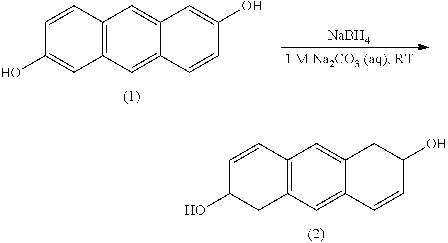 [SMILES: Oc1ccc2cc3cc(O)ccc3cc2c1 ; "NaBH4" ; OC1C=Cc2cc3c(cc2C1)C=CC(O)C3]

In a 250 mL two-neck round bottom flask equipped with a stir bar and headspace covered with inert gas was added sodium borohydride (3.54 g, 93.5 mmol) in 1 M sodium carbonate solution (78 mL). Next, anthraflavic acid (1, 1.50 g, 6.54 mmol) was added in batches to the reaction mixture and then allowed to stir at room temperature overnight. The reaction mixture was poured into cold 6M hydrochloric acid (13 mL). The aqueous layer was extracted with ethyl acetate three times. The combined organic layers were then washed with saturated sodium bicarbonate solution and dried with anhydrous Na₂SO₄. The solution was filtered and concentrated under reduced pressure to obtain a light brown powder. The solid was dried under vacuum at 60° C. overnight to yield 1.3 g solid (2), 99% yield.

¹H-NMR (DMSO-d₆, 300 MHz): δ: 9.67 (s, 2H), 8.15 (s, 2H), 7.84 (d, J=9 Hz, 2H), 7.14 (s, 2H) and 7.09 (d, J=6.9 Hz).

### Example 31: Synthesis of 1,2,5,6-anthracenetetraone (3)

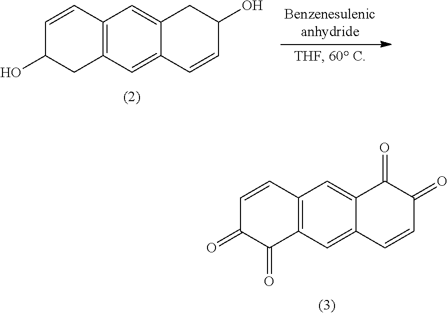 [SMILES: OC1C=Cc2cc3c(cc2C1)C=CC(O)C3 ; O=c1ccc2cc3c(=O)c(=O)ccc3cc2c1=O]

2,6-Dihydroxyanthracene (2, 0.5 g, 2.38 mmol) was dissolved in dry THF (48 mL) and purged with argon. The solution was then added in portions to a stirred solution of benzeneseleninic acid anhydride (1.71 g, 4.76 mmol) in dry THF (100 mL) under argon (in a three-necked round-bottom flask equipped with a reflux condenser with argon balloon and a thermometer). The reaction was heated to 50° C. for 3 hours and was then allowed to cool to room temperature. After storing overnight, the solvent and volatile by-products were removed in vacuo using a rotary evaporator, which was placed in a fume hood to prevent inhalation of volatile selenium by-products. The crude material was stirred in 1,4-dioxane overnight and filtered to afford 460 mg of red solid (3), 81% yield.

¹HNMR (DMSO-d₆, 300 MHz): δ: 8.20 (s, 2H), 7.89 (d, J=9 Hz, 2H), 6.58 and (d, J=10.2 Hz, 2H)

### Example 32: Synthesis of 9,10-dibromo-1,2,5,6-anthracenetetraone (4)

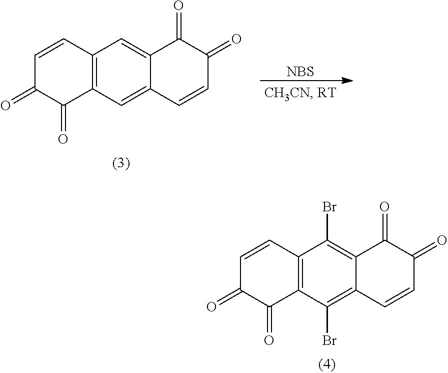

To a solution of 1,2,5,6-anthracenetetraone (3, 0.25 g, 1.05 mmol) in acetonitrile (16 mL) in a round bottom flask equipped with a stir bar was added N-bromosuccinimide (0.75, 4.20 mmol) in one portion. The resulting mixture was allowed to stir at room temperature overnight. The reaction was allowed to come to room temperature and poured into 30 mL of ice water. The precipitate was filtered, washed with water (3×) and hexane (3×), and dried under high vacuum at 100 C to yield 310 mg of dark green solid (4), 75% yield.

¹H-NMR (DMSO-d₆, 300 MHz): δ: 8.26 (d, J=6.3 Hz, 2H) and 8.05 (d, J=6.3 Hz, 2H).

### Example 33: Synthesis of Poly-Anthracenetetrone Sulfide (PAQT) (5)

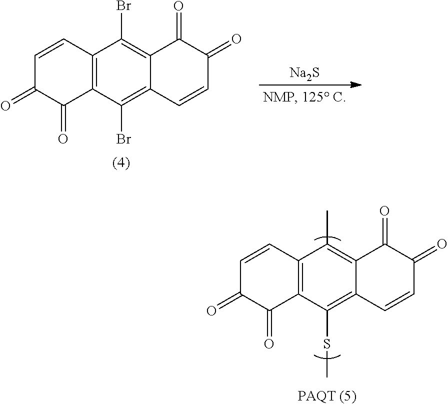

To a solution of 4,8-dibromo-1,2,5,6-anthracenetetraone (0.10 g, 0.25 mmol) in anhydrous NMP (0.6 mL) in a round bottom flask was added sodium sulfide anhydrous (0.020 g, 0.25 mmol). The reaction mixture was heated to 100° C. overnight. The resulting mixture was allowed to come to room temperature, precipitate filtered. The precipitate was washed with hot water (3×) and acetone (3×). The precipitate was dried overnight under high vacuum at 110° C. to yield 80 mg of dark grey solid (PAQT), 100% yield. The product was characterized by elemental analysis. The data shows that the measured values of C, H, and S in PAQT is found to be 65.12%, 2.74%, and 16.10%, respectively. The approximate calculated value of C, H, S is 63.48%, 2.66% and 16.95%, respectively. The measured value and calculated value are within close agreement.

### Example 34: Synthesis of Poly-Anthraquinone-Benzoquinone Sulfide

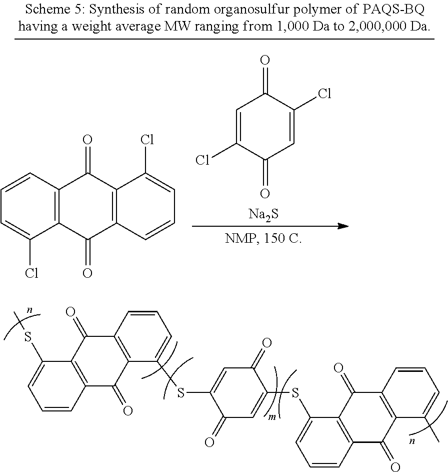

Under argon condition, a vial was added 1,5-dichloroanthraquinone (1.0 g, 3.6 mmol), 2,5-dichloro-1,4-benzoquinone (0.2 g, 1.1 mmol), anhydrous NMP (17 mL), and sodium sulfide (0.4 g, 4.7 mmol). The reaction was allowed to stir under argon at 150° C. for 16 hours. Upon completion, the reaction mixture was cooled to room temperature and the precipitate was filtered. The precipitate was washed 3 times with hot water and 3 times with acetone until the wash is clear. The precipitate was dried under vacuum at 120° C. to yield 0.65 g of orange-brown solid.

### Example 35: Synthesis of Poly-Anthraquinone-Benzoquinone Trisulfide

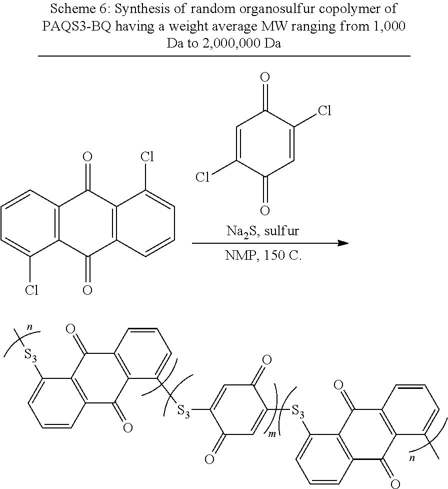

Under argon conditions, 1,5-dichloroanthraquinone (1.0 g, 3.6 mmol), 2,5-dichloro-1,4-benzoquinone (0.13 g, 0.7 mmol), sulfur (0.28 g, 8.7 mmol), anhydrous NMP (17 mL), and sodium sulfide (0.34 g, 4.3 mmol) were added to a vial. The reaction was allowed to stir under argon at 150° C. for 16 hours. Upon completion, the reaction mixture was cooled to room temperature and the precipitate was filtered. The precipitate was washed 3 times with hot water and 3 times with acetone until the wash is clear. The precipitate was dried under vacuum at 120° C. to yield 1.13 g of dark green solid.

### Example 36: Synthesis of Poly-Anthraquinone-Benzoquinone Pentasulfide

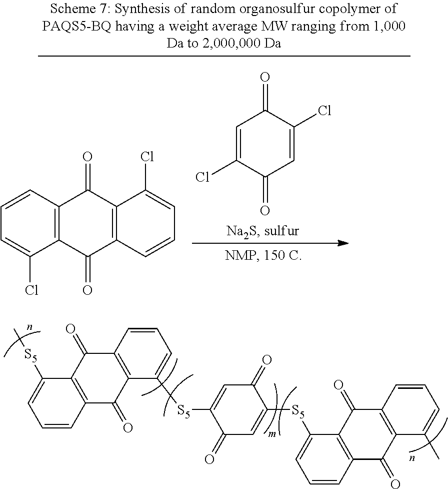

Under argon condition, a vial was added 1,5-dichloroanthraquinone (1.0 g, 3.6 mmol), 2,5-dichloro-1,4-benzoquinone (0.13 g, 0.7 mmol), sulfur (0.53 g, 16.6 mmol), anhydrous NMP (17 mL), and sodium sulfide (0.34 g, 4.3 mmol). The reaction was allowed to stir under argon at 150° C. for 16 hours. Upon completion, the reaction mixture was cooled to room temperature and the precipitate was filtered. The precipitate was washed 3 times with hot water and 3 times with acetone until the wash is clear. The precipitate was dried under vacuum at 120° C. to yield 1.23 g of light green solid.

### Example 37: Synthesis of Sulfurized Polyacrylonitrile (SPAN)

An exemplary synthesis of sulfurized carbon matrix polymer from polyacrylonitrile is reported below.

Sulfurized carbon matrix polymer was synthesized in two steps. First, polyacrylonitrile (PAN, Mw 150,000) was mixed with dried elemental S in a mass ratio of 1:4 and ball-milled for an hour or up to three hours in some cases. to ensure homogeneous mixing. The S: PAN (4:1) mixture was heated in a N₂ filled furnace at 155° C. for 2 hours first for elemental S to melt and mix with PAN polymer. The furnace temperature was ramped up to 450° C. with ramping rate of 5° C./min, and isotherm at 450° C. for 6 hours to get sulfurized PAN composite material. The SPAN was characterized by elemental analysis and it shows that there is 35.36 wt % S, 48.67 wt % C, 1.08 wt % of H, and 7.34 wt % of N in this sulfurized polymer (SPAN).

### Example 38: Battery Made of Li/Organosulfur Polymer Cathode Cells

FIG. 32 shows exemplary arrangement of a plurality of electrochemical cells in a battery herein described.

FIG. 33 shows a schematic representation of an exemplary plurality of electrically connected electrochemical cells in accordance with the disclosure.

### Example 39: Exemplary Procedure to Prepare an S-Linked Polymer:Sulfurized Carbon Matrix Polymer Cathode

An exemplary procedure to prepare an S-linked polymer: sulfurized carbon matrix polymer cathode is provided below and can be applied to SPAN or additional Sulfurized carbon matrix polymers.

First, a specific ratio of Sulfurized carbon matrix polymer:SP C65 carbon mixture was mixed by mortar and pestle for 10 min. The Sulfurized carbon matrix polymer: SP C65 mixture was then added to S-linked quinone polymer PAQS and mixed them well using a coffee mixer. A calculated amount 3 wt % solution of PVDF or Na-CMC (medium) in NMP or H₂O was added to the powder mixture of S-linked quinone polymer: Sulfurized carbon matrix polymer: SP C65 in a cup which was sealed using a screw cap. The whole mixture was then placed into a Thinky centrifuged mixture and mixed then at 2000 rpm for 30 sec to 5 min for at least 3 times. A thick honey like material was coated onto a carbon coated aluminum foil. The NMP or H₂O was dried at 80° C. under vacuum.

### Additional Examples of Li//S-Linked Quinone Polymer: Sulfurized Carbon Matrix Polymer Coin Cells

### Example 40: Li//S-Linked Quinone Polymer: Sulfurized Carbon Matrix Polymer:SP-C65:CMC (35:47:11:7) Coin Cell

In this example, a hybrid mixture of S-linked quinone polymer (PAQS) and sulfurized carbon matrix polymer (Sulfurized organo-sulfur polymer (SPAN)) was used as cathode active materials. The cathode was prepared by first mixing sulfurized carbon matrix polymer and SP-C65 using a mortar and pestle. Then added the S-linked quinone polymer into the mortar and mixed using a pestle. A 3% CMC (Medium) solution in H₂O was added to the hybrid mix of S-linked polymer, sulfurized carbon matrix polymer and SP-C65. The overall mixture was spin-mixed using a Thinky for 30 sec at 2000 rpm, twice. A homogenous looking viscous slurry was obtained, which was coated on to carbon coated aluminum foil using an auto-coater. The coated foil was then dried at 80° C. for overnight under vacuum and stored in an argon glovebox with H₂O and O₂ levels<10 ppm. The final composition of the electrode came out as S-Linked Quinone Polymer: Sulfurized Carbon Matrix: SPC65: CMC (35:47:11:7). This combination of hybrid polymers is termed as Gen4 polymer.

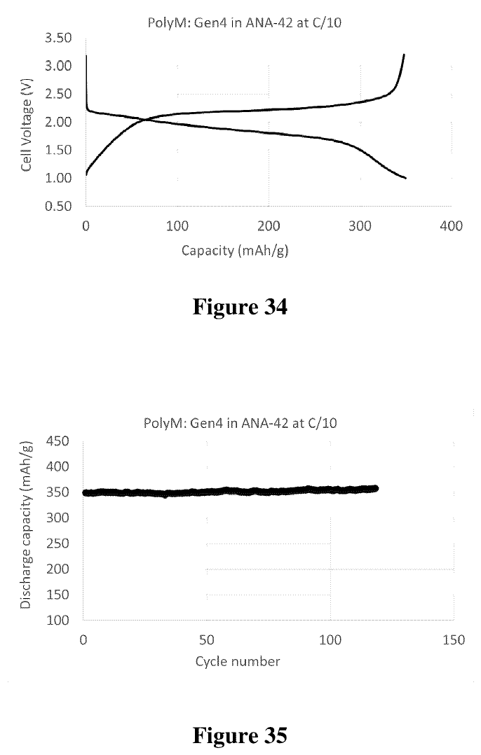

FIG. 34. shows a voltage profile (charge and discharge characteristics) of Li//Gen4 in ANA-42 at C/10.

The electrochemical tests were performed using two-electrode CR2032 coin-type cells using lithium chip (thickness 0.02 mm, 1.54 cm²) as anode, and above described Gen4 as cathode. An 18 mm diameter (2.54 cm²) Celgard 2400 was used as separator. Various electrolyte formulations were tested, but in this example, 80 μL of 1.2M LiFSI in BTFE:TEP (1:3 mol) electrolyte formulation termed as ANA-42 was found to be given the best cycling data (FIG. 34). The cell was cycled at C/10 with the voltage cutoffs of 3.2V to 1.0V. This Gen4 hybrid mix of polymer gave an average ˜1.9V battery when coupled with metallic lithium anode (FIG. 34) The overall discharge capacity of the cell was found to be 350 mAh/g, which is >100% higher than the cathode with PAQS polymer alone. This is a significant improvement of capacity when a hybrid mix of S-linked polymer and sulfurized carbon matrix polymer is used as a cathode active material.

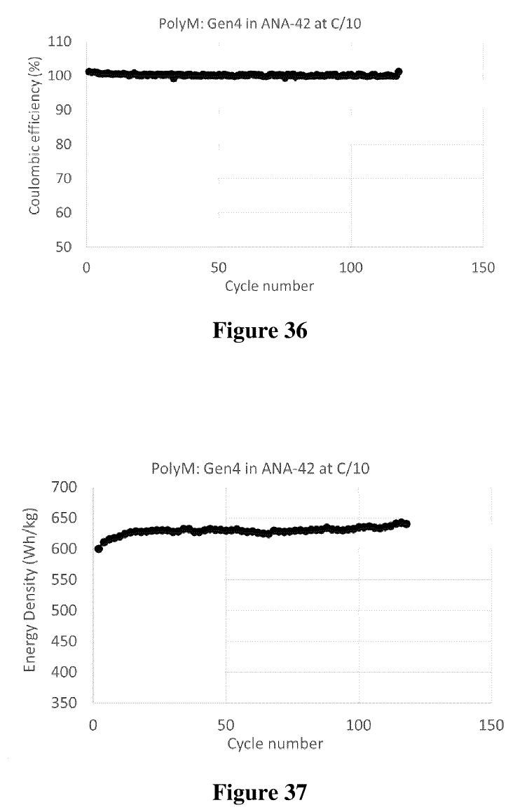

FIG. 35 shows discharge capacity vs. cycle number of Li//Gen4 hybrid polymer cell in ANA-42 at C/10. The data shows the remarkable stability of the discharge capacity up to 110 cycles. The coulombic efficiency vs. cycle number is presented in FIG. 36 which shows excellent coulombic efficiency up to 110 cycles. The overall energy density (Wh/kg) of the system vs. cycle number is presented in FIG. 37. The overall energy density was found to be >550 or >640 Wh/kg and was remarkably stable up to at least 110 cycles.

### Example 41: Gen4 Polymer Cycling at Higher Rate (C/3)

The Gen4 hybrid mix of polymer cathode was coated on to the carbon coated aluminum foil as described in example 40. The coated foil was then dried at room temperature for overnight, and then at 100° C. for overnight under vacuum and stored in an argon glovebox with H₂O and O₂ levels<10 ppm. The final composition of the electrode came out as Gen4:SPC65:CMC (82:11:7 wt ratios).

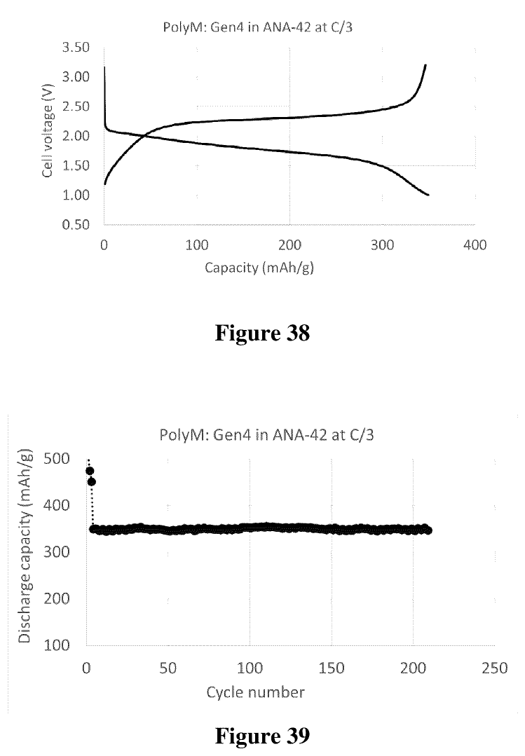

FIG. 38 show a voltage profile (charge and discharge characteristics) of Li//Gen4 hybrid polymer cathode in ANA-42 at C/3.

The cell was cycled at C/3 with the voltage cutoffs of 3.2V to 1.0V. The charge and discharge characteristics at C/3 in FIG. 38. The overall discharge capacity of the cell was found to be 340 mAh/g which is also >100% higher than the cathode with PAQS polymer alone.

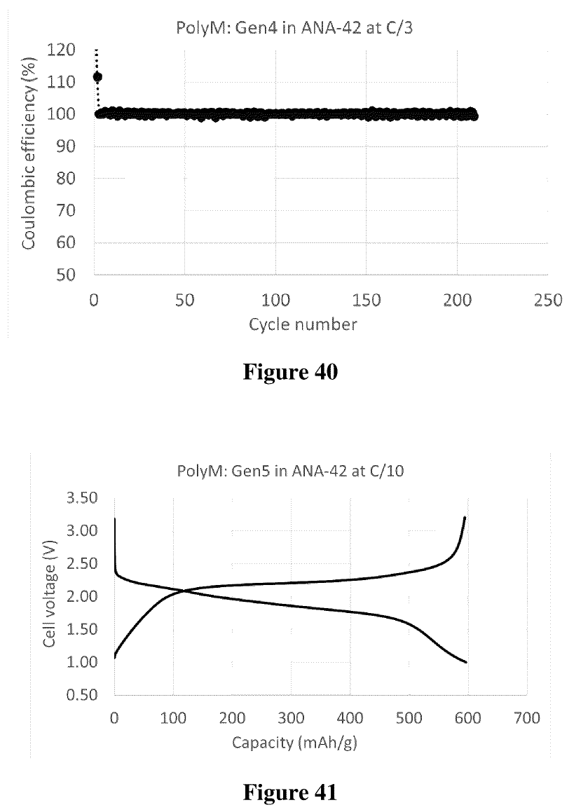

FIG. 39 shows discharge capacity vs. cycle number of Li//Gen4 hybrid polymer mix cell in ANA-42 at C/3. The data shows the remarkable stability of the discharge capacity up to 210 cycles. The coulombic efficiency vs. cycle number was presented in FIG. 40, which shows 100% coulombic efficiency up to 210 cycles.

### Example 42: S-Linked Quinone Polymer: Sulfurized Carbon Matrix Polymer: SP-C65 CMC (8:76:10:6)

In this example, a hybrid mixture of S-linked quinone polymer and sulfurized carbon matrix polymer with weight ratio of 10:90 was used as cathode active material. The combinations weight ratios from 20:80 to 5:95 of S-linked quinone polymer and sulfurized carbon matrix polymer is termed as Gen5 polymer cathode. The Gen5 hybrid cathode was prepared as described in Example 40. The coated foil was then dried at room temperature for overnight and then 100° C. for overnight under vacuum and stored in an argon glovebox with H₂O and O₂ levels<10 ppm. The final composition of the electrode came out as S-linked quinone polymer: sulfurized carbon matrix polymer: SP-C65: CMC (8:76:10:6 wt ratios).

FIG. 41 shows voltage profile (charge and discharge characteristics) of Li//Gen5 hybrid polymer cathode cell in ANA-42 at C/10.

The electrochemical tests were performed using two-electrode CR2032 coin-type cells using lithium chip (thickness 0.02 mm, 1.54 cm²) as anode, and above described Gen5 cathode An 18 mm diameter (2.54 cm²) Celgard 2400 was used as separator. Various electrolyte formulations were tested, but in this example, 80 uL of 1.2M LiFSI in BTFE:TEP (1:3 mol) electrolyte formulation (ANA-42) was found to be given the best cycling data (FIGS. 41, 42 and 43). The cell was cycled at C/10 with the voltage cutoffs of 3.2V to 1.0V. The overall discharge capacity of the cell was found to be 598 mAh/g which is ˜240% higher than the PAQS polymer alone as cathode active material.

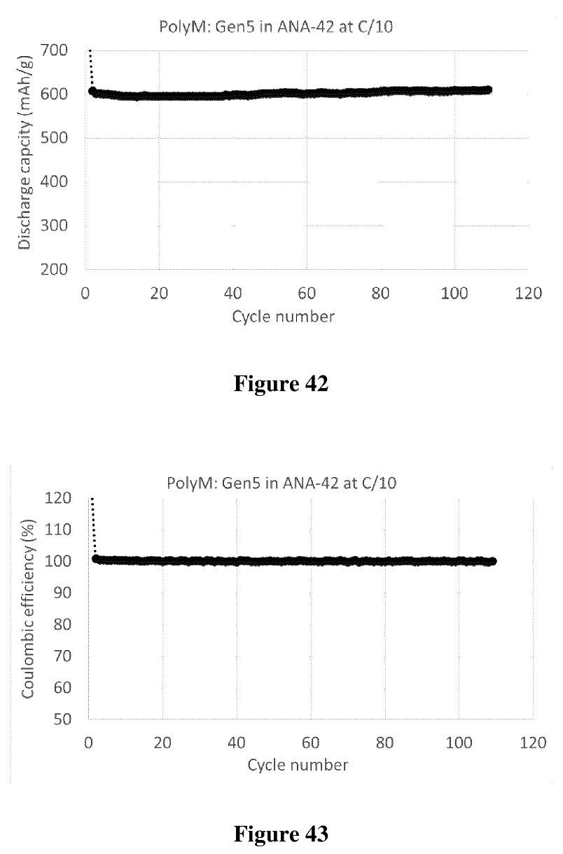

FIG. 42 shows discharge capacity vs. cycle number of Li//Gen5 polymer in ANA-42 at C/10. The data shows the remarkable stability of the discharge capacity up to 110 cycles. The coulombic efficiency vs. cycle number was presented in FIG. 43, which shows 100% coulombic efficiency up to 110 cycles. FIG. 43 shows Coulombic efficiency vs. cycle number of Li//Gen5 cell in ANA-42 at C/10.

### Example 43: PAQS-PBQS Random Copolymer as Cathode Active Material

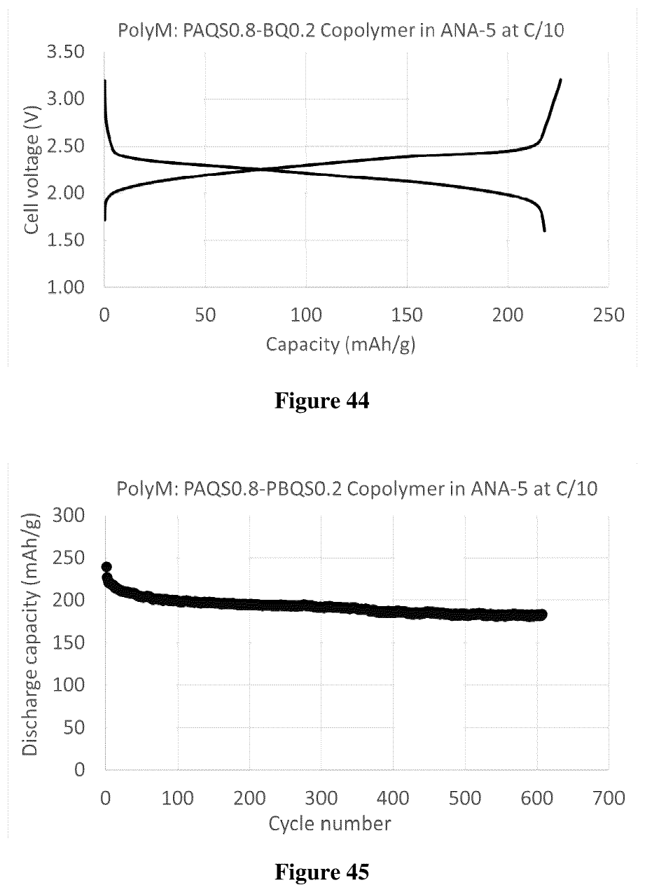

In this example, a random copolymer of PAQS_{0.8}-PBQS_{0.2} was used as cathode active material similar to the active material described in Example 22. The cathode was prepared by first mixing PAQS_{0.8}-PBQS_{0.2} copolymer and SP-C65 carbon by using a mortar and pestle. A 3 wt % solution of PVDF in NMP was added into the mixed powder in a plastic cup. The overall mixture was then placed in a Thinky centrifugal mixer and centrifuged at 2000 rpm for 30 sec for 3 times. The homogenous viscous slurry was coated on to carbon coated aluminum foil using an auto-coater. The coated foil was then dried at 100° C. for overnight under vacuum and stored in an argon glovebox with H₂O and O₂ levels<10 ppm. The final composition of the electrode came out as PAQS_{0.8}-PBQS_{0.2}:SP-C65:PVDF (70:20:10 wt ratios). The electrochemical tests were performed using two-electrode CR2032 coin-type cells using lithium chip (thickness 0.02 mm, 1.54 cm²) as anode, and above described PAQS_{0.8}-PBQS_{0.2}:SP-C65:PVDF (2.5 mg, 1.13 cm²) as cathode. An 18 mm diameter (2.54 cm²) Celgard 2400 was used as separator. Various electrolyte formulations were tested, but in this example, 80 uL of 1M LiTFSI in DME:13DOL (1:1 vol)+100 mM LiNO₃ electrolyte formulation (ANA-5) was found to be given the best cycling data. The cell was cycled at C/10 with the voltage cutoffs of 3.2V to 1.6V. The voltage profile of the cell is presented in FIG. 44. The charge and discharge characteristics and stability at C/10 of the cell is presented in FIG. 45. The overall discharge capacity of the cell was found to be 225 mAh/g, which is >40% higher than the cathode with PAQS polymer alone. The cell was cycled for 608 cycles with no significant capacity decay, as shown in FIG. 45. The higher capacity and remarkable cycling stability were attributed to the better coating with SP-C65 carbon, which has superior conductivity over traditional SP carbon, and LiNO₃ additive in the electrolyte.

FIG. 44 shows a voltage profile (charge and discharge characteristics) of Li//PAQS_{0.8}-PBQS_{0.2} cell in ANA-5 at C/10.

FIG. 45 shows discharge capacity vs cycle number of Li//PAQS_{0.8}-PBQS_{0.2} cell in ANA-5 at C/10. The cell was cycled up to 608 cycles with no significant capacity decay.

In summary, redox active organosulfur polymer and related electrode materials, electrodes, electrode chemical cells, batteries, methods and systems are herein described. In particular, tricyclic compounds having a redox potential of 0.20 V to 3.3 V with reference to Li/Li+ electrode potential under standard conditions. Redox active organosulfur polymer can be used as a cathode for an electrochemical cell containing a Li anode and a non-aqueous electrolytes. Accordingly, redox active organosulfur polymer and related electrode materials, electrodes, electrochemical cells, batteries, methods and systems, can be used to provide in several embodiments, cheap, environmentally friendly, safe and/or high-rate battery that can be a good replacement of current battery for grid storage, and other stationary applications.

In particular, redox active S-linked polymers, sulfurized matrices, and related composites, compositions electrode material, electrodes, as well as related electrode chemical cell battery, methods and systems are described, and related composites, compositions electrode material, wherein the redox active S-linked polymers, sulfurized matrices, have a redox potential of up to 3.5 V with reference to Li/Li+ electrode potential under standard conditions and a capacity of at least 50 mAh/g, possibly up to 300 mAh/g, up to 400 mAh/g, up to 800 mAh/g, or higher are described. More particularly, redox active S-linked polymers, sulfurized matrices, and related composites, and compositions are provided as electrode material of a cathode for an electrochemical cell further containing a Li anode and a non-aqueous electrolyte.

The examples set forth above are provided to give those of ordinary skill in the art a complete disclosure and description of how to make and use the embodiments of the organosulfur polymer, materials, compositions, systems and methods of the disclosure, and are not intended to limit the scope of what the inventors regard as their disclosure. All patents and publications mentioned in the specification are indicative of the levels of skill of those skilled in the art to which the disclosure pertains.

The entire disclosure of each document cited (including patents, patent applications, journal articles including related supplemental and/or supporting information sections, abstracts, laboratory manuals, books, or other disclosures) in the Background, Summary, Detailed Description, and Examples is hereby incorporated herein by reference. All references cited in this disclosure are incorporated by reference to the same extent as if each reference had been incorporated by reference in its entirety individually. However, if any inconsistency arises between a cited reference and the present disclosure, the present disclosure takes precedence.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the disclosure claimed. Thus, it should be understood that although the disclosure has been specifically disclosed by preferred embodiments, exemplary embodiments and optional features, modification and variation of the concepts herein disclosed can be resorted to by those skilled in the art, and that such modifications and variations are considered to be within the scope of this disclosure as defined by the appended claims.

It is also to be understood that the terminology used herein is for the purpose of describing particular embodiments only and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The term “alkyl” as used herein refers to a linear, branched, or cyclic saturated hydrocarbon group typically although not necessarily containing 1 to about 15 carbon atoms, or 1 to about 6 carbon atoms, such as methyl, ethyl, n-propyl, isopropyl, n-butyl, isobutyl, t-butyl, octyl, decyl, and the like, as well as cycloalkyl groups such as cyclopentyl, cyclohexyl and the like. Generally, although again not necessarily, alkyl groups herein contain 1 to about 15 carbon atoms. The term “cycloalkyl” intends a cyclic alkyl group, typically having 4 to 8, or 5 to 7, carbon atoms. The term “substituted alkyl” refers to alkyl substituted with one or more substituent groups, and the terms “heteroatom-containing alkyl” and “heteroalkyl” refer to alkyl in which at least one carbon atom is replaced with a heteroatom. If not otherwise indicated, the terms “alkyl” and “lower alkyl” include linear, branched, cyclic, unsubstituted, substituted, and/or heteroatom-containing alkyl and lower alkyl, respectively.

The term “heteroatom-containing” as in a “heteroatom-containing alky group” refers to an alkyl group in which one or more carbon atoms is replaced with an atom other than carbon, e.g., nitrogen, oxygen, sulfur, phosphorus or silicon, typically nitrogen, oxygen or sulfur. Similarly, the term “heteroalkyl” refers to an alkyl substituent that is heteroatom-containing, the term “heterocyclic” refers to a cyclic substituent that is heteroatom-containing, the terms “heteroaryl” and “heteroaromatic” respectively refer to “aryl” and “aromatic” substituents that are heteroatom-containing, and the like. It should be noted that a “heterocyclic” group or compound may or may not be aromatic, and further that “heterocycles” may be monocyclic, bicyclic, or polycyclic as described above with respect to the term “aryl.” Examples of heteroalkyl groups include alkoxyaryl, alkylsulfanyl-substituted alkyl, N-alkylated amino alkyl, and the like. Examples of heteroaryl substituents include pyrrolyl, pyrrolidinyl, pyridinyl, quinolinyl, indolyl, pyrimidinyl, imidazolyl, 1,2,4-triazolyl, tetrazolyl, etc., and examples of heteroatom-containing alicyclic groups are pyrrolidino, morpholino, piperazino, piperidino, and additional substituents identifiable by a skilled person.

The term “alkoxy” as used herein intends an alkyl group bound through a single, terminal ether linkage; that is, an “alkoxy” group may be represented as —O-alkyl where alkyl is as defined above. A “lower alkoxy” group intends an alkoxy group containing 1 to 6 carbon atoms. Analogously, “alkenyloxy” and “lower alkenyloxy” respectively refer to an alkenyl and lower alkenyl group bound through a single, terminal ether linkage, and “alkynyloxy” and “lower alkynyloxy” respectively refer to an alkynyl and lower alkynyl group bound through a single, terminal ether linkage.

The term “aryl” as used herein, and unless otherwise specified, refers to an aromatic substituent containing a single aromatic ring or multiple aromatic rings that are fused together, directly linked, or indirectly linked (such that the different aromatic rings are bound to a common group such as a methylene or ethylene moiety). Aryl groups can contain 5 to 24 carbon atoms, or aryl groups contain 5 to 14 carbon atoms. Exemplary aryl groups contain one aromatic ring or two fused or linked aromatic rings, e.g., phenyl, naphthyl, biphenyl, diphenylether, diphenylamine, benzophenone, and the like. “Substituted aryl” refers to an aryl moiety substituted with one or more substituent groups, and the terms “heteroatom-containing aryl” and “heteroaryl” refer to aryl substituents in which at least one carbon atom is replaced with a heteroatom, as will be described in further detail infra.

The terms “cyclic”, “cyclo-”, and “ring” refer to alicyclic or aromatic groups that may or may not be substituted and/or heteroatom containing, and that may be monocyclic, bicyclic, or polycyclic. The term “alicyclic” is used in the conventional sense to refer to an aliphatic cyclic moiety, as opposed to an aromatic cyclic moiety, and may be monocyclic, bicyclic or polycyclic.

The term “isomers” as used refers to heterocyclic aromatic groups that have the same core molecular but may differ in atomic connectivity and/or location of unsaturation and is meant to include all possible structural variants. For example, as shown below, “pyrrole isomers” refers to all possible substituted variants of 1H-pyrrole and 2H-pyrrole; “indole isomers” refers to all possible substituted variants of 3H-indole, 1H-indole and 2H-isoindole, and so on:

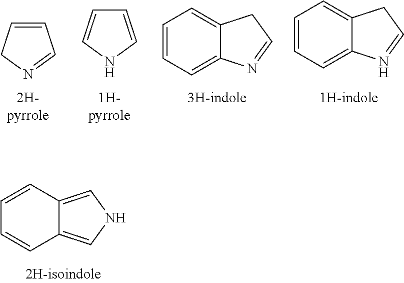

Likewise, as shown below, “triazole isomers” refers to all possible substituted variants of 1,2,4-triazole and 1,2,3-triazole; “oxadiazole isomers” refers to all possible substituted variants of 1,2,5-oxadiazole and 1,2,3-oxadiazole, and so on:

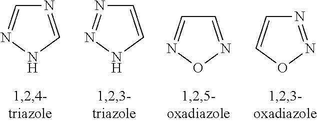

The terms “halo”, “halogen”, and “halide” are used in the conventional sense to refer to a chloro, bromo, fluoro or iodo substituent or ligand.

The term alkylene as used herein refers to an alkanediyl group which is a divalent saturated aliphatic group, with two carbon atoms as points of attachment, a linear or branched, cyclo, cyclic or acyclic structure. Exemplary alkylene includes propane-1,2-diyl group (—CH(CH3)CH2-) or propane-1,3-diyl group (—CH2CH2CH2-).

The term alkenylene refers to an alkenediyl group which is a divalent unsaturated aliphatic group, with two carbon atoms as points of attachment, a linear or branched, cyclo, cyclic or acyclic structure, at least one nonaromatic carbon-carbon double bond. Exemplary alkylene includes 2-butene-1,4-diyl group (—CH2CH═CHCH2-).

The term alkynylene refers to an alkynediyl group which is a divalent unsaturated aliphatic group, with two carbon atoms as points of attachment, a linear or branched, cyclo, cyclic or acyclic structure, at least one nonaromatic carbon-carbon triple bond. Exemplary alkylene includes 2-butyne-1,4-diyl group (—CH2CCCH2-).

The term “substituted” as in “substituted alkyl,” “substituted aryl,” and the like, is meant that in the alkyl, aryl, or other moiety, at least one hydrogen atom bound to a carbon (or other) atom is replaced with one or more non-hydrogen substituents.

Examples of such substituents include, without limitation: functional groups such as halo, hydroxyl, sulfhydryl, C1-C24 alkoxy, C2-C24 alkenyloxy, C2-C24 alkynyloxy, C5-C24 aryloxy, C6-C24 aralkyloxy, C6-C24 alkaryloxy, acyl (including C2-C24 alkylcarbonyl (—CO-alkyl) and C6-C24 arylcarbonyl (—CO-aryl)), acyloxy (—O-acyl, including C2-C24 alkylcarbonyloxy (—O—CO-alkyl) and C6-C24 arylcarbonyloxy (—O—CO-aryl)), C2-C24 alkoxycarbonyl (—(CO)—O-alkyl), C6-C24 aryloxycarbonyl (—(CO)—O-aryl), halocarbonyl (—CO)—X where X is halo), C2-C24 alkylcarbonato (—O—(CO)—O-alkyl), C6-C24 arylcarbonato (—O—(CO)—O-aryl), carboxy (—COOH), carboxylato (COO⁻), carbamoyl (—(CO)—NH2), mono-(C1-C24 alkyl)-substituted carbamoyl (—(CO)—NH(C1-C24 alkyl)), di-(C1-C24 alkyl)-substituted carbamoyl (—(CO)—N(C1-C24 alkyl)2), mono-(C5-C24 aryl)-substituted carbamoyl (—(CO)—NH-aryl), di-(C5-C24 aryl)-substituted carbamoyl (—(CO)—N(C5-C24 aryl)2), di-N—(C1-C24 alkyl),N—(C5-C24 aryl)- substituted carbamoyl, thiocarbamoyl (—(CS)—NH2), mono-(C1-C24 alkyl)-substituted thiocarbamoyl (—(CO)—NH(C1-C24 alkyl)), di-(C1-C24 alkyl)-substituted thiocarbamoyl (—(CO)—N(C1-C24 alkyl)2), mono-(C5-C24 aryl)- substituted thiocarbamoyl (—(CO)—NH-aryl), di-(C5-C24 aryl)-substituted thiocarbamoyl (—(CO)—N(C5-C24 aryl)2), di-N—(C1-C24 alkyl),N—(C5-C24 aryl)-substituted thiocarbamoyl, carbamido (—NH—(CO)—NH2), cyano(—C≡N), cyanato (—O—C ≡N), thiocyanato (—S—C≡N), formyl (—(CO)—H), thioformyl ((CS)—H), amino (—NH2), mono-(C1-C24 alkyl)-substituted amino, di-(C1-C24 alkyl)-substituted amino, mono-(C5-C24 aryl)-substituted amino, di-(C5-C24 aryl)-substituted amino, C2-C24 alkylamido (NH—(CO)-alkyl), C6-C24 arylamido (—NH—(CO)-aryl), imino (—CR═NH where R=hydrogen, C1-C24 alkyl, C5-C24 aryl, C6-C24 alkaryl, C6-C24 aralkyl, etc.), C2-C20 alkylimino (CR═N(alkyl), where R=hydrogen, C1-C24 alkyl, C5-C24 aryl, C6-C24 alkaryl, C6-C24 aralkyl, etc.), arylimino (—CR═N(aryl), where R=hydrogen, C1-C20 alkyl, C5-C24 aryl, C6-C24 alkaryl, C6-C24 aralkyl, etc.), nitro (—NO2), nitroso (—NO), sulfo (—SO2-OH), sulfonato (—SO2-O⁻), C1-C24 alkylsulfanyl (—S-alkyl; also termed “alkylthio”), C5-C24 arylsulfanyl (—S-aryl; also termed “arylthio”), C1-C24 alkylsulfinyl ((SO)-alkyl), C5-C24 arylsulfinyl (—(SO)-aryl), C1-C24 alkylsulfonyl (—SO2-alkyl), C5-C24 arylsulfonyl (—SO2-aryl), boryl (—BH2), borono (—B(OH)2), boronato (—B(OR)2 where R is alkyl or other hydrocarbyl), phosphono (—P(O)(OH)2), phosphonato (—P(O)(O⁻)2), phosphinato (—P(O)(O⁻)), phospho (—PO2), phosphino (—PH2), silyl (—SiR3 wherein R is hydrogen or hydrocarbyl), and silyloxy (—O-silyl); and the hydrocarbyl moieties C1-C24 alkyl (e.g. C1-C12 alkyl and C1-C6 alkyl), C2-C24 alkenyl (e.g. C2-C12 alkenyl and C2-C6 alkenyl), C2-C24 alkynyl (e.g. C2-C12 alkynyl and C2-C6 alkynyl), C5-C24 aryl (e.g. C5-C14 aryl), C6-C24 alkaryl (e.g. C6-C16 alkaryl), and C6-C24 aralkyl (e.g. C6-C16 aralkyl).

The term “acyl” refers to substituents having the formula —(CO)-alkyl, —(CO)-aryl, or —(CO)-aralkyl, and the term “acyloxy” refers to substituents having the formula —O(CO)— alkyl, —O(CO)-aryl, or —O(CO)-aralkyl, wherein “alkyl,” “aryl, and “aralkyl” are as defined above.

The term “alkaryl” refers to an aryl group with an alkyl substituent, and the term “aralkyl” refers to an alkyl group with an aryl substituent, wherein “aryl” and “alkyl” are as defined above. In some embodiments, alkaryl and aralkyl groups contain 6 to 24 carbon atoms, and particularly alkaryl and aralkyl groups contain 6 to 16 carbon atoms. Alkaryl groups include, for example, p-methylphenyl, 2,4-dimethylphenyl, p-cyclohexylphenyl, 2,7-dimethylnaphthyl, 7-cyclooctylnaphthyl, 3-ethyl-cyclopenta-1,4-diene, and the like. Examples of aralkyl groups include, without limitation, benzyl, 2-phenyl-ethyl, 3-phenyl-propyl, 4-phenyl-butyl, 5-phenyl-pentyl, 4-phenylcyclohexyl, 4-benzylcyclohexyl, 4-phenylcyclohexylmethyl, 4-benzylcyclohexylmethyl, and the like. The terms “alkaryloxy” and “aralkyloxy” refer to substituents of the formula —OR wherein R is alkaryl or aralkyl, respectively, as just defined.

The term “Periodic Table” refers to the version of IUPAC Periodic Table of the Elements dated Nov. 28, 2016 [12].

When a Markush group or other grouping is used herein, all individual members of the group and all combinations and possible subcombinations of the group are intended to be individually included in the disclosure. Every combination of components or materials described or exemplified herein can be used to practice the disclosure, unless otherwise stated. One of ordinary skill in the art will appreciate that methods, device elements, and materials other than those specifically exemplified can be employed in the practice of the disclosure without resort to undue experimentation. All art-known functional equivalents, of any such methods, device elements, and materials are intended to be included in this disclosure. Whenever a range is given in the specification, for example, a temperature range, a frequency range, a time range, or a composition range, all intermediate ranges and all subranges, as well as, all individual values included in the ranges given are intended to be included in the disclosure. Any one or more individual members of a range or group disclosed herein can be excluded from a claim of this disclosure. The disclosure illustratively described herein suitably can be practiced in the absence of any element or elements, limitation or limitations, which is not specifically disclosed herein.

“Optional” or “optionally” means that the subsequently described circumstance may or may not occur, so that the description includes instances where the circumstance occurs and instances where it does not according to the guidance provided in the present disclosure. For example, the phrase “optionally substituted” means that a non-hydrogen substituent may or may not be present on a given atom, and, thus, the description includes structures wherein a non-hydrogen substituent is present and structures wherein a non-hydrogen substituent is not present. It will be appreciated that the phrase “optionally substituted” is used interchangeably with the phrase “substituted or unsubstituted.” Unless otherwise indicated, an optionally substituted group may have a substituent at each substitutable position of the group, and when more than one position in any given structure may be substituted with more than one substituent selected from a specified group, the substituent may be either the same or different at every position. Combinations of substituents envisioned can be identified in view of the desired features of the compound in view of the present disclosure, and in view of the features that result in the formation of stable or chemically feasible compounds. The term “stable”, as used herein, refers to compounds that are not substantially altered when subjected to conditions to allow for their production, detection, and, in certain embodiments, their recovery, purification, and use for one or more of the purposes disclosed herein.

A number of embodiments of the disclosure have been described. The specific embodiments provided herein are examples of useful embodiments of the disclosure and it will be apparent to one skilled in the art that the disclosure can be carried out using a large number of variations of the devices, device components, methods steps set forth in the present description. As will be obvious to one of skill in the art, methods and devices useful for the present methods can include a large number of optional composition and processing elements and steps.

In summary, in several embodiments, described herein are organosilicon compound, related complex that allow performance of fluorocarbon compound or olefin-based reactions and in particular polymerization of olefins to produce polyolefin polymers, and related methods and systems are described.

In particular, it will be understood that various modifications may be made without departing from the spirit and scope of the present disclosure. Accordingly, other embodiments are within the scope of the following claims.

### REFERENCES

1. IUPAC, Compendium of chemical terminology (the “Gold Book”). 2nd ed. 1997: Blackwell Science Oxford.
2. Goldbook, I. quinones. 2014; Available from: https://goldbook.iupac.org/terms/view/Q05015.
3. Patai, S. and Z. Rappoport, The Quinonoid Compounds vol 1. 1988, John Wiley & Sons Ltd., Hoboken.
4. Patai, S. and Z. Rappoport, The Quinonoid Compounds, vol 2. 1988, John Wiley & Sons Ltd., Hoboken.
5. Wikipedia-Quinone. Quinone 2022; Available from: https://en.wikipedia.org/wiki/Quinone.
6. Wang, J., et al., A novel conductive polymer-sulfur composite cathode material for rechargeable lithium batteries. Advanced materials, 2002. 14(13-14): p. 963-965.
7. Ahmed, M. S., et al., Multiscale understanding of covalently fixed sulfur-polyacrylonitrile composite as advanced cathode for metal-sulfur batteries. Advanced Science, 2021. 8(21): p. 2101123.
8. Shadike, Z., et al., Review on organosulfur materials for rechargeable lithium batteries. Materials Horizons, 2021. 8(2): p. 471-500.
9. Pan, Z., et al., Progress and perspectives of organosulfur for lithium-sulfur batteries. Advanced Energy Materials, 2022. 12(8): p. 2103483.
10. Zhang, S.S., Understanding of sulfurized polyacrylonitrile for superior performance lithium/sulfur battery. Energies, 2014. 7(7): p. 4588-4600.
11. Yu, X.-g., et al., Lithium storage in conductive sulfur-containing polymers. Journal of Electroanalytical Chemistry, 2004. 573(1): p. 121-128.
12. IUPAC. Periodic Table. 2016; Available from: iupac.org/wp-content/uploads/2015/07/IUPACPeriodicTable-28Nov16.pdf.

1. A S-linked quinone homopolymer represented by Formula (I)
-[M-Sₚ]-ₘ (I)
in which
M is a redox active monomeric quinone moiety having a redox potential of 0.5 V to 3.5 V with reference to Li/Li+ electrode potential under standard conditions,
p refers to the number of sulfur atom linking the redox active a monomeric quinone moiety M, p ranges from 1 to 5,
Sₚ is a sulfide when p is 1 or polysulfide when p is from 2 to 5,
m ranges from 5 to 10,000,
wherein the S-linked quinone polymer has a weight average molecular weight of at least 1,000 Dalton or a weight averaged MW ranging from 2000 to 2,000,000 Daltons, from 10,000 to 1,500,000 Daltons, from 100,000 to 1,000,000 Daltons, and a solubility in tetrahydrofuran (THF) of equal or less than 1.0 microgram per mL at 21° C. at 1 atm.

2. The S-linked quinone homopolymer of claim 1 wherein the redox active monomeric quinone moiety comprises a structure represented by Formula (III): 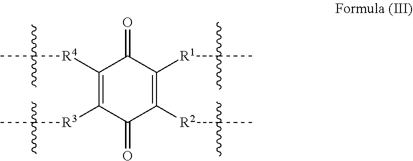
wherein R¹, R², R³, and R⁴ are each independently null, H, Sₚ wherein p ranges from 1 to 5, F, Cl, Br, I, CF3, a linear or branched, substituted or unsubstituted C1-C4 aliphatic group, an aromatic, heteroaromatic, non-aromatic cycle, or non-aromatic heterocycle containing substituent containing 4-12 carbon atoms and 0-4 heteroatoms, wherein heteroatoms are selected from O, N, and S, R¹ and R² together and/or R³, and R⁴ together are part of an aromatic or aliphatic cyclic structure,
wherein dash line [symbol] represents null or a single bond to quinone ring carbon when associated R¹, R², R³, or R⁴ is null.

3. The S-linked quinone homopolymer of claim 2 wherein the redox active monomeric quinone moiety is S-linked wherein the S-linked redox active monomeric quinone is represented by Formula (IIIA) and Formula (IIIB)

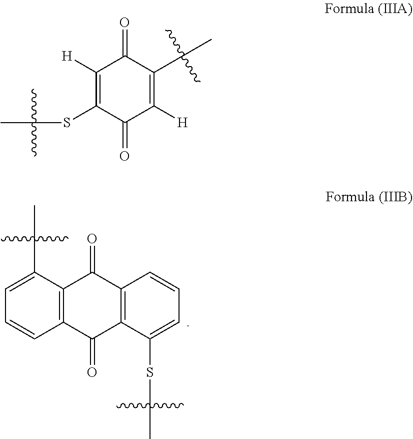 [SMILES: *SC1=CC(=O)C(*)=CC1=O ; *Sc1cccc2c1C(=O)c1cccc(*)c1C2=O]

4. The S-linked quinone homopolymer of claim 1 wherein the redox active monomeric quinone moiety comprises a structure represented by represented by Formula (IV): 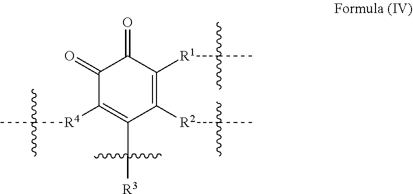
wherein R¹, R², R³, and R⁴ are each independently null, H, Sp wherein p ranges from 1 to 5, F, Cl, Br, I, CF3, a linear or branched, substituted or unsubstituted C1-C4 aliphatic group, an aromatic, heteroaromatic, non-aromatic cycle, or non-aromatic heterocycle containing substituent containing 4-12 carbon atoms and 0-4 heteroatoms, wherein heteroatoms are selected from O, N, and S, R¹ and R² together and/or R³, and R⁴ together are part of an aromatic or aliphatic cyclic structure,
wherein dash line [symbol] represents null or a single bond to quinone ring carbon when associated R¹, R², R³, or R⁴ is null.

5. The S-linked quinone homopolymer of claim 4 wherein the redox active monomeric quinone moiety is S-linked wherein the S-linked redox active monomeric quinone is represented by any one of S-linked monomeric moiety of Formula (IVA), Formula (IVB), or Formula (IVC)

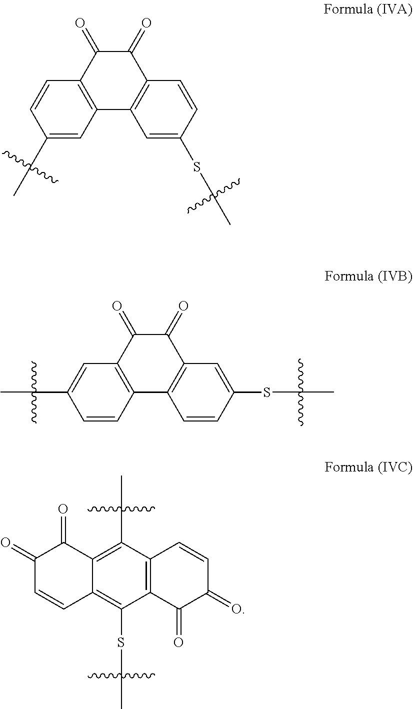 [SMILES: *Sc1ccc2c(c1)-c1cc(*)ccc1C(=O)C2=O ; *Sc1ccc2c(c1)C(=O)C(=O)c1cc(*)ccc1-2 ; *Sc1c2ccc(=O)c(=O)c2c(*)c2ccc(=O)c(=O)c12]

6. A S-linked quinone copolymer represented Formula (II)
-[M1-Sₚ₁]ₘ₁-co-[M2-Sₚ₂]-ₘ₂ (II)
in which
M1 and M2 are each a redox active monomeric quinone moiety comprising a redox potential of 0.5 V to 3.5 V with reference to Li/Li+ electrode potential under standard conditions,
p1 and p2 each independently refer to a number of sulfur atom linking the redox active monomeric quinone moiety M1 and monomeric quinone moiety M2 respectively, p1 and p2 each independently range from 1 to 5,
Sₚ₁ is a sulfide when p1 is 1 or polysulfide when p1 is from 2 to 5,
Sₚ₂ is a sulfide when p2 is 1 or polysulfide when p2 is from 2 to 5,
m1 and m2 each independently range from 5 to 5,000, optionally a ratio of m1 to m2 ranges from 1:50 to 1:1, 1:20 to 1:2, 1:6 to 1:3, or 1:5 to 1:4,
wherein the S-linked quinone copolymer of Formula (II) has a weight average molecular weight ranging from 1,000 Dalton to 2,000,000 Dalton, or a weight averaged MW ranging from 2000 to 2,000,000 Daltons, from 10,000 to 1,500,000 Daltons, from 100,000 to 1,000,000 Daltons, and a solubility in tetrahydrofuran (THF) of equal or less than 1.0 microgram per mL at 21° C. at 1 atm.

7. The S-linked quinone copolymer of claim 6 wherein redox active monomeric quinone moiety M1 and monomeric quinone moiety M2 are arranged in a random copolymer, block copolymer or alternate copolymer.

8. The S-linked quinone copolymer of claim 7 wherein the redox active monomeric quinone moiety M1 and the redox active monomeric quinone moiety M2 are arranged in a random copolymer.

9. The S-linked quinone copolymer of claim 6 wherein the redox active monomeric quinone moiety M1 and the redox active monomeric quinone moiety M2 are independently represented by any one of Formula (III) and Formula (IV): 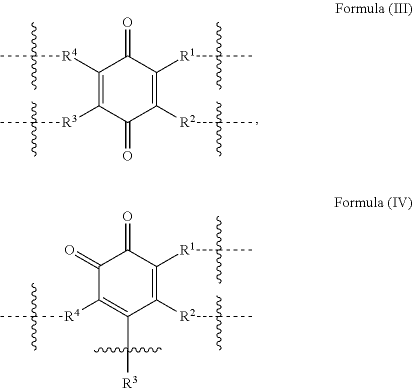
wherein R¹, R², R³, and R⁴ of Formula (III) and Formula (IV) are each independently null, H, Sₚ wherein p ranges from 1 to 5, F, Cl, Br, I, CF3, a linear or branched, substituted or unsubstituted C1-C4 aliphatic group, an aromatic, heteroaromatic, non-aromatic cycle, or non-aromatic heterocycle containing substituent containing 4-12 carbon atoms and 0-4 heteroatoms, wherein heteroatoms are selected from O, N, and S, R¹ and R² together and/or R³, and R⁴ together are part of an aromatic or aliphatic cyclic structure,
wherein dash line [symbol] represents null or a single bond to quinone ring carbon when associated R¹, R², R³, or R⁴ is null.

10. The S-linked quinone copolymer of claim 9 wherein the redox active monomeric quinone moiety M1 and the redox active monomeric quinone moiety M2 are S-linked, wherein the S-linked redox active monomeric quinone moiety M1 and S-linked redox active monomeric quinone moiety M2 are independently selected from any one of S-linked monomeric moiety of Formula (IIIA), Formula (IIIB), Formula (IVA), Formula (IVB), and Formula (IVC)

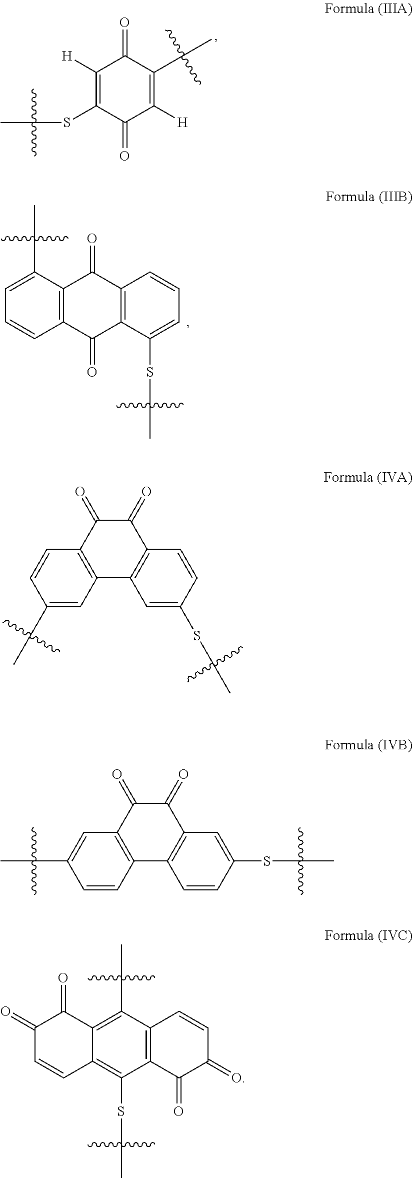 [SMILES: *SC1=CC(=O)C(*)=CC1=O ; *Sc1cccc2c1C(=O)c1cccc(*)c1C2=O ; *Sc1ccc2c(c1)-c1cc(*)ccc1C(=O)C2=O ; *Sc1ccc2c(c1)C(=O)C(=O)c1cc(*)ccc1-2 ; *Sc1c2ccc(=O)c(=O)c2c(*)c2ccc(=O)c(=O)c12]

11. The S-linked quinone copolymer of claim 10 wherein the S-linked redox active monomeric quinone moiety M1 is represented by Formula (IIIA), 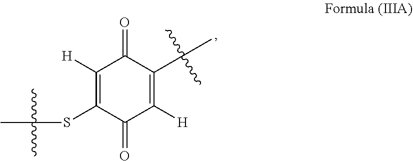 [SMILES: *SC1=CC(=O)C(*)=CC1=O]
and S-linked redox active monomeric quinone moiety M2 is represented by any one of S-linked monomeric moieties of Formula (IIIB), Formula (IVA), Formula (IVB), and Formula (IVC), 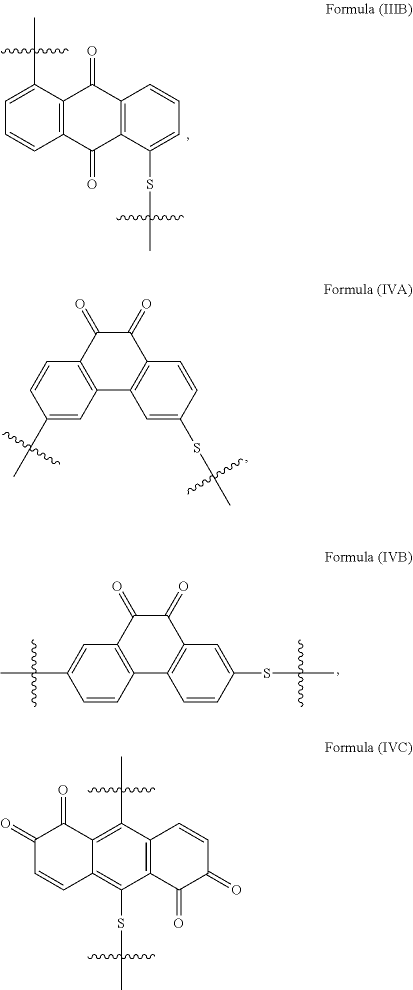 [SMILES: *Sc1cccc2c1C(=O)c1cccc(*)c1C2=O ; *Sc1ccc2c(c1)-c1cc(*)ccc1C(=O)C2=O ; *Sc1ccc2c(c1)C(=O)C(=O)c1cc(*)ccc1-2 ; *Sc1c2ccc(=O)c(=O)c2c(*)c2ccc(=O)c(=O)c12]
wherein a molar ratio of S-linked monomeric moiety of Formula (IIIA) to any one of S-linked monomeric moieties of Formula (IIIB), Formula (IVA), Formula (IVB), and Formula (IVC) ranges from 1:50 to 1:1, 1:20 to 1:2, 1:6 to 1:3, or 1:5 to 1:4.

12. The S-linked quinone copolymer of claim 11 wherein a molar ratio of S-linked monomeric moiety M1 of Formula (IIIA) to S-linked monomeric moiety M2 of Formula (IIIB), Formula (IVA), Formula (IVB), or Formula (IVC) is 1:4.

13. The S-linked quinone copolymer of claim 11 wherein the S-linked redox active monomeric quinone moiety M2 of Formula (II) is represented Formula (IIIB)

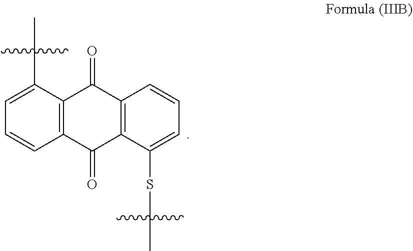 [SMILES: *Sc1cccc2c1C(=O)c1cccc(*)c1C2=O]

14. The S-linked quinone copolymer of claim 13 wherein a molar ratio of the S-linked monomeric moiety of Formula (IIIA) to the S-linked monomeric moiety Formula (IIIB) can be 1:4.

15. A sulfurized carbon matrix represented by Formula (V), wherein Q is a bonded sp2 carbon atom (C) or a nitrogen (N), wherein [symbol] represents a single or double bond, Sₚ represents a polysulfide and p ranges from 2 to 8, wherein the sulfurized carbon matrix has a weight averaged MW ranging from 2000 to 2,000,000 Daltons, or a weight averaged MW ranging from 2000 to 2,000,000 Daltons, from 10,000 to 1,500,000 Daltons, from 100,000 to 1,000,000 Daltons, 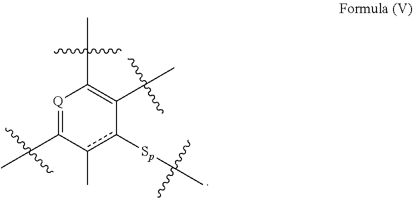
wherein the sulfurized carbon matrix has a sulfur content based on total weight of the sulfurized carbon matrix equal to or greater than 5 wt % and less than 20 wt %, equal to or greater than 20 wt % and less than 40 wt %, equal to or greater than 40 wt % less than 60 wt %, equal to or greater than 60 wt % less than 70 wt %, equal to or greater than 70 wt % less than 80 wt %.

16. The sulfurized carbon matrix of claim 15 wherein the sulfurized carbon matrix of the Formula (V) can be selected from any one of sulfurized SPAN (11), covalent trizaine frameworks (S-CTF-1) (12), covalent trizaine frameworks (S-CTF-1) (13), poly(sulfur random-1,3-diisopropylbenzene) (poly(S-r-DIB) (14), S-BOP (15), carbon/polymeric sulfur (C/PS) composite (16), covalently grafted polysulfur graphene nanocomposite (PolySGN, 17), and Graphene-supported crosslinked sulfur copolymer nanoparticles, cp(S-TTCA)@rGO-80 (18) or any combination thereof.

17. A redox active composition is comprising at least one S-linked quinone homopolymer of claim 1, and one or more sulfurized carbon matrix represented by Formula (V), wherein Q is a bonded sp2 carbon atom (C) or a nitrogen (N), wherein [symbol] represents a single or double bond, Sₚ represents a polysulfide and p ranges from 2 to 8, wherein the sulfurized carbon matrix has a weight averaged MW ranging from 2000 to 2,000,000 Daltons, or a weight averaged MW ranging from 2000 to 2,000,000 Daltons, from 10,000 to 1,500,000 Daltons, from 100,000 to 1,000,000 Daltons, 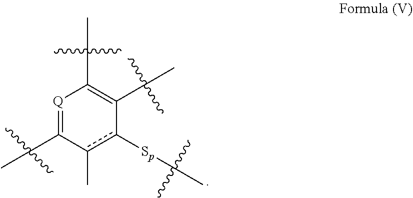
wherein the sulfurized carbon matrix has a sulfur content based on total weight of the sulfurized carbon matrix equal to or greater than 5 wt % and less than 20 wt %, equal to or greater than 20 wt % and less than 40 wt %, equal to or greater than 40 wt % less than 60 wt %, equal to or greater than 60 wt % less than 70 wt %, equal to or greater than 70 wt % less than 80 wt %, optionally together with an additive.

18. A redox active composite is comprising at least one of S-linked quinone homopolymer of claim 1, and at least one of sulfurized carbon matrix of claim 15, and/or a composition of claim 17.

19. A redox active composite comprising at least one S-linked quinone polymer selected from S-linked quinone homopolymer of claim 1, together with one or more of sulfurized carbon matrix represented by Formula (V), wherein Q is a bonded sp2 carbon atom (C) or a nitrogen (N), wherein [symbol] represents a single or double bond, Sₚ represents a polysulfide and p ranges from 2 to 8, wherein the sulfurized carbon matrix has a weight averaged MW ranging from 2000 to 2,000,000 Daltons, or a weight averaged MW ranging from 2000 to 2,000,000 Daltons, from 10,000 to 1,500,000 Daltons, from 100,000 to 1,000,000 Daltons, 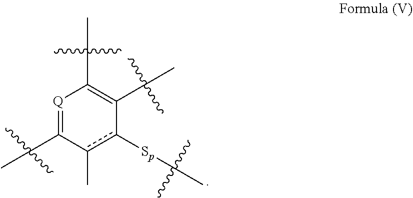
wherein the sulfurized carbon matrix has a sulfur content based on total weight of the sulfurized carbon matrix equal to or greater than 5 wt % and less than 20 wt %, equal to or greater than 20 wt % and less than 40 wt %, equal to or greater than 40 wt % less than 60 wt %, equal to or greater than 60 wt % less than 70 wt %, equal to or greater than 70 wt % less than 80 wt %,
wherein a weight ratio of the S-linked quinone polymer and the sulfurized carbon matrix ranges from 20:1 to 1:20, 10:1 to 1:10, 9:1 to 3:2, or 6:1 to 2:1 or is 1:1.

20. The redox active composite of claim 19 wherein the S-linked quinone homopolymer is selected from the group comprising 2,5-S-linked-polyanthraquinone (PAQS), 3,6-S-linked-polyphenanthrequinone (36PPAQS), 2,7-S -linked-polyphenanthrequinone (27PPAQS), and 9,10-S-linked-1,2,5,6-polyanthracenetetraone (PAQT).

21. The redox active composite of claim 20, wherein the sulfurized carbon matrix is SPAN.

22. The redox active composite of claim 19 further comprising an additive such as a binder, and a conductive additive, wherein the binder can optionally be selected from one of poly(vinylidene-fluoride), poly(tetrafluoroethylene), sodium carboxymethylcellulose, lithium carboxymethylcellulose, styrene-butadiene rubber, polyacrylic acid (PAA), polyvinyl alcohol (PVA), polyethylene glycol (PEG), polyethylene oxide (PEO), polyamide imide (PAI), or any combination thereof, wherein the conductive additive is selected from one of graphite, carbon black, acetylene black, Super-P carbon, nickel powder, various Super-P carbons and KB or any combination thereof.

23. The redox active composite of claim 22 wherein the additive comprises a binder, wherein the binder is present in 1 to 20% by weight of the redox active composite, and the conductive additive is present in 5 to 70% by weight of the redox active composite.

24. A cathode material comprising a redox active composition of claim 17.

25. The cathode material of claim 24, wherein a weight ratio of the S-linked quinone polymer to the sulfurized carbon matrix ranges from 20:1 to 1:20, 10:1 to 1:10, 9:1 to 3:2, or 6:l to 2:l or is 1:1.

26. A method to provide a cathode material, the method comprises combining at least one S-linked quinone polymer of claim 1, at least one sulfurized carbon matrix represented by Formula (V), wherein Q is a bonded sp2 carbon atom (C) or a nitrogen (N), wherein [symbol] represents a single or double bond, Sₚ represents a polysulfide and p ranges from 2 to 8, wherein the sulfurized carbon matrix has a weight averaged MW ranging from 2000 to 2,000,000 Daltons, or a weight averaged MW ranging from 2000 to 2,000,000 Daltons, from 10,000 to 1,500,000 Daltons, from 100,000 to 1,000,000 Daltons, 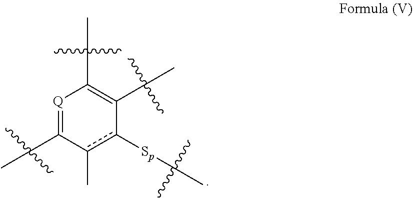
wherein the sulfurized carbon matrix has a sulfur content based on total weight of the sulfurized carbon matrix equal to or greater than 5 wt % and less than 20 wt %, equal to or greater than 20 wt % and less than 40 wt %, equal to or greater than 40 wt % less than 60 wt %, equal to or greater than 60 wt % less than 70 wt %, equal to or greater than 70 wt % less than 80 wt %,
optionally together with a conductive additive to provide a redox composition and/or a redox composite configured to enable contact with a non-aqueous electrolyte or an aqueous electrolyte of an electrochemical cells.

27. The method of claim 25 wherein the at least one S-linked quinone polymer and the at least one sulfurized carbon matrix are mixed homogeneously.

28. The method of claim 26, wherein the at least one S-linked quinone polymer and the at least one sulfurized carbon matrix can be combined in any configuration allowing electrical connection between the at least one S-linked quinone polymer and the at least one sulfurized carbon matrix the configuration further enabling contact with a non-aqueous electrolyte when the cathode material is included in an electrochemical cell.

29. The method of claim 26, wherein the combining is performed to provide a cathode material herein described in which a weight ratio of the S-linked quinone polymer to the sulfurized carbon matrix ranges from 20:1 to 1:20, 10:1 to 1:10, 9:1 to 3:2, or 6:1 to 2:1 or is 1:1.

30. A cathode material, obtained by the method of claim 26.

31. A system to provide a cathode material are described comprises at least one of an S-linked quinone homopolymer of claim 1, at least one sulfurized carbon matrix of claim 15 optionally together with an additive for combined use in the to provide a cathode material.

32. A method for making a S-linked quinone homopolymer, the method comprising
providing a redox active monomeric quinone monomer X₁-M-X₂, wherein X₁ and X₂ presents a leaving group,
providing a source of sulfide Sp,
contacting the redox active monomeric quinone monomer X₁-M-X₂ with the source of sulfide Sp under suitable conditions and for sufficient period of time to provide the S-linked quinone polymer represented by Formula (I)
-[M-Sₚ]-ₘ (I)
in which
M is a redox active monomeric quinone moiety having a redox potential of 0.5 V to 3.5 V with reference to Li/Li+ electrode potential under standard conditions,
p refers to the number of sulfur atom linking the redox active a monomeric quinone moiety M, p ranges from 1 to 5,
Sₚ is a sulfide when p is 1 or polysulfide when p is from 2 to 5,
m ranges from 5 to 10,000,
wherein the S-linked quinone polymer has a weight average molecular weight of at least 1,000 Dalton or a weight averaged MW ranging from 2000 to 2,000,000 Daltons, from 10,000 to 1,500,000 Daltons, from 100,000 to 1,000,000 Daltons, and a solubility in tetrahydrofuran (THF) of equal or less than 1.0 microgram per mL at 21° C. at 1 atm.

33. An S-linked quinone homopolymer obtained by the method of claim 32.

34. A method for making a S-linked quinone copolymer, the method comprising
providing a redox active monomeric quinone monomer X₁-M1-X₂, and a redox active monomeric quinone monomer X₁-M2-X₂ wherein X₁ and X₂ presents a leaving group,
providing a source of sulfide Sₚ₁ and Sₚ₂,
contacting the redox active monomeric quinone monomer X₁-M1-X₂ and redox active monomeric quinone monomer X₁-M2-X₂ with the source of sulfide Sₚ₁ and Sₚ₂ under suitable conditions and for sufficient period of time to provide the S-linked quinone copolymer represented by Formula (II)
-[M1-Sₚ₁]ₘ₁-co-[M2-Sₚ₂]-ₘ₂ (II)
in which
M1 and M2 are each a redox active monomeric quinone moiety comprising a redox potential of 0.5 V to 3.5 V with reference to Li/Li+ electrode potential under standard conditions,
p1 and p2 each independently refer to a number of sulfur atom linking the redox active monomeric quinone moiety M1 and monomeric quinone moiety M2 respectively, p1 and p2 each independently range from 1 to 5,
Sₚ₁ is a sulfide when p1 is 1 or polysulfide when p1 is from 2 to 5,
Sₚ₂ is a sulfide when p2 is 1 or polysulfide when p2 is from 2 to 5,
m1 and m2 each independently range from 5 to 5,000, optionally a ratio of m1 to m2 ranges from 1:50 to 1:1, 1:20 to 1:2, 1:6 to 1:3, or 1:5 to 1:4,
wherein the S-linked quinone copolymer of Formula (II) has a weight average molecular weight ranging from 1,000 Dalton to 2,000,000 Dalton, or a weight averaged MW ranging from 2000 to 2,000,000 Daltons, from 10,000 to 1,500,000 Daltons, from 100,000 to 1,000,000 Daltons, and a solubility in tetrahydrofuran (THF) of equal or less than 1.0 microgram per mL at 21° C. at 1 atm.

35. An S-linked quinone copolymer obtained by the method of claim 33.

36. An electrochemical cell comprising an anode, a cathode and a non-aqueous electrolyte or an aqueous electrolyte, wherein the cathode electrode comprises, a redox active composition of claim 17.

37. A battery comprising one or more electrochemical cells of claim 36.
